(19) United States
(12) Patent Application Publication
(10) Pub. No.: US 2007/0112585 A1
(43) Pub. Date: May 17, 2007

(54) Cognition analysis

(76) Inventors: Hans C. Breiter, Lincoln, MA (US); Gregory Gasic, Wellesley, MA (US)

Correspondence Address: FISH & RICHARDSON PC, P.O. BOX 1022, MINNEAPOLIS, MN, 55440-1022, US

(21) Appl. No.: 10/566,688

(22) PCT Filed: Aug. 2, 2004
(86) PCT No.: PCT/US04/25146

§ 371 Date: Sep. 25, 2006

Related U.S. Application Data
(60) Provisional application No. 60/492,053, filed on Aug. 1, 2003.

(51) Int. Cl. G06Q 10/00; G06Q 50/00

(52) U.S. Cl. 705/2

(57) ABSTRACT

Methods for evaluating information about the structure and function of neural circuits in the brain can be used for diagnosis and gene identification. Exemplary methods and data management features consolidate relationships within multi-dimensional complex data sets, erg., data sets that include systems biology measures, such as those obtained from neuroimaging, and, optionally also genetic measures, e.g., from the same individuals.

### CROSS-REFERENCE TO RELATED APPLICATIONS

This application claims priority to U.S. Application Ser. No. 60/492,053, filed on 1 Aug. 2003, the contents of which is hereby incorporated by reference in its entirety.

### RESERVATION OF COPYRIGHTS

The disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Neuroimaging has been used to detecting abnormalities in individuals that suffer from neuropsychiatric disorders. However, the conventional methods for evaluating neuropsychiatric disorders rely on outwards signs or “exophenotypes” of illness. The American Psychiatric Association's Diagnostic Statistical Manual (DSM-IV, 1994) is an example of a diagnostic procedure that uses such exophenotypes. Further, a number of psychiatric disorders may be caused, at least in part, by genetic components, the vast majority of which remain unidentified.

### SUMMARY

Methods for evaluating information about the structure and function of neural circuits in the brain can be used for diagnosis and gene identification and, accordingly, are of particular importance for medicine, pharmacology, and society. Many of the methods and data management features described herein consolidate relationships within multi-dimensional complex data sets, e.g., data sets that include systems biology measures, such as those obtained from neuroimaging, and, optionally also genetic measures, e.g., from the same individuals. Generally, this process can be applied to any multi-variable space, not just to quantitative measures from the brain or genome. In the context of neuroimaging and genetics, this process is one that has direct implications for the identification of genes for susceptibility and/or resistance to functional brain illness, e.g., a behavioral or cognitive illness.

Accordingly, in one aspect, the invention features a datastructure that includes: a) genetic information that describes a plurality of genetic markers of a subject or a reference to such information; and b) a systems biology map of the subject or a reference to such a map, e.g., wherein the map includes information about neural circuit function in the brain. The datastructure can be encoded in machine-accessible media or memory. The datastructure can also be transmitted, e.g., as a signal (e.g., a modulated or encoded) or other communication, e.g., electronically or digitally.

In one embodiment, the systems biology map includes structural information (e.g., only structural information).

In one embodiment, the systems biology map includes functional information. For example, the systems biology map includes information about activity in a plurality of brain regions in at least one mental process, e.g., a paradigm, e.g., in at least two, three, four, or five paradigms. The paradigm, typically, includes an external framework with which a mental process interacts. For example, the mental process can be made to interact with an external stimulus, an external request, an external task, or an external sequence.

In one embodiment, the plurality of brain regions includes at least five, ten, twenty, thirty, forty, fifty, or sixty brain regions. For example, at least one, ten, twenty, or thirty of the brain regions of the plurality are selected from Table 1. Regions can be defined by structural and/or functional features. Subregions or smaller volumes than the exemplary regions in Table 1 can also be used, as can regions that are defined by larger volumes and that encompass one or more of the exemplary regions.

In one embodiment, the information for each of the brain regions is independent of reference to a coordinate frame. For example, the brain regions can be identified by a numerical index (e.g., an index values for each of a set of predefined regions) or by text (e.g., a categorical reference) or an indirect reference (e.g., use of pointers and hyperlinks). In another embodiment, one or more the brain regions can be identified by reference to a coordinate frame, e.g., Talairach coordinates. For example, the information is not indexed voxel by voxel so as not to be in a form of a raster, e.g., the information is non-rasterized.

In one embodiment, the paradigm interacts with the informational backbone for motivation, e.g., it evokes at least one region in the informational backbone for motivation. In one embodiment, the paradigm interacts with mechanisms for representation and convergence, feature evaluation, probability assessment, outcome processing, valuation, reward/aversion processing, counterfactual comparisons, and memory. In one embodiment, the paradigm interacts with mechanisms for selection of objectives for fitness, mechanisms for selection of behavior, or information processing (e.g., reception). In one embodiment, the paradigm interacts with mechanisms for language and symbol processing, mechanisms for communication, and/or mechanisms for social behavior.

In one embodiment, the systems biology map can include information obtained by imaging, e.g., neuroimaging, e.g., tomography, e.g., MRI, fMRI, MEG, fCT, OI, SPECT, or PET system. Neuroimaging can including imaging at least one region of the brain or central nervous system.

In an embodiment in which there is information for least two paradigms, these paradigms may interact with overlapping, but non-coextensive regions of the brain, e.g., each paradigm may interact with at least one region that is not activated in another paradigm by a normal subject. Exemplary paradigms include: a social reward paradigm, a CPT/probability paradigm, a physiological aversion/pain paradigm, a mental rotation paradigm, an emotional faces paradigm, and a monetary reward paradigm. Other paradigms can also be used. For example, another paradigm which interrogates the informational backbone for motivation or other areas described herein, e.g., an area interrogated by one of the above paradigms can be used.

In one embodiment, the information about activity for at least one of the regions includes deviations from a reference (e.g., percentage differences, ratios, and subtractive values).

In one embodiment, the systems biology map includes one or a plurality of matrices, each matrix including information about neural activity in a plurality of defined brain regions during different paradigms. In another embodiment, the map includes a similar or identical set of information, but is stored or represented in another form, e.g., as text, graphic, e.g., as a vector, table, etc. In one embodiment, two matrices are used, one including information about individual activation regions and another about population activation regions.

For example, the plurality of genetic markers includes markers on at least two, three, four, five, six, ten, twelve, or fifteen different, non-homologous chromosomes. In one embodiment, the plurality of genetic markers includes markers on each autosome, e.g., at least one, two, five, ten, twenty, or fifty markers on each autosome. For example, at least 20, 50, or 70% of the markers can be spaced closer than 500, 50, 20, 10, or 2 Mb to another marker or 200, 100, 50, 20, or 10 cM to another marker.

The genetic information can includes information about, e.g., nucleotide identity for a plurality of genetic markers, methylation status for a plurality of genetic markers, parental origin for one or a plurality of genetic markers, chromatin structure or accessibility for one or a plurality of genetic markers, a haplotype, microsatellite marker, sequence tagged site, SNP, a chromosomal deletion, inversion, transversion, rearrangement, trisomy, or other chromosomal abnormality.

In another aspect, the invention features a datastructure that includes: a systems biology map of a subject wherein the map includes quantitative information about neural circuit function in the brain. For example, the information indicates function of a plurality of regions of the brain during a plurality of mental processes.

In one embodiment, the systems biology map includes structural information (e.g., only structural information)

In one embodiment, the systems biology map includes functional information. For example, the systems biology map includes information about activity in a plurality of brain regions in at least one mental process, e.g., a paradigm, e.g., in at least two, three, four, or five paradigms. In one embodiment, the plurality of brain regions includes at least five, ten, twenty, thirty, forty, fifty, or sixty brain regions. For example, at least one, ten, twenty, or thirty of the brain regions of the plurality are selected from Table 1. Subregions or smaller volumes than the exemplary regions in Table 1 can also be used, as can regions that are defined by larger volumes and encompass one or more of the exemplary regions.

In one embodiment, the information for each of the brain regions is independent of reference to a coordinate frame. For example, the brain regions can be identified by a numerical index (e.g., an index values for each of a set of predefined regions) or by text (e.g., a categorical reference) or an indirect reference (e.g., use of pointers and hyperlinks). In another embodiment, one or more the brain regions can be identified by reference to a coordinate frame, e.g., Talairach coordinates. For example, however, the information is not indexed voxel by voxel so as not to be in a form of a raster, i.e., the information is non-rasterized.

In one embodiment, the paradigm interacts with the informational backbone for motivation, e.g., it evokes at least one region in the informational backbone for motivation. In one embodiment, the paradigm evokes at least one region in the informational backbone for motivation. In one embodiment, the paradigm interacts with mechanisms for representation and convergence, feature evaluation, probability assessment, outcome processing, valuation, reward/aversion processing, counterfactual comparisons, and memory. In one embodiment, the paradigm interacts with mechanisms for selection of objectives for fitness, mechanisms for selection of behavior, or information processing (e.g., reception). In one embodiment, the paradigm interacts with mechanisms for language and symbol processing, mechanisms for communication, and/or mechanisms for social behavior.

The systems biology map can include information obtained by imaging, e.g., neuroimaging, e.g., tomography, e.g., MRI, fMRI, MEG, fCT, OI, SPECT, or PET system.

In an embodiment in which there is information for least two paradigms, these paradigms may interact with overlapping, but non-coextensive regions of the brain, e.g., each paradigm may interact with at least one region that is not activated in another paradigm by a normal subject.

Exemplary paradigms include: a social reward paradigm, a CPT/probability paradigm, a physiological aversion/pain paradigm, a mental rotation paradigm, an emotional faces paradigm, and a monetary reward paradigm. Other paradigms can also be used. For example, another paradigm which interrogates the informational backbone for motivation or other areas described herein, e.g., an area interrogated by one of the above paradigms can be used.

In one embodiment, the information about activity for at least one of the regions includes deviations from a reference (e.g., percentage differences, ratios, and subtractive values).

In one embodiment, the systems biology map includes a plurality of matrices, each matrix including information about neural activity in a plurality of defined brain regions during different paradigms. In another embodiment, the map includes a similar or identical set of information, but is stored or represented in another form, e.g., as text, graphic, e.g., as a vector, table, etc.

The datastructure can further include genetic information that describes a plurality of genetic markers of the subject or a reference to such information. For example, the plurality of genetic markers includes markers on at least two, three, four, five, six, ten, twelve, or fifteen different, non-homologous chromosomes. In one embodiment, the plurality of genetic markers includes markers on each autosome, e.g., at least one, two, five, ten, twenty, or fifty markers on each autosome. For example, at least 20, 50, or 70% of the markers can be spaced closer than 500, 50, 20, 10, or 2 Mb to another marker or 200, 100, 50, 20, or 10 cM to another marker.

The genetic information can includes information about, e.g., nucleotide identity for a plurality of genetic markers, methylation status for a plurality of genetic markers, parental origin for one or a plurality of genetic markers, chromatin structure or accessibility for one or a plurality of genetic markers, a haplotype, microsatellite marker, sequence tagged site, SNP, a chromosomal deletion, inversion, transversion, rearrangement, trisomy, or other chromosomal abnormality.

The datastructure can be encoded in machine-accessible media or memory. The datastructure can also be transmitted, e.g., as a signal (e.g., a modulated or encoded) or other communication, e.g., electronically or digitally.

In another aspect, the invention features a datastructure that includes: a systems biology map of a subject wherein the map includes a plurality of values corresponding to a set of continuous variables, wherein the variables of the set correspond to different regions of the brain, and the values that correspond to the variables indicate function of respective regions during a mental process.

In one embodiment, the systems biology map includes structural information (e.g., only structural information)

In one embodiment, the systems biology map includes functional information. For example, the systems biology map includes information about activity in a plurality of brain regions in at least one mental process, e.g., a paradigm, e.g., in at least two, three, four, or five paradigms. In one embodiment, the plurality of brain regions includes at least five, ten, twenty, thirty, forty, fifty, or sixty brain regions. For example, at least one, ten, twenty, or thirty of the brain regions of the plurality are selected from Table 1. Subregions or smaller volumes than the exemplary regions in Table 1 can also be used, as can regions that are defined by larger volumes and encompass one or more of the exemplary regions.

In one embodiment, the information for each of the brain regions is independent of reference to a coordinate frame. For example, the brain regions can be identified by a numerical index (e.g., an index values for each of a set of predefined regions) or by text (e.g., a categorical reference) or an indirect reference (e.g., use of pointers and hyperlinks). In another embodiment, one or more the brain regions can be identified by reference to a coordinate frame, e.g., Talairach coordinates. For example, however, the information is not indexed voxel by voxel so as not to be in a form of a raster, i.e., the information is non-rasterized.

In one embodiment, the paradigm interacts with the informational backbone for motivation, e.g., it evokes at least one region in the informational backbone for motivation. In one embodiment, the paradigm evokes at least one region in the informational backbone for motivation. In one embodiment, the paradigm interacts with mechanisms for representation and convergence, feature evaluation, probability assessment, outcome processing, valuation, reward/aversion processing, counterfactual comparisons, and memory. In one embodiment, the paradigm interacts with mechanisms for selection of objectives for fitness, mechanisms for selection of behavior, or information processing (e.g., reception). In one embodiment, the paradigm interacts with mechanisms for language and symbol processing, mechanisms for communication, and/or mechanisms for social behavior.

In one embodiment, the systems biology map is condensed relative to a native dataset (e.g., a rasterized dataset), e.g., at least 10, 10², 10³, 10⁴, 10⁵, or 10⁶ fold.

In an embodiment in which there is information for least two paradigms, these paradigms may interact with overlapping, but non-coextensive regions of the brain, e.g., each paradigm may interact with at least one region that is not activated in another paradigm by a normal subject.

Exemplary paradigms include: a social reward paradigm, a CPT/probability paradigm, a physiological aversion/pain paradigm, a mental rotation paradigm, an emotional faces paradigm, and a monetary reward paradigm. Other paradigms can also be used. For example, another paradigm which interrogates the informational backbone for motivation or other areas described herein, e.g., an area interrogated by one of the above paradigms can be used.

In one embodiment, the information about activity for at least one of the regions includes deviations from a reference (e.g., percentage differences, ratios, and subtractive values).

In one embodiment, the systems biology map includes a plurality of matrices, each matrix including information about neural activity in a plurality of defined brain regions during different paradigms. In another embodiment, the map includes a similar or identical set of information, but is stored or represented in another form, e.g., as text, graphic, e.g., as a vector, table, etc.

The datastructure can further include genetic information that describes a plurality of genetic markers of the subject or a reference to such information. For example, the plurality of genetic markers includes markers on at least two, three, four, five, six, ten, twelve, or fifteen different, non-homologous chromosomes. In one embodiment, the plurality of genetic markers includes markers on each autosome, e.g., at least one, two, five, ten, twenty, or fifty markers on each autosome. For example, at least 20, 50, or 70% of the markers can be spaced closer than 500, 50, 20, 10, or 2 Mb to another marker or 200, 100, 50, 20, or 10 cM to another marker.

The genetic information can includes information about, e.g., nucleotide identity for a plurality of genetic markers, methylation status for a plurality of genetic markers, parental origin for one or a plurality of genetic markers, chromatin structure or accessibility for one or a plurality of genetic markers, a haplotype, microsatellite marker, sequence tagged site, SNP, a chromosomal deletion, inversion, transversion, rearrangement, trisomy, or other chromosomal abnormality.

In one embodiment, the datastructure further includes c) information that is an index corresponding to the subject. For example, the index can be randomized, encrypted, or anonymous. In another example, the index directly identifies the subject (e.g., name, social security number etc). In one embodiment, the index associates the subject with familial or other pedigree information.

The datastructure can be encoded in machine-accessible media or memory. The datastructure can also be transmitted, e.g., as a signal (e.g., a modulated or encoded) or other communication, e.g., electronically or digitally.

The invention also features database including: a plurality of records, wherein each record of the plurality includes a datastructure described herein or other datastructure which is condensed relative to native information (e.g., rasterized data) obtained from subjects at a plurality of time points. In one embodiment, the datastructure is accessible to statistical analysis (e.g., uncompressed) and enables phenotypic classification of subjects.

In one embodiment, the records of the plurality include records for a plurality of unrelated individuals and records for at least one biological family member of each of the plurality of unrelated individuals. For example, at least 5, 10, 20, 30, or 50% of the database can include records for individuals for which there is also a record for a biologically related family member.

In one embodiment, the database includes records for at least 50, 100, 200, 500, 1000, 3000 or 30,000 human subjects, or ranges therebetween. In one embodiment, the database includes records for individuals from different populations (e.g., ethnic populations, e.g., at least two, three, or four different continents, e.g., Caucasians, Africans, Polynesians, Native Americans, and Asians).

In one embodiment, the database includes records for at least 50, 100, 200, 500, 1000, 3000 or 10,000 human subjects who each have a clinical diagnosis of a neurological and/or psychiatric disorder, e.g., schizophrenia, manic depression, bipolar disorder, addictions (e.g., substance abuse, gambling, etc.), obsessive-compulsive disorder, anxiety/paranoia, autism, schizo-affective disorder, delusional disorder, psychosis, antisocial personality disorder, or anorexia/bulimia nervosa. For example, the database can include at least 50, 100, 200, 500, 1000, 3000 or 10,000 for a single disorder.

For example, the datastructure is a condensed form of a native dataset, e.g., (a rasterized dataset). For example, the datastructure is condensed at least 10, 10², 10³, 10⁴, 10⁵, or 10⁶ fold.

In one embodiment, the datastructure further includes genetic information or a reference to such information. The datastructure can include other features described herein.

In another aspect, the invention features a method that includes: providing a database that includes information about brain activity (e.g., structural and/or functional information) for each of a plurality of subjects (e.g., a database described herein); and

classifying the subjects based on the information.

In one embodiment, the classifying includes selecting a subset of variables, and sorting the subjects as a function of the variables of the subset. For example, the subset of variables can be selected based on the information content (e.g., relative information content) of each of the variables. For example, the subset of variables can be selected based on correlations (e.g., autocorrelations) among the variables. In one embodiment, each variable is associated with an activity of a brain region and a mental process, e.g., a paradigm.

In one embodiment, the classifying includes generating, evaluating, or characterizing a tree, e.g., a binary tree. For example, each node of the tree corresponds to a variable associated with a particular region of the brain and a mental process.

In one embodiment, the classifying is recursive.

In one embodiment, the plurality of subjects includes at least 50, 100, 200, 500, 1000, or 3000 human subjects.

In one embodiment, the classifying includes an association rule algorithm. For example, the association rule algorithm is non-parametric.

In one embodiment, the classifying includes a classification tree analysis, hierarchical clustering, Bayesian clustering, k-means clustering, self-organizing maps, and/or shortest path analysis.

In one embodiment, the method further includes comparing genetic information among subjects of at least one class, e.g., evaluating a statistic for association of one or more genetic markers among the subjects of the at least one class.

In one embodiment, the information includes quantitative volumetric data evaluated by tomography, e.g., MRI, e.g., fMRI or mMRI. The quantitative volumetric data can include a plurality of matrices.

In one embodiment, the subjects are social non-human animals, e.g., non-human primates or voles. In one embodiment, the subjects are voles.

In another aspect, the invention features a method that includes: providing a database that includes quantitative information about brain function for each of a plurality of subjects; and identifying, e.g., objectively identifying, a subset of subjects from the plurality of subjects according to similarity of brain function. In one embodiment, a plurality of subsets are objectively identified.

In one embodiment, the identifying includes selecting, e.g., objectively selecting, a subset of quantitative variables whose values vary among the plurality of subjects.

In one embodiment, the method further includes receiving additional quantitative information about brain function for at least one additional subject, and evaluating whether the additional subject is a member of the identified subset.

For example, the identifying includes generating one or more association rules that model the subset; a decision tree that models the subset; and a probability function that models the subset. In one embodiment, the database includes systems biology maps. For example, the systems biology maps includes values determined evaluating subjects during at least two different mental processes.

In another aspect, the invention features a data-tree that includes a plurality of nodes, wherein each non-terminal node includes (i) a reference to a variable or variable class, wherein the variable or variable class is a parameter of brain function in the subject, (ii) optionally, a node level, and (iii) criterion for distinguish descendants of the node.

For example, the tree is a binary tree. In one embodiment, each non-terminal node includes a pointer to one or more descendant nodes.

In one embodiment, for at least some of the nodes of the plurality, the criterion is an association rule. In one embodiment, each descendant node can be defined by a function, e.g., a probabilistic or statistical function, that differentiates it from a sibling descendant node. In one embodiment, the nodes are ordered as function of variables that they respectively reference, e.g., as a function of information content or autocorrelations for the respective variables. For example, at least one of the variables or variable classes refers to a brain region in a paradigm.

In another aspect, the invention features a datastructure including a plurality of matrices, wherein each matrix includes functional information obtained during a mental process of a subject, the matrix including at least two dimensions, a first dimension that identifies regions of the brain, and one or more values for each region, wherein the values correspond to activity levels in the respective regions during the mental process. In one embodiment, the second dimension identifies left/right hemisphere.

In one embodiment, the datastructure includes a first matrix that includes functional information obtained during a first paradigm and a second matrix that includes functional information obtained during a second paradigm.

In one embodiment, the datastructure includes a first matrix that includes first values that depend on a dataset obtained by imaging the subject at multiple timepoints (e.g., a native dataset, e.g., rasterized data), wherein the first values are independent of information from other subjects, and a second matrix that includes second values that depend on the same dataset, wherein the second values are determined or are selected as a function of information from other subjects. In one embodiment, the second values are selected based on location of activation centers detected in an aggregate of image information from a plurality of other subjects.

In one embodiment, the first values are determined and/or selected as a function of location of activation centers detected by clustering signal changes from a baseline, wherein the signal changes are independent of information from any other subject.

The datastructure can be encoded in machine-accessible media or memory. The datastructure can also be transmitted, e.g., as a signal (e.g., a modulated or encoded) or other communication, e.g., electronically or digitally.

In one aspect, the invention features a method that includes: providing (e.g., imaging or receiving) native information about brain function of a subject during a mental process, the information including quantitative data for signals in at least a plurality of regions; comparing signals during the mental process to reference signal parameters to locate regions of activity; and populating a datastructure with information about signals at least in the regions of activity. The method can provide a systems biology map.

In one embodiment, the reference signal parameters is function of a baseline for the subject. In another embodiment, the reference signal parameters are a function of signals from a population of subjects.

In one embodiment, locating regions of activity includes clustering signal changes relative to the reference signal parameters. For example, the clustering includes defining foci in a three-dimensional coordinate space. In one embodiment, the comparing includes generating a statistical map, e.g., as a function of correlation between a gamma function and signal changes. The method can include other features described herein.

In another aspect, the invention features a method that includes: providing (e.g., imaging or receiving) datasets (e.g., native or rasterized datasets) about brain function for a plurality of subjects during a mental process, the information including quantitative data for signals in at least a plurality of regions; combining information from the datasets to provide an aggregate dataset; and localizing regions of activity in the aggregate dataset.

In one embodiment, the combining includes one or more of: transforming native datasets to a reference coordinate frame, averaging the native datasets, and producing a statistical map. In one embodiment, the localizing includes clustering signal changes in the aggregate dataset.

In another aspect, the invention features a method that includes: providing (e.g., imaging or receiving) native datasets about brain function for a plurality of subjects during a mental process, the information including quantitative data for signals in at least a plurality of regions; for each subject, producing a first systems biology map from the native dataset of the particular subject, wherein the first system biology map is independent of the native datasets from the other subjects, and a second systems biology map that is a function of regions of activity detected in an aggregate dataset from the plurality of subjects.

In another aspect, the invention features a method that includes: providing (e.g., imaging or receiving) information about structure and/or function of the brain of the subject, the information including quantitative data for at least a plurality of regions; and objectively evaluating the information using quantitative criteria; and providing a diagnosis for the subject based on results of the evaluating. For example, the quantitative data includes information about brain function during a plurality of mental processes. In one embodiment, at least one mental process includes a paradigm, e.g., a paradigm that evokes the information backbone for motivation. An objective evaluation is typically completely free of the bias or potential bias of a human analyst. Bias may still produced by blind or double-blind human analyst, because the analyst is using non-quantitative metrics to make a decision.

In one embodiment, the evaluating includes comparing the information about the subject to a decision tree. For example, the comparing includes evaluating a probability of association for the information about the subject and one or more terminal nodes of the tree. In another example the comparing includes evaluating a probability of association for the information about the subject and each bifurcation of the tree. In another example, the evaluating includes evaluating a probability that the information about the subject is within a classification, wherein the classification is a function of quantitative activity measures for a plurality of brain regions.

Information about the brain of the subject can be evaluated using rules at one or more nodes of the tree. Rules can be evaluated according to organization of the tree. The information about the brain of the subject can include functional information. One or more parameters (e.g., a functional or morphometric parameter) can be compared to boundaries of the bin. It is also possible to generate new binning criteria, e.g., by modifying the tree while the subject is being evaluated using the tree. The information evaluated by the tree can be information from a condensed representation of a native dataset obtained by imaging the brain. The information can be from, e.g., a matrix or a plurality of matrices. The information can be obtained from a plurality of images and/or a plurality of paradigms. The method can include other features described herein.

In another aspect, the invention features a method that includes: imaging regions of the brain of a subject while at least one of the regions is active to obtain a native dataset (e.g., including rasterized image information) that includes information about activity in one or more of the regions at a plurality of temporal instances (or receiving the native dataset); and condensing the native dataset to provide a condensed dataset that includes quantitative information about at least some of the imaged regions. In one embodiment, the condensed dataset includes information about one or more activity peaks in at least some of the imaged regions. In one embodiment, the condensed dataset discards time resolution for at least 10, 20, 30, 50, 70, 80, 90, or 100% of the regions.

In one embodiment, the regions are imaged by am. In one embodiment, the condensing reduces data size at least 10, 10², 10³, 10⁴, 10⁵, or 10⁶ fold.

In one embodiment, the condensed dataset includes information that can be represented as a matrix, one dimension of which differentiates among regions of the brain. (e.g., a region in Table 1).

In another aspect, the invention features a method that includes: imaging regions of the brain of a subject during a mental process to obtain a dataset (e.g., a native dataset) that includes information about brain function; and populating variables in a matrix by extracting quantitative information from the dataset. In one embodiment, wherein the matrix includes at least two dimensions.

In one embodiment, the first dimension resolves different regions of the brain. In one embodiment, the second dimension resolves the left and right hemisphere of the brain. In one embodiment, the matrix includes a third dimension. In one embodiment, information about one or more activations in a given region and hemisphere are provided at respective variables of the matrix.

In one embodiment, the information includes a list, the members of the list being stored at different positions along a third dimension of the matrix. In one embodiment, the matrix does not provide information about time, e.g., the information about the one or more activations is not time-resolved.

The imaging can include, e.g., neuroimaging, e.g., tomography, e.g., MRI, fMRI, MEG, fCT, OI, SPECT, or PET system.

In one embodiment, the provide a systems biology map that includes functional information. For example, the systems biology map includes information about activity in a plurality of brain regions in at least one mental process, e.g., a paradigm, e.g., in at least two, three, four, or five paradigms. In one embodiment, the plurality of brain regions includes at least five, ten, twenty, thirty, forty, fifty, or sixty brain regions. For example, at least one, ten, twenty, or thirty of the brain regions of the plurality are selected from Table 1. Subregions or smaller volumes than the exemplary regions in Table 1 can also be used, as can regions that are defined by larger volumes and encompass one or more of the exemplary regions.

In one embodiment, the information for each of the brain regions is independent of reference to a coordinate frame. For example, the brain regions can be identified by a numerical index (e.g., an index values for each of a set of predefined regions) or by text (e.g., a categorical reference) or an indirect reference (e.g., use of pointers and hyperlinks). In another embodiment, one or more the brain regions can be identified by reference to a coordinate frame, e.g., Talairach coordinates. For example, however, the information is not indexed voxel by voxel so as not to be in a form of a raster, i.e., the information is non-rasterized.

In one embodiment, the paradigm interacts with the informational backbone for motivation, e.g., it evokes at least one region in the informational backbone for motivation. In one embodiment, the paradigm evokes at least one region in the informational backbone for motivation. In one embodiment, the paradigm interacts with mechanisms for representation and convergence, feature evaluation, probability assessment, outcome processing, valuation, reward/aversion processing, counterfactual comparisons, and memory. In one embodiment, the paradigm interacts with mechanisms for selection of objectives for fitness, mechanisms for selection of behavior, or information processing (e.g., reception). In one embodiment, the paradigm interacts with mechanisms for language and symbol processing, mechanisms for communication, and/or mechanisms for social behavior.

In an embodiment in which there is information for least two paradigms, these paradigms may interact with overlapping, but non-coextensive regions of the brain, e.g., each paradigm may interact with at least one region that is not activated in another paradigm by a normal subject.

Exemplary paradigms include: a social reward paradigm, a CPT/probability paradigm, a physiological aversion/pain paradigm, a mental rotation paradigm, an emotional faces paradigm, and a monetary reward paradigm. Other paradigms can also be used. For example, another paradigm which interrogates the informational backbone for motivation or other areas described herein, e.g., an area interrogated by one of the above paradigms can be used.

In one embodiment, the information about activity for at least one of the regions includes deviations from a reference (e.g., percentage differences, ratios, and subtractive values).

In one embodiment, the systems biology map includes a plurality of matrices, each matrix including information about neural activity in a plurality of defined brain regions during different paradigms. In another embodiment, the map includes a similar or identical set of information, but is stored or represented in another form, e.g., as text, graphic, e.g., as a vector, table, etc.

In another aspect, the invention features a method that includes: receiving a native dataset that includes imaged information about brain function of a subject; and populating variables in a matrix by extracting quantitative information from the native dataset. The method can be used to provide a systems biology map, e.g., as described herein.

In another aspect, the invention features a method that includes: imaging regions of the brain of a plurality of subjects; transforming image information to a reference coordinate space; selecting a subset of regions for which activations are detected among the plurality of subjects; and producing a condensed dataset for each subject of the plurality wherein the condensed dataset is smaller than the native dataset for each subject of the plurality and retains information about the selected subset of regions. In one embodiment, selecting the subset includes averaging the transformed image information and evaluating statistically significant changes relative to results of the averaging. In one embodiment, selecting the subset includes selecting regions that differ from a reference (e.g., a baseline obtained prior or after the mental process). The method can include other features described herein. In a related method, information is received for one or more subjects. A condensed dataset is produced for the subject. The condensed dataset retains information about one or more region in which activations are detected in the subject or in which at least one activation is detected among a plurality of subjects. The retained information can be selected, e.g., as described herein.

In another aspect, the invention features a method that includes: receiving functional information about neural circuit activity, the information being obtained by imaging a plurality of brain regions in a subject, and generating a dataset that associates each of a plurality of brain regions with quantitative information, wherein the quantitative information includes lists of activation peaks (e.g., % signal change) and each list is associated with at least one of the brain regions. In one embodiment, the list is rank ordered. In one example, the dataset is represented as a matrix. For example, members of each list are positioned or referenced in consecutive cells along one axis of the matrix.

In another example, the dataset is represented as a vector or is stored in a relational database, e.g., as a table. The method can include other features described herein.

In another aspect, the invention features method that includes: evaluating a subject to produce a first systems biology map of the subject; treating the subject; and evaluating the subject to produce a second systems biology map of the subject; wherein the first and second systems biology maps include quantitative information about brain function in a plurality of brain regions during at least one mental process, e.g., a paradigm. The method can be used, e.g., to evaluate a treatment, e.g., a candidate treatment or a previously validated treatment.

In one embodiment, treating the subject includes administering an agent to the subject. Examples of the agent include a pharmaceutical, a narcotic, an addictive substance, or a non-addictive substance.

In one embodiment, treating the subject includes providing a non-invasive therapy to the subject. For example, the non-invasive treatment can include hypnosis, music, video, visual, superficial contacts, exercise, or physical pressure.

The system biology maps can be maps described herein. For example, they can include information about activity in a plurality of brain regions in at least one mental process, e.g., a paradigm. They can include information about activity in a plurality of brain regions in at least two paradigms.

In one embodiment, the systems biology map includes structural information (e.g., only structural information)

In one embodiment, the systems biology map includes functional information. For example, the systems biology map includes information about activity in a plurality of brain regions in at least one mental process, e.g., a paradigm, e.g., in at least two, three, four, or five paradigms. In one embodiment, the plurality of brain regions includes at least five, ten, twenty, thirty, forty, fifty, or sixty brain regions. For example, at least one, ten, twenty, or thirty of the brain regions of the plurality are selected from Table 1. Subregions or smaller volumes than the exemplary regions in Table 1 can also be used, as can regions that are defined by larger volumes and encompass one or more of the exemplary regions.

In one embodiment, the information for each of the brain regions is independent of reference to a coordinate frame. For example, the brain regions can be identified by a numerical index (e.g., an index values for each of a set of predefined regions) or by text (e.g., a categorical reference) or an indirect reference (e.g., use of pointers and hyperlinks). In another embodiment, one or more the brain regions can be identified by reference to a coordinate frame, e.g., Talairach coordinates. For example, however, the information is not indexed voxel by voxel so as not to be in a form of a raster, i.e., the information is non-rasterized.

In one embodiment, the paradigm interacts with the informational backbone for motivation, e.g., it evokes at least one region in the informational backbone for motivation. In one embodiment, the paradigm evokes at least one region in the informational backbone for motivation. In one embodiment, the paradigm interacts with mechanisms for representation and convergence, feature evaluation, probability assessment, outcome processing, valuation, reward/aversion processing, counterfactual comparisons, and memory. In one embodiment, the paradigm interacts with mechanisms for selection of objectives for fitness, mechanisms for selection of behavior, or information processing (e.g., reception). In one embodiment, the paradigm interacts with mechanisms for language and symbol processing, mechanisms for communication, and/or mechanisms for social behavior.

The systems biology map can include information obtained by imaging, e.g., neuroimaging, e.g., tomography, e.g., MRI, fMRI, MEG, fCT, OI, SPECT, or PET system.

In an embodiment in which there is information for least two paradigms, these paradigms may interact with overlapping, but non-coextensive regions of the brain, e.g., each paradigm may interact with at least one region that is not activated in another paradigm by a normal subject.

Exemplary paradigms include: a social reward paradigm, a CPT/probability paradigm, a physiological aversion/pain paradigm, a mental rotation paradigm, an emotional faces paradigm, and a monetary reward paradigm. Other paradigms can also be used. For example, another paradigm which interrogates the informational backbone for motivation or other areas described herein, e.g., an area interrogated by one of the above paradigms can be used.

In one embodiment, the information about activity for at least one of the regions includes deviations from a reference (e.g., percentage differences, ratios, and subtractive values).

In one embodiment, the systems biology map includes a plurality of matrices, each matrix including information about neural activity in a plurality of defined brain regions during different paradigms. In another embodiment, the map includes a similar or identical set of information, but is stored or represented in another form, e.g., as text, graphic, e.g., as a vector, table, etc.

In another aspect, the invention features a method that includes: providing a dataset that includes quantitative information about brain activity during at least two paradigms for each of a plurality of subjects; evaluating a parameter that is a continuous function of at least two components of the quantitative information, the at least two components being associated with different paradigms; and analyzing a statistic for association between the parameter and an allele for one or more genetic loci. For example, analyzing the statistic can include a linkage analysis, e.g., non-parametric linkage analysis.

In another aspect, the invention features methods of providing a population-based statistic for a brain structure. The methods include: evaluating images of a brain structure, e.g., for each of a plurality of subjects; aligning the images; and determining positional information defining an virtual brain structure whose structural features are based on a pre-selected probability value, the value representing the probability that the brain structure of one of the members of the plurality is within the constraint of the virtual brain structure. For example, the positional information represents an isoform surface. In one embodiment, the pre-selected probability value is 10, 20, 30, 40, 50, 60, 70, 80, 85, 90, 91, 92, 93, 94, 95, 96, 97, 98, or 99%.

The plurality of subjects can include between 5-5000 subjects, e.g., 8-500, 15-50, 10-35, or 51-200 subjects. For example, each subject of the plurality has a common characteristic, e.g., a common behavioral trait that differs from normal, a genetic marker of interest (e.g., a disease-associated marker), a common experience (e.g., traumatic stress/disaster, abuse victim, drug addiction), or a common learned ability (e.g., literacy). (e.g., compare juveniles with learning v. no learning). The subjects of the plurality may have the same gender, same age, within a 20, 15, 10, 5 or 2 years. In one embodiment, each subject of the plurality is female, and the images were obtained at a similar phase of the menstrual cycle (e.g., the same quarter of the cycle). In one embodiment, each subject of the plurality is addicted to a substance (e.g., a narcotic, caffeine). In one embodiment, each subject of the plurality has a abnormal characteristic in a behavioral paradigm, e.g., a social reward paradigm, a CPT/probability paradigm, a physiological aversion/pain paradigm, a mental rotation paradigm, an emotional faces paradigm, and a monetary reward paradigm.

In one embodiment, the virtual brain structure is smaller than normal, e.g., in one or both hemispheres. The brain structure can be the amygdala or other structure listed in Table 1.

The aligning can include locating one or more of the midpoints of decussations of the anterior and posterior commissures and the midsaggital plane. It can include rotation and/or a nondeformation transformation.

Determining positional information can include gray/white matter segmentation and/or evaluating signal intensity histograms.

The methods can further include receiving information about the brain structure of an individual subject and comparing the received information to the information about the virtual brain structure. The method can further include providing an estimate of risk for a behavioral trait, wherein the plurality of subjects each have a common behavioral trait.

In another aspect, the invention features a datastructure that includes morphometric information about a brain structure (e.g., the amygdala or other brain structure). The morphometric information can be based on a statistical function dependent on a cohort of individuals with a common behavioral trait (e.g., an abnormal behavioral trait). For example, the morphometric information can include information about volume of the amygdala (e.g., a quantitative measure of volume) or information about the surface topology of the amygdala (e.g., information about the degree of undercutting or overcutting relative to a reference individual or a reference cohort or information about the surface contours, e.g., coordinates). In one embodiment, the information about surface topology of the amygdala describes at least a part of the right amygdala, or the right and left amygdala. In another embodiment, the morphometric information describes a degree of symmetry-asymmetry for a particular brain structure (e.g., the amygdala or other brain structure). A morphometric parameter described herein can be used as one parameter in a classification method or any other method described herein, e.g., to evaluate genotypes and/or phenotypes and correlations between such factors.

In another aspect, the invention features a method that includes: obtaining a group of subjects, e.g., human subjects; imaging the CNS of each subject while the respective subject is exposed to information (e.g., text, audio (e.g., music, speech), video (e.g., advertising) etc); evaluating correlation between a characteristic of neural circuit activity of the subjects and alleles present at one or more genetic markers; and providing an evaluation of the information as a function between the characteristic and the frequency of an allele in a population. The method can include other features described herein.

In one exemplary method, subjects (e.g., human patients) are imaged using a plurality of procedures to produce tomographic maps. Generally, at least two (e.g., at least three, four, five, or six) different procedures are used. The plurality of procedures can include functional imaging during one or more paradigms, morphogenetic mapping of anatomical features, diffusion tensor analysis for white matter, radiological imaging, f-deoxy-glucose scanning, cerebral blood flow, and % cellular viability.

Raw image data are translated into a multi-dimensional quantitative “systems biology map” that provides a complex representation of neuropsychiatric function. Because multiple procedures are used, the representation can span more than one cognitive center. Certain combinations of procedures can produce a nearly-continuous map that is a holistic measure of neuropsychiatric function.

The systems biology map (SBM) can be displayed to a user as a matrix or may even be rendered on as a three-dimensional image of the brain. More typically, the SB map is stored in a database for computational analysis. Data can be analyzed using a models, e.g., to assess the reward-aversion circuit, e.g., using behavioral economics models.

These SB maps have many applications, including, for example, evaluating a subject, diagnosing a subject, testing a therapeutic procedure or therapeutic compound, monitoring disease progression, monitoring therapy, and so on.

The fineness of the map may, for example, separate a general behavior perceived as a single disease into two or more distinguishable disorders. Further, the technique can be applied to non-human animals (e.g., primates and voles) and may be used in conjunction with administering a drug, evaluating gene expression, and so forth.

The following are some exemplary features: a dataset that includes functional tomography for more than one paradigm; a dataset that includes parameters representing properties of more than one behavioral circuit; a multi-dimensional matrix that is a function of imaged neural activity during a behavior and imaged anatomical features. (etc. for other combinations; a multi-dimensional matrix that is a function of at least three different images of the brain.

An exemplary method of correlating a neuropsychiatric trait with a genetic locus may include: obtaining imaging information and genetic information from a population of individuals; generating a multi-dimensional systems biology (SB) map for each individual of the population; quantitatively sort the individuals based on their respective “maps”, e.g., using an association rule algorithm, thereby identifying a subpopulation; comparing polymorphisms at least one genetic locus between individuals of the subpopulation to evaluate linkage between a polymorphism and members of the subpopulation

For example, the comparing can include a genome scan to identify a genetic marker with a significant LOD score for the subpopulation. The method can also include comparing polymorphisms of individuals excluded from the subpopulation, e.g., to detect whether absence of an allele is determinative. Other genetic methods (e.g., families, linkage disequilibrium, etc.) can be incorporated.

After a genetic polymorphism is associated with a neuropsychiatric trait, a bottom up approach is used to evaluate individuals who have the polymorphism. The individuals can be evaluated at the extremes of function, and imaged as described above to produce a SB map. Typically, the individuals that are evaluated are not members of the study that linked the polymorphism to the trait.

This approach can have the following applications: provide confirmatory information, provide information for construction of a second model of neuropsychiatric function, and enable extrapolation of genetic information to a second population of individuals.

The sorting can use criteria for at least two dimensions of the SB map.

Many of the methods described herein can be embodied as software, e.g., a machine-executable instructions. The software can be stored on a machine-readable or accessible medium or as an article, e.g., a commodity. Such methods can also be implemented on a machine. Many steps within such methods can be executed, e.g., by interaction with a user or automatically. Methods can also be implemented across a network, e.g., an intranet or internet. For example, the network can link a health care provider and a patient, a physician (e.g., a radiologist) and a patient, and different physicians (e.g., a radiologist and psychiatrist). Communications between members of the network can be secure, web-accessible, and can include hypertext, rotatable images, and other interactive and/or cartographic display techniques.

The methods can be implemented using a system that includes a server that stores a database described herein, and a client that is in communication (e.g., digital comminication) with the server and can send queries and receive requested information to and from the server. A server can include, for example, a processor and a memory for storing information about a plurality of subject. The processor can be configured to access the memory and retrieve information about one or more subjects and/or perform an analysis described herein.

Some implementations of the invention enable providing a continuous function of disease risk.

As used herein the term “circuit” refers to identifiable regions of the brain that are operational during a function such as a paradigm or other task. Typically such regions are distributed in space, but interact with one another. The brain is not modular but is a distributed system.

All cited patents, patent applications, and references are incorporated by reference in their entireties. In particular, U.S. published applications 2002-0042563 (Ser. No. 09/822,585) and U.S. applications Ser. No. 09/729,665, 60/573,138, and a provisional patent application, filed 2 Aug. 2004, titled “MORPHOMETRIC ANALYSIS OF BRAIN STRUCTURES,” bearing attorney docket number 00786-620P02, are incorporated by reference in their entireties.

### BRIEF DESCRIPTION OF THE DRAWINGS

FIG. 1 is a schematic of exemplary interactions between the environment, genome, and epigenome.

FIG. 2 is a schematic of an exemplary hierarchical organization that generates behavior.

FIG. 3 is a schematic illustrating some levels of the components shown in FIG. 2.

FIGS. 4a, 4b, and 4c are exemplary models for cognition.

FIG. 5 is an exemplary model of the informational backbone for motivation (iBM) 20.

FIG. 6 is an exemplary combined model 10 for motivation that depicts the interaction between iBM 20 and a behavioral mechanism 40 and a selection mechanism 30.

FIG. 7 depicts the combined model for motivation 10 and interactions among its components.

FIG. 8 depicts iBM components and mapping of five exemplary paradigms onto iBM components using a color code.

FIG. 9 depicts aspects of an exemplary monetary reward paradigm and results obtained in particular experiments.

FIG. 10a depicts an exemplary qualitative systems biology map.

FIGS. 10b and 11 highlight some regions that feature in exemplary paradigms.

FIG. 12 depicts an exemplary qualitative systems biology map.

FIG. 13 depicts brain regions which may feature in three putative endophenotypes for major depressive disorder.

FIG. 14 depicts brain regions which may feature in some different disorders.

FIG. 15 is a schematic of an exemplary phenotype→genotype approach.

FIG. 16 is a schematic of an exemplary genotype→phenotype approach.

FIG. 17 is a flow chart of an exemplary method for producing a QSBM (quantitative systems biology map).

FIG. 18 is a flow chart of an exemplary method for generating a classification tree.

FIGS. 19A, B, and C are exemplary methods for associating genotypic and phenotypic information.

FIG. 20 depicts an exemplary set of matrices.

FIG. 21 is a schematic of an exemplary system 300.

FIG. 22 depicts an exemplary computing unit.

FIG. 23 is a schematic of an exemplary apparatus.

FIG. 24 shows binning across a spectrum.

FIG. 25 are schematics of a binary tree.

### DETAILED DESCRIPTION

The Informational Backbone of Motivation (iBM)

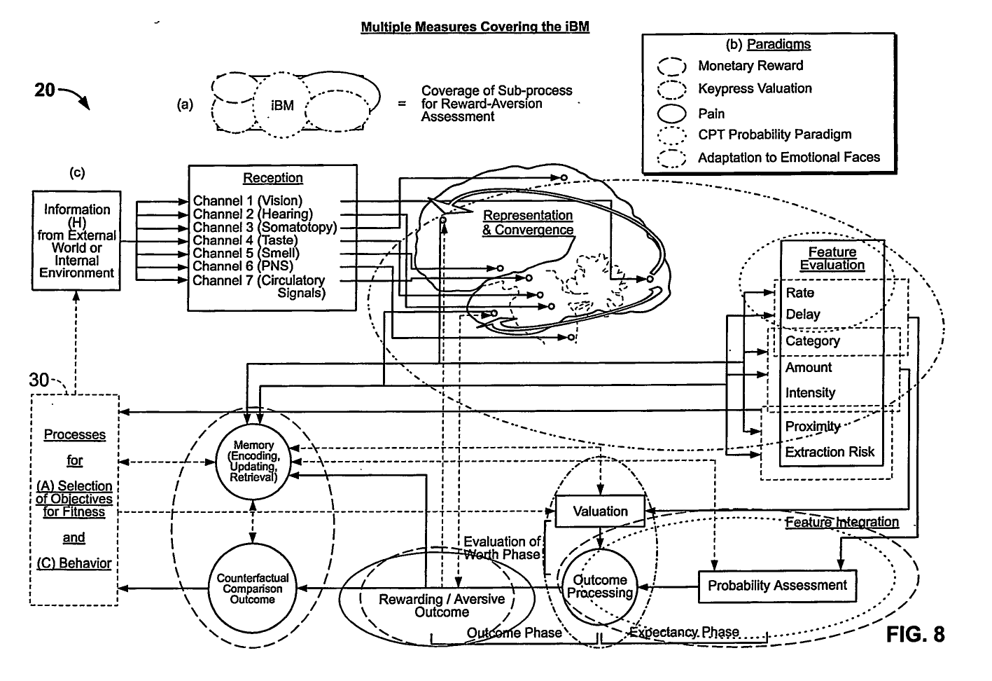

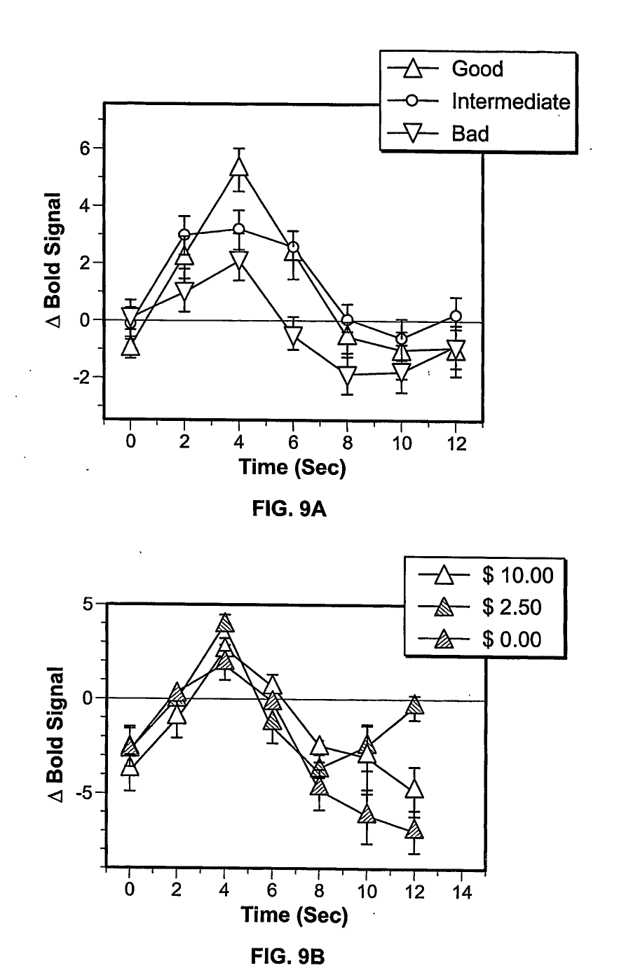

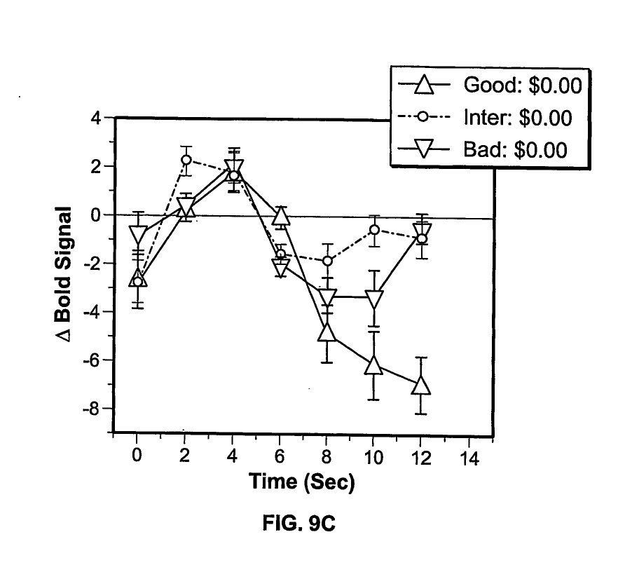

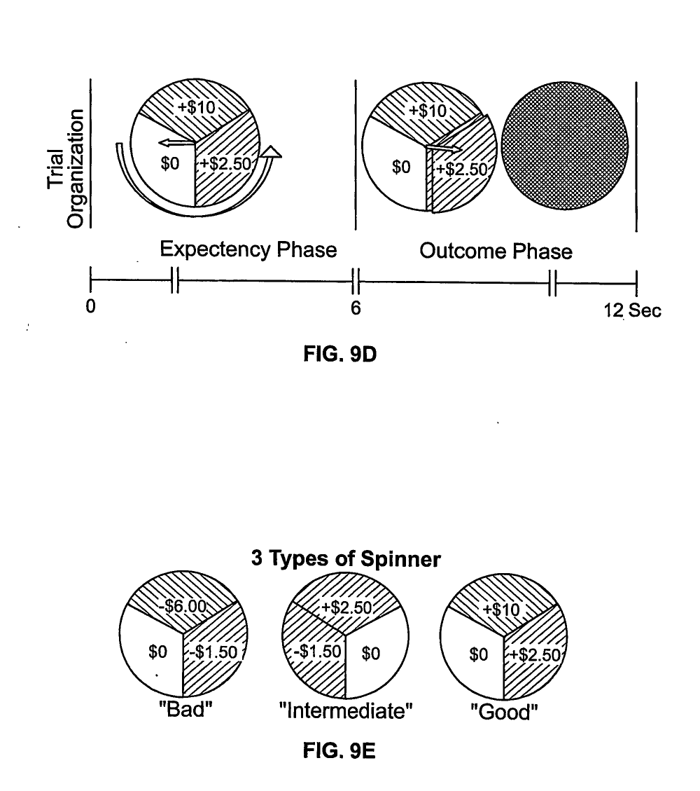

One central features of the mind is the “informational backbone of motivation” or “iBM.” The iBM is a large domain of the brain that processes information for motivation. See, e.g., FIG. 8. The iBM encompasses a number of circuits which participate in motivation. The iBM includes a number of component mechanisms, including, e.g., mechanisms for representation and convergence, feature evaluation, probability assessment, outcome processing, valuation, reward/aversion processing, counterfactual comparisons, and memory. Paradigms can trigger one or more of these mechanisms, although not every paradigm evokes every circuit or structure in the iBM.

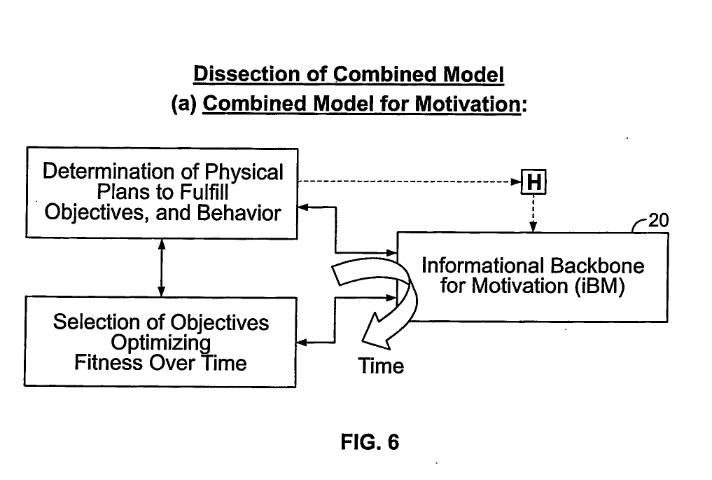

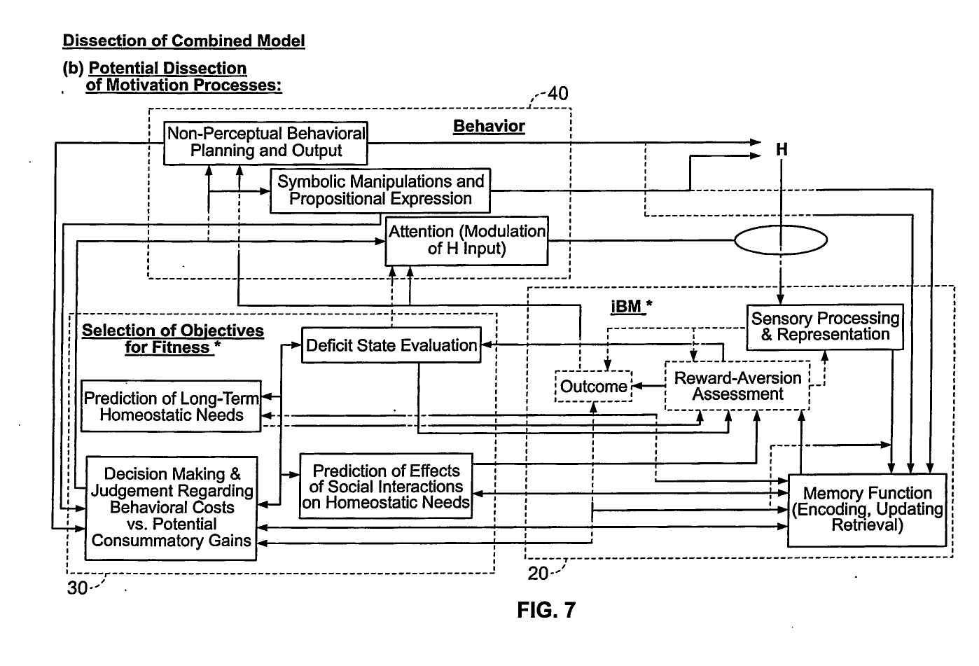

Other central features of the mind are depicted in FIG. 6. Exemplary component circuits include the reward/aversion circuit, working memory, centers of language and social behavior. Still other components are involved in valuation, outcome processing, probability assessment, feature evaluation, representation & convergence, reception, counterfactual comparisons, and other behaviors. It is possible to select or design paradigms that evoke one or more of these components and evaluate their function during the paradigm, e.g., as described for the exemplary paradigms provided herein.

The reward/aversion circuit is part of the iBM. The reward/aversion circuit allows the organism to assign a value to objects in the environment so as to work for “rewards” and avoid “punishments” (aversive outcomes). This circuit can include an extended set of subcortical gray matter regions (nucleus accumbens (NAc), caudate, putamen, sublenticular extended amygdala (SLEA), amygdala, hippocampus, hypothalamus, and thalamus) and domains of the paralimbic girdle (including the orbitofrontal cortex (GOb), insula, cingulate cortex, parahippcampus, and temporal pole) that receive dopaminergic projections from the ventral tegmental area and substantia nigra, here jointly referred to as the ventral tegmentum: VT).

Some additional exemplary regions of the brain that can be imaged and described in a systems biology map are provided in Table 1.

TABLE 1
Exemplary Brain Regions

| | |
|---|---|
| 1. | Transverse Cerebral Fissue and Third Ventricle |
| 2. | Optic Chiasm |
| 3. | Fourth Ventricle |
| 4. | Brainstem |
| 5. | Lateral Ventricles |
| 6. | Caudate |
| 7. | Putamen |
| 8. | Nucleus Accumbens |
| 9. | Pallidum |
| 10. | Thalamus |
| 11. | Ventral Diencephalon |
| 12. | Inferior Lateral Ventricles |
| 13. | Amygdala |
| 14. | Hippocampus |
| 15. | Angular Gyrus |
| 16. | Intracalcarine Cortex |
| 17. | Cingulate Gyrus, anterior division |
| 18. | Cingulate Gyrus, posterior division |
| 19. | Cuneal Cortex |
| 20. | Central Opercular Cortex |
| 21. | Superior Frontal Gyrus |
| 22. | Middle Frontal Gyrus |
| 23. | Inferior Frontal Gyrus, pars opercularis |
| 24. | Inferior Frontal Gyrus, pars triangularis |
| 25. | Frontal Medial Cortex |
| 26. | Frontal Operculum Cortex |
| 27. | Frontal Orbital Cortex |
| 28. | Frontal Pole |
| 29. | Heschl's Gyrus (includes H1 and H2) |
| 30. | Insular Cortex |
| 31. | Juxtapositional Lobule Cortex |
| | (formerly Supplementary Motor Cortex) |
| 32. | Lingual Gyrus |
| 33. | Occipital Fusiform Gyrus |
| 34. | Lateral Occipital Cortex; inferior division |
| 35. | Lateral Occipital Cortex, superior division |
| 36. | Occipital Pole |
| 37. | Paracingulate Gyrus |
| 38. | Precuneous Cortex |
| 39. | Parahippocampal Gyrus, anterior division |
| 40. | Parahippocampal Gyrus, posterior division |
| 41. | Parietal Operculum Cortex |
| 42. | Postcentral Gyrus |
| 43. | Planum Polare |
| 44. | Precentral Gyrus |
| 45. | Planum Temporale |
| 46. | Subcallosal Cortex |
| 47. | Supracalcarine Cortex |
| 48. | Supramarginal Gyrus, anterior division |
| 49. | Supramarginal Gyrus, posterior division |
| 50. | Superior Parietal Lobule |
| 51. | Superior Temporal Gyrus, anterior division |
| 52. | Superior Temporal Gyrus, posterior division |
| 53. | Middle Temporal Gyrus, anterior division |
| 54. | Middle Temporal Gyrus, posterior division |
| 55. | Inferior Temporal Gyrus, anterior division |
| 56. | Inferior Temporal Gyrus, posterior division |
| 57. | Temporal Fusiform Cortex, anterior division |
| 58. | Temporal Fusiform Cortex, posterior division |
| 59. | Middle Temporal Gyrus, temporooccipital part |
| 60. | Inferior Temporal Gyrus, temporooccipital part |
| 61. | Temporal Occipital Fusiform Cortex |
| 62. | Temporal Pole |

Each region of the brain can perform processes, and can be dedicated to a particular process. For example, the ventral prefrontal cortex is a communications center, e.g., in symbolic systems, e.g., language. Decision making is a behavioral output. Directed behavior can be the manifestation of intertwined processes of cognition, e.g., emotion and analysis. Various evaluation methods described herein can be used to identify deficits in one or more processes in one or more regions, thereby characterizing emotion and analysis.

An Exemplary Schema

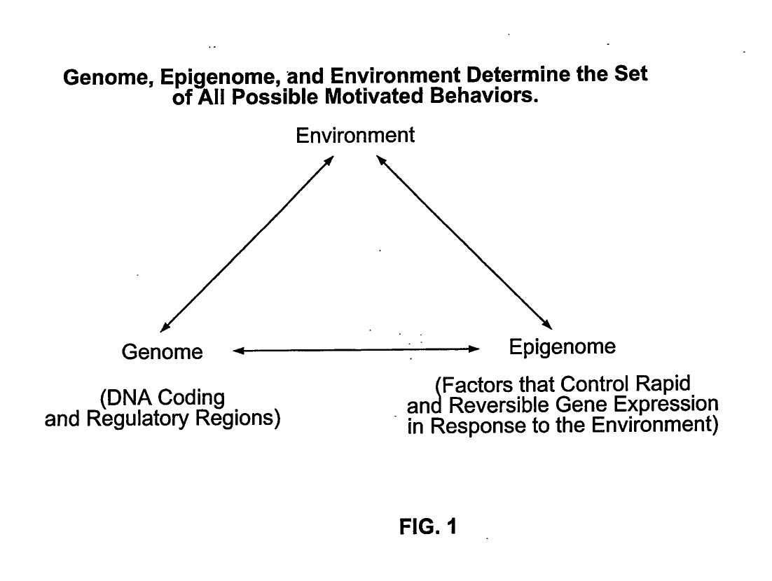

Referring now to FIG. 1, behaviors can be explained by the interaction of three major factors, the genome, the epigenome, and the environment. The genome refers to the sequence content of nuclear genomic nucleic acid and mitochondrial genomic nucleic acid and other resident nucleic acid, such has viral nucleic acid. The epigenome refers to interaction of the genome with epigenetic factors that are transmissible, but variable modifications such as methylation, chromatin structure, long-range chromosomal effects (e.g., position effect variegation, transvection), and even RNAi (e.g., endogenous or exogenously added). The epigenome can function as a rheostat that reacts to create changes in biological function that are transmissible to a subsequent generation.

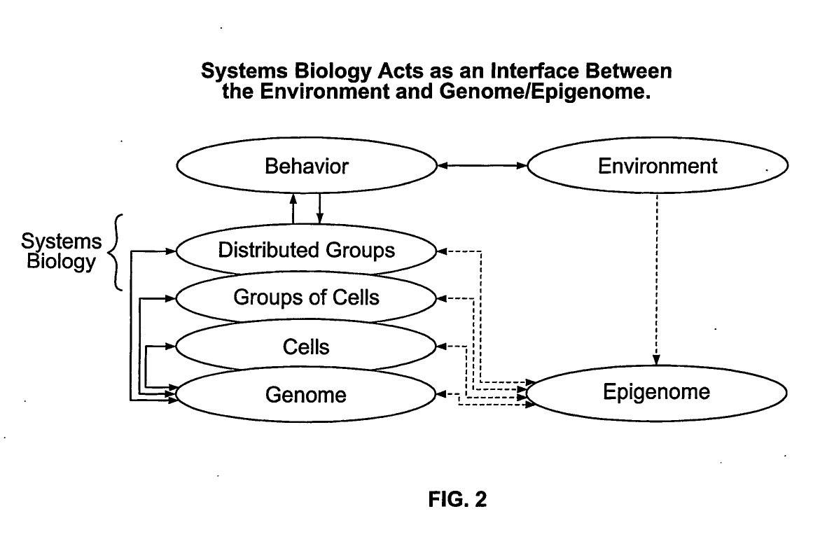

Referring now to FIG. 2, systems biology functions at the interface between behavior and the genome and epigenome. The genome and epigenome can directly affect cellular functions. At a higher level, groups of cells interact, e.g., as neural networks. At a still higher level distributed groups are formed which can control behavior, e.g., by reacting to the environment. Although cells are critical component of the highest systems biology level, the impact of a single nucleotide in the genome or a single epigenetic factor can be only a very small fraction of the complexity of the system. Thus, a single genetic or epigenetic change may be difficult detect in the noise of the system.

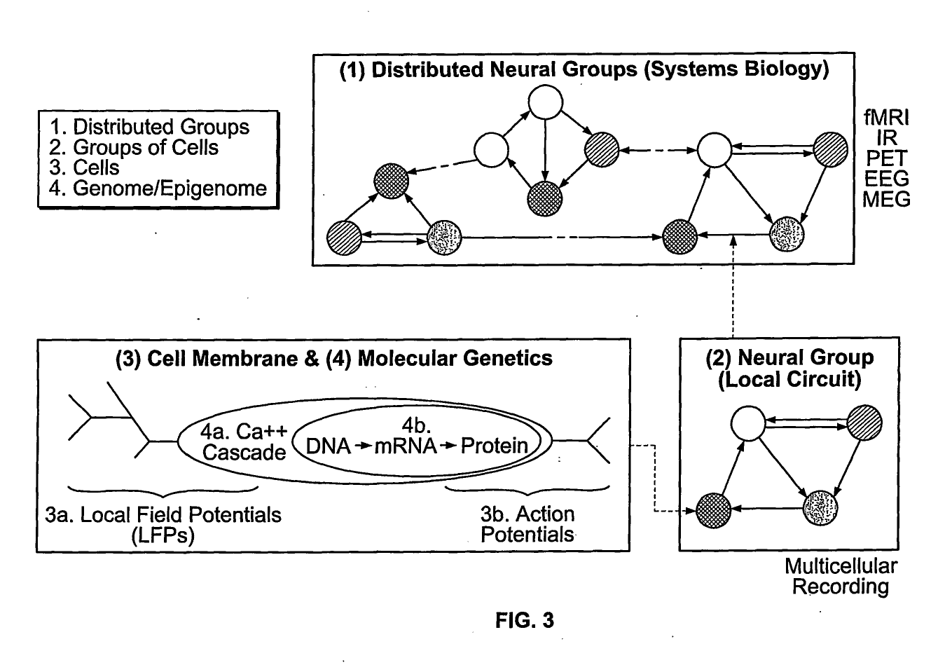

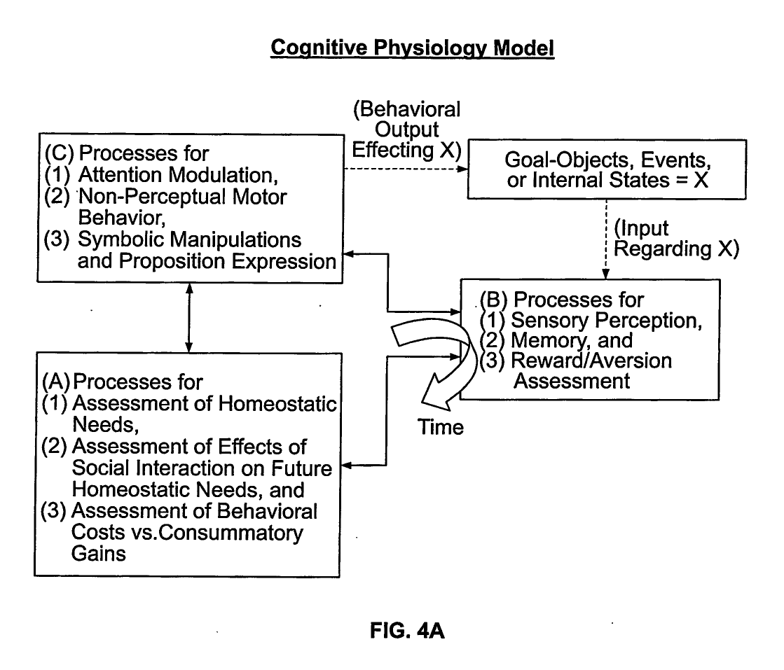

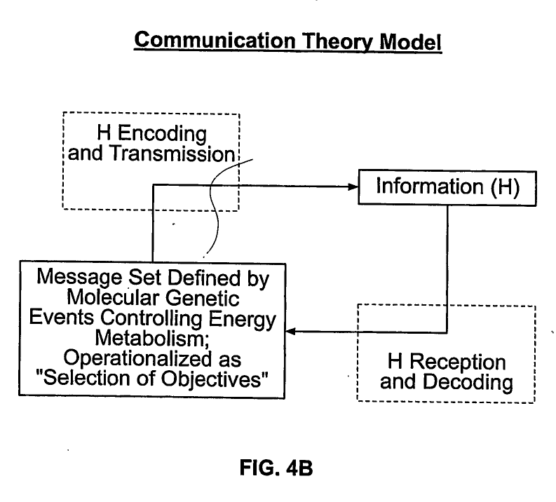

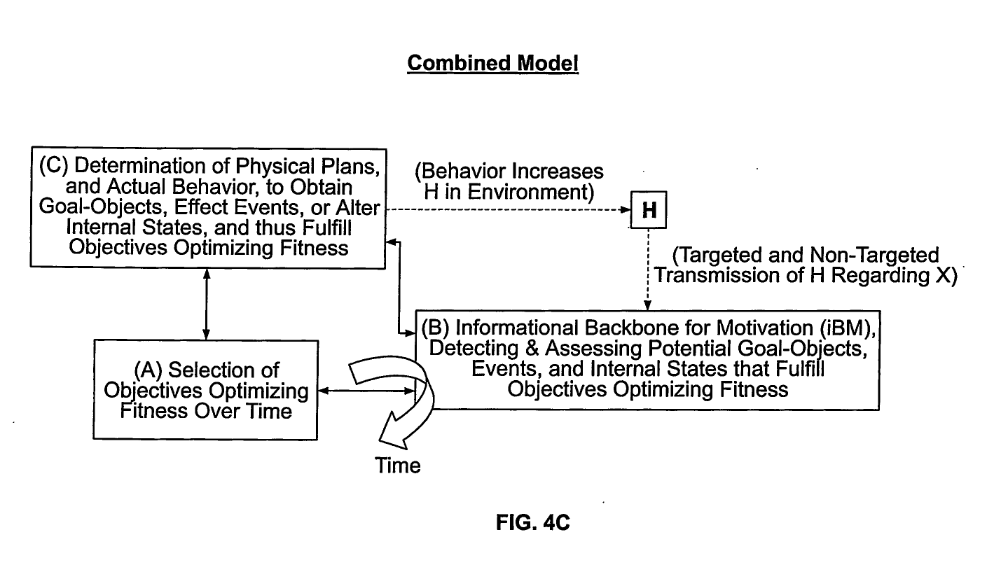

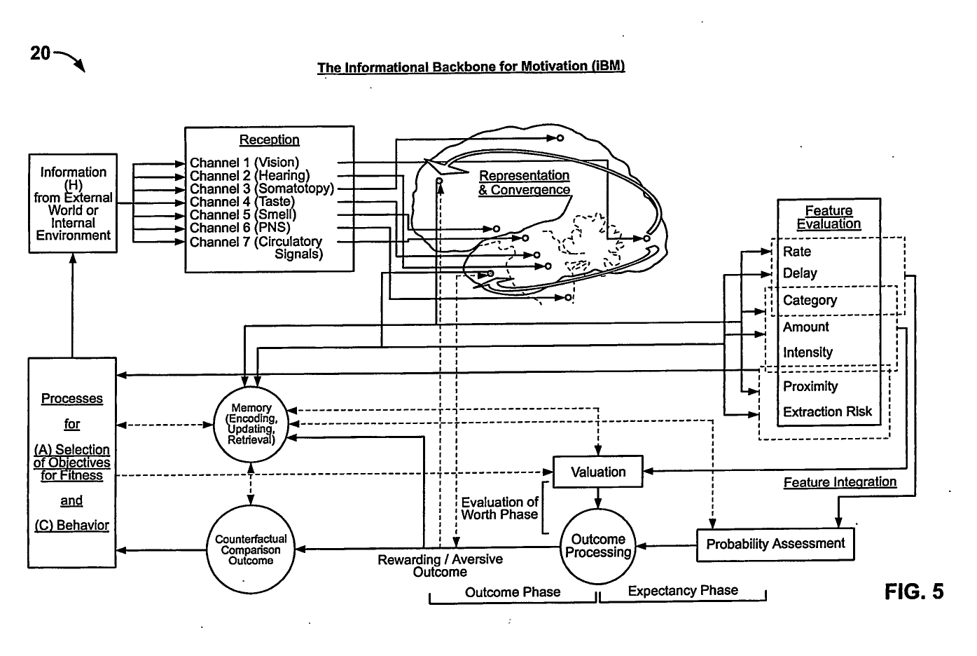

Referring now also to FIG. 3, a variety of methods are available to obtain information about each level in the systems biology hierarchy. The information can include both structural and functional information. For example, distributed neural groups can be evaluated by one or more of: magnetic resonance imaging (MRI) (also referred to as nuclear magnetic resonance or NMR) and other non-invasive techniques such as magnetic resonance spectroscopy (MRS), electroencephgraphy (EEG), magnetoencephalography (MEG), positron emission tomography (PET, including labeled ligand studies), optical imaging (OR), single photon emission computer tomography (SPECT), and functional computerized tomography (fCT). MRI methods include functional magnetic resonance imaging (fMRI), which provides information about function of neural groups. The map may include, for example, structural information such as morphometric information about anatomical features, diffusion tensor analysis for white matter, radiological imaging, f-deoxy-glucose scanning, cerebral blood flow, and % cellular viability.

Local circuits (e.g., neural groups) can be detected, e.g., by multicellular recording (e.g., during surgery of humans or by monitoring non-humans) or even by high resolution (or “fine”) tomography, for example, by evaluating 50 μM isotropic voxels at 7 T. Exemplary methods for evaluating cells include: evaluating local field potentials (LFPs), e.g., using implanted electrodes; evaluating ion or electrochemical potentials and flux (e.g., Ca²⁺ cascades, e.g., by voltometry); and evaluating gene and protein expression (e.g., using microarrays, antibodies, and mass spectroscopy). Methods for evaluating the genome and epigenome are described below. Many methods refer generally to genetic markers and genetic analysis. Such methods can also include evaluating epigenetic features associated with such markers.

Information from different levels of the hierarchy can be combined. For example, mechanistic explanations can be derived by reductive linkage of descriptions across (both up & down) scales.

Strategies for Relating Phenotype and Genotype

Three examples of general strategies for relating genetic markers to a phenotype defined by a systems biology map are described as follows.

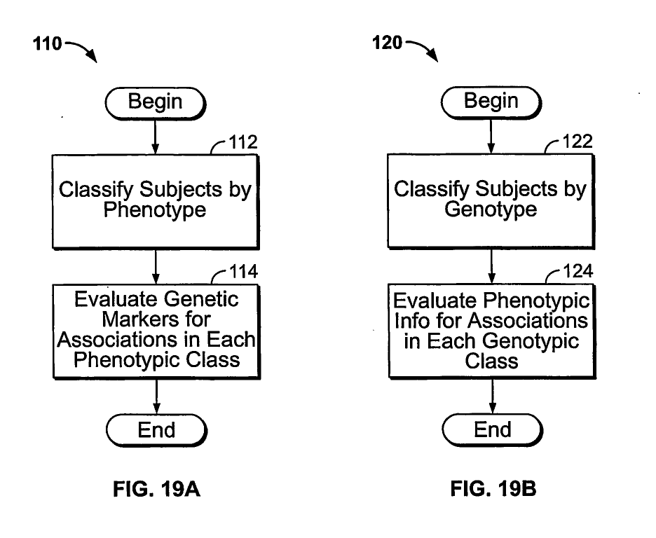

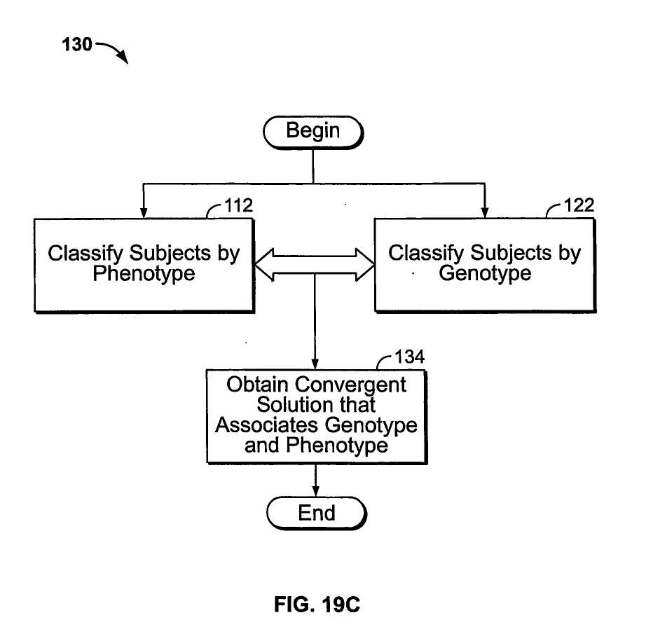

Referring to the example in FIG. 19A, the first strategy 110 includes first classifying 112 subject accordingly to their phenotype, e.g., using information from systems biology maps (e.g., QSBMs). The classification process defines a plurality of phenotypic classes. Genetic markers are evaluated 114 for their association with (e.g., within) at least one of the classes.

Referring to the example in FIG. 19B, the second strategy 120 includes first classifying 122 subject accordingly to their genotype, e.g., using genetic information. The classification process defines a plurality of genotypic classes. Then, phenotypes (e.g., information from systems biology maps) are evaluated to identify associations with at least one of the genotypic classes.

Referring to the example in FIG. 19C, the third strategy 130 includes concurrently classifying subjects by phenotype 112 and classifying them by genotype 122. By exchanging information during the classification processes, a convergent solution can be obtained 134 that associates genotype and phenotype. For example, aconvergence of results can be forced between the neuroimaging and the genotypic data. This convergence relies on using outcomes from the evalution of the neuroimaging data as a set of association rules to prune the partitions found with the data mining of the genotypic data. In parallel with this process, the outcome of the evaluation of the genotypic data is used to constrain the outcome from the neuroimaging data.

Many aspects of the first strategy 110—which involves classification by phenotype—have the further advantage of providing diagnostic and prognostic categories that are useful even without genetic information or validated genetic associations. Also, this first strategy does not necessarily require extensive family information, linkage disequilibrium, founder effects, or requirements on the input population of subjects to provide meaningful statistics for finding genes that are associated with a particular phenotypic class.

Producing an Exemplary Systems Biology Map

Referring to the example in FIG. 8, a plurality of paradigms can be used to generate a systems biology map that includes functional information about neural circuitry in a subject.

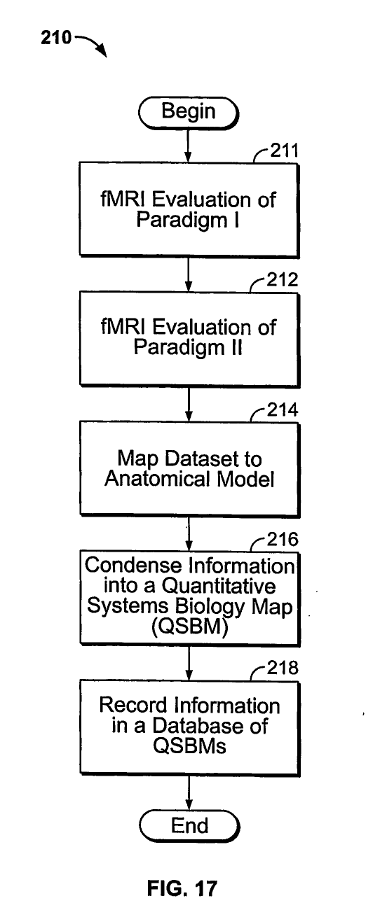

FIG. 17 provides a flowchart for one exemplary method. A subject is evaluated using fMRI during a first paradigm 211 and during a second paradigm 212. Methods for evaluating subjects during paradigms are described, e.g., US 2002-0042563 and below. Raw acquisition data can be mapped 214 onto a standard anatomical model, e.g., the Talairach coordinates. In other implementations, other types information can be used instead of or in conjunction with the first and second paradigms. Such information includes: anatomical and morphological information about brain structure and function, clinical information (see, e.g., below). See discussion below.

This information can be condensed 216 to produce a systems biology map, e.g., a qualitative or quantitative systems biology map. The abbreviation “QSBM” is used to represent quantitative systems biology maps. Although it is possible to use the raw data directly, typically the “raw” or “native” dataset acquired by instruments (e.g., an MRI machine) during a paradigm is very large. For example, a typically dataset from fMRI can include multiple 128×128 sections for 15 to 30 different slices and for about 300 time points. If multiple runs of the paradigm are done, then the dataset is increased that many times. Parcellation and statistical analysis can further increase the dataset 10 to 15 fold. Thus, it is possible to have at least 20 Mb or even up to 1 terabyte (1 Tb) of data for a single subject. However, this information can be processed to generate a matrix (e.g., in the kilobyte to 1 Mbyte range) that has a reduced size relative to the native dataset, but retains the useful information. Thus, byte-for-byte, information can be condensed at least 10, 10², 10³, 10⁴, 10⁵, or 10⁶ fold, and ranges therebetween. The ability to condense information into a meaningful and accessible format may be critical for the development and/or analysis of large databases of functional information about neural circuitry.

Extracting information for a QSBM typically involves discarding data. Although compression techniques can be used, e.g. to store the QSBM, typically the QSBM is in a form that is easily accessible, e.g., for computation. Because data is typically discarded, it is usually not possible to regenerate the native dataset from the QSBM. In one embodiment, the QSBM discards time resolution. For example, the QSBM can merely retain a list of activations for each region without reference to the temporal dimension, although the list may be ordered according to time of occurrence.

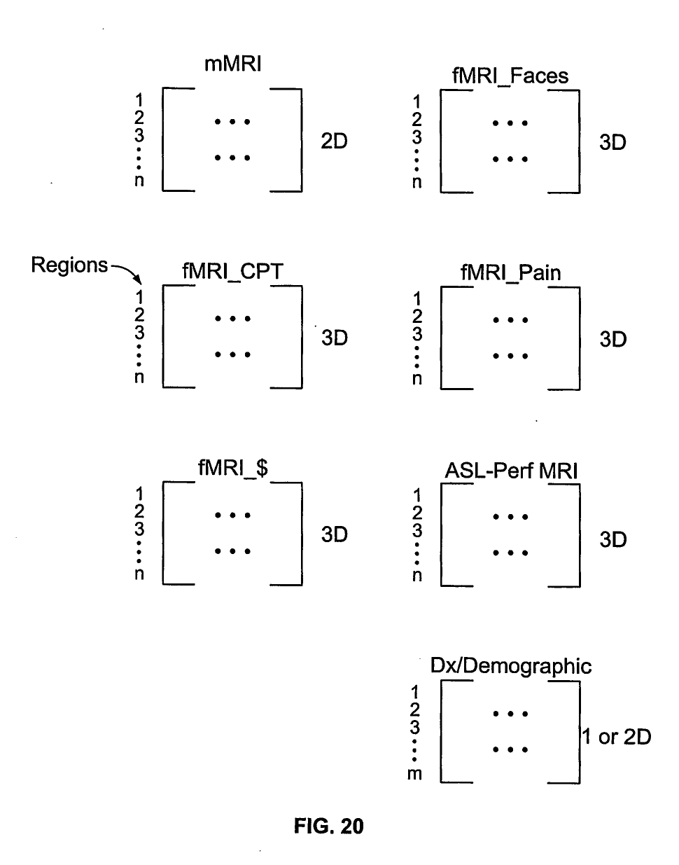

In one implementation the information is condensed into one or more matrices. FIG. 20 illustrates a set of matrices. Each matrix includes one dimension (illustrated vertically) that refers to different regions of the brain (e.g., regions 1, 2, 3, . . . n, wherein n refers to the n^{th} region) and another dimension (horizontal) that refers to left and right hemispheres of the brain. A third dimension (e.g., going into the page) is used to store a list of values for particular region-hemisphere. For fMRI data, for example, the list of values may refer to % change of each of the activation peaks detected during a paradigm. For example, if a region has three different activation peaks that are due to the following changes in signal, 2.3%, −0.5%, and 1.2%, the sequence of values in the third dimension can be {2.3%, 1.2%, −05%}.

Other values may also be used (e.g., instead of or in conjunction with % change), e.g., time to peak for each of the activation peaks detected during a paradigm, delay, FT, and slope. In another embodiment, information about each activation peak can further include information indicating location of the peak, e.g., where within the region the activation occurred and/or time, e.g., a reference to the temporal dimension.

An additional matrix can be used to store clinical (e.g., diagnostic) and demographic information such as age, gender, handedness, EEG, drug regimen (e.g., pharmacology), narcotic dependency, pedigree information, place of birth, place of residence, socio-economic status, race, language (e.g., ability to speak, understand a particular language and/or exposure to language, e.g., as an infant, child, adult), WAIB-R, DRM-IV diagnosis, and so forth. Still other types of useful information include quantitative medical assessments, e.g., blood pressure, pulse, body temperature, blood cell count, circadian rhythm, height, height, and other biometric values.

Another further matrix can be used to store genotypic information, although such information can also be stored separately. This additional matrix may only be two-dimensional.

It is appreciated that a matrix can also be represented using other formats (e.g., an n-dimensional vector) or transformed into other representations (e.g., one or more tables in a relational database, a text string, and so forth). A set of matrices can also be represented as a single matrix which has an additional dimension relative to the most complex matrix in the set.

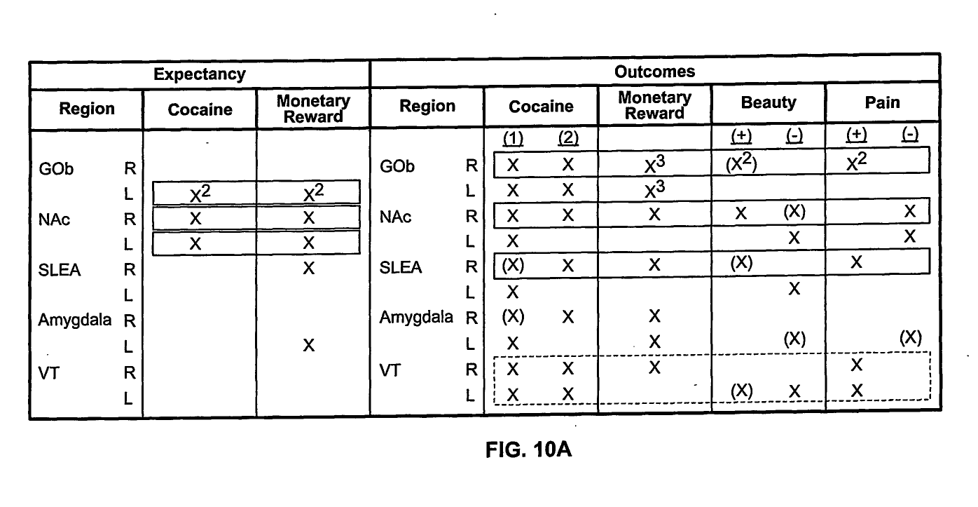

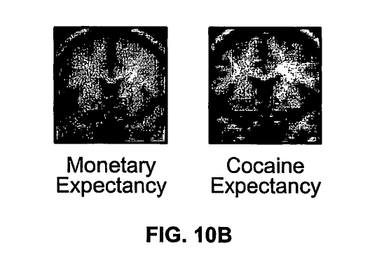

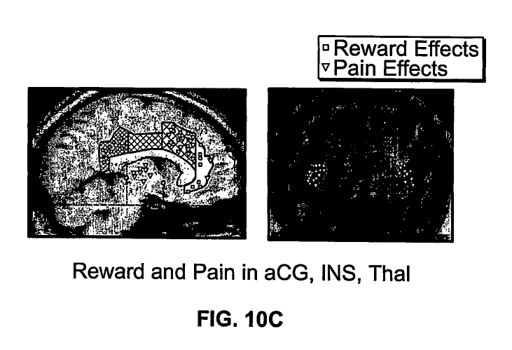

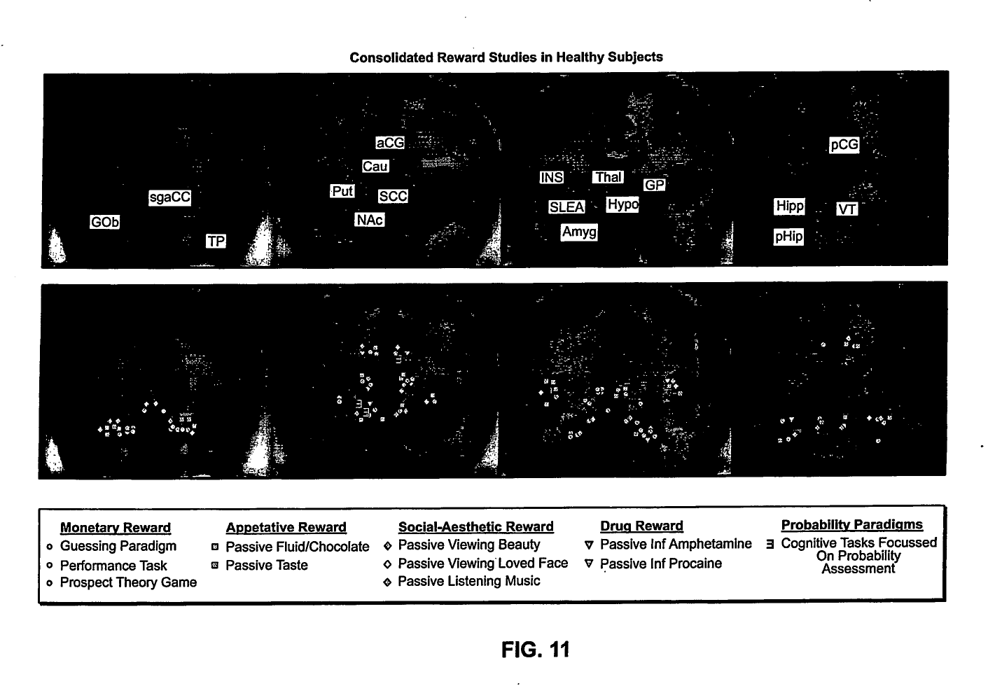

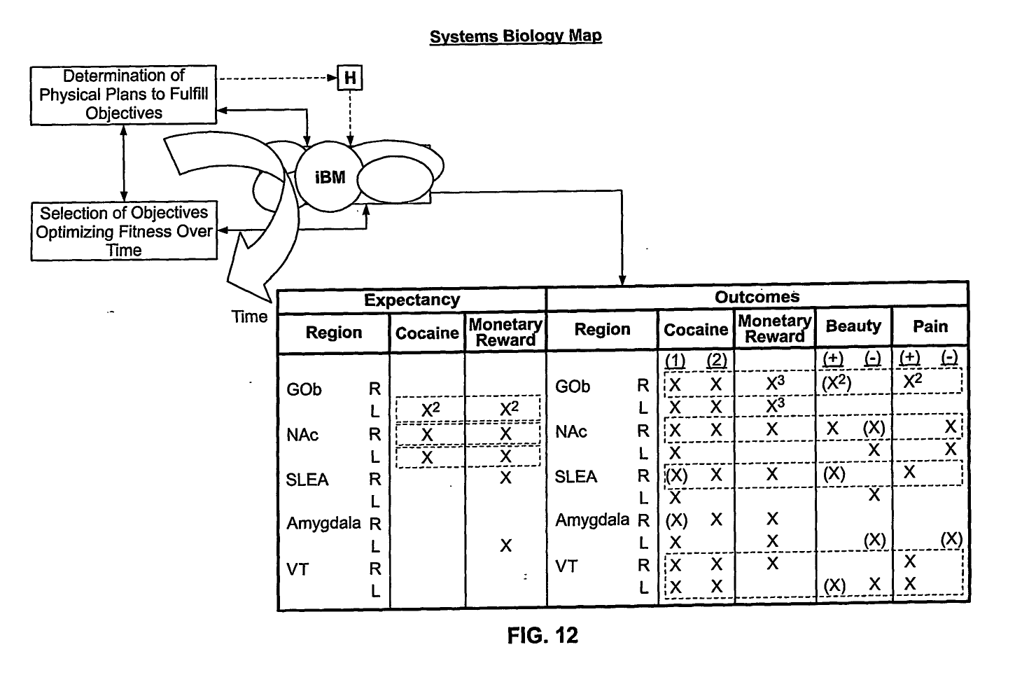

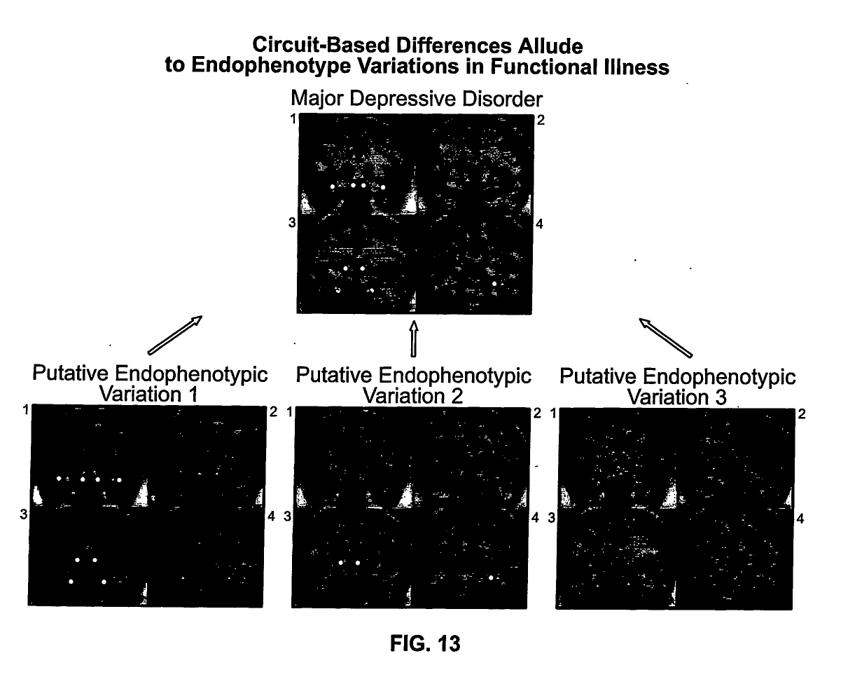

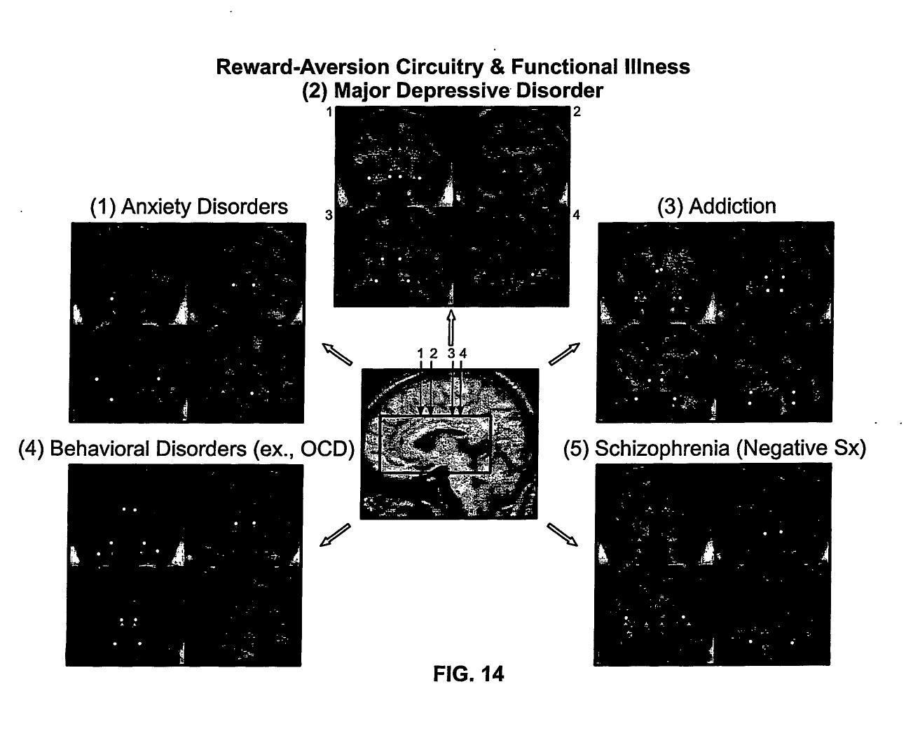

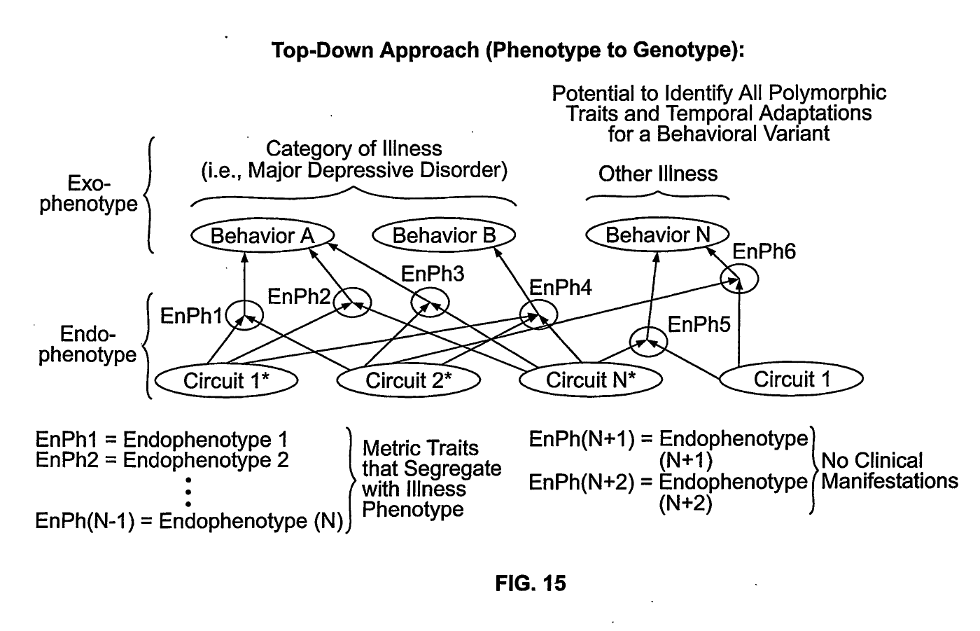

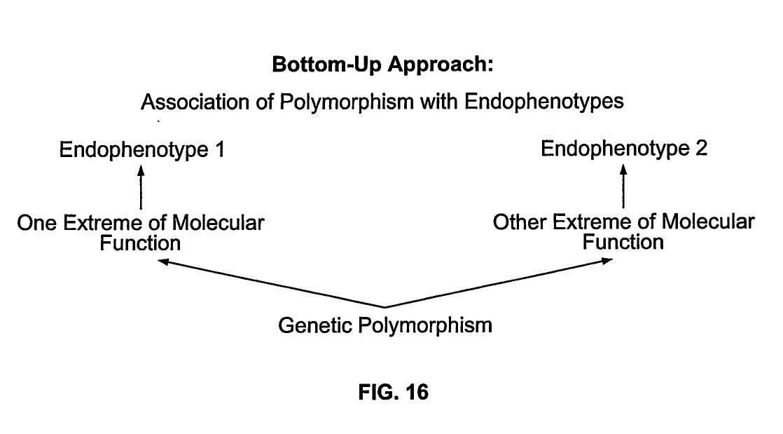

FIG. 10 describes an exemplary qualitative systems biology map. The map describes different regions, here, the Gob, NAc, SLEA, Amygdala, and Vt. The map also indicates activity of the regions during the expectancy phase of cocaine and monetary reward paradigms, and the outcome phase of cocaine, monetary reward, beauty and pain paradigms. Using paradigms, component circuits or structures can be evoked at one or more phases, e.g., during the expectancy or outcome phase. The expectancy and outcome phases refer to processes. In some cases, these may occur concurrently, e.g., during overlapping time segments.

Phenotypic Classifications

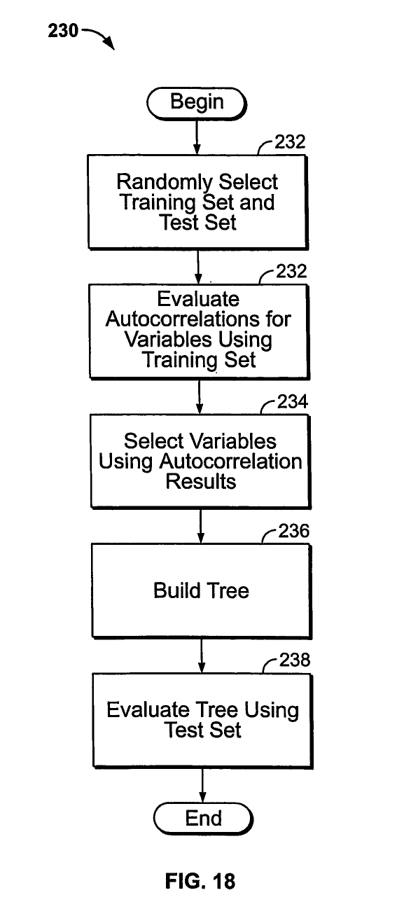

Referring now to the exemplary method 230 in FIG. 18, information about a plurality of subjects (e.g., human subjects) can be used to produce phenotypic classifications. The method 230 includes randomly selecting 232 a test set and training set from the plurality of subjects. For example, if a database includes information about 1000 subjects, 500 might be used for the training set and the other 500 might be used for the test set. Variables for phenotypic information are then analyzed by evaluating 232 autocorrelations between the variables in the training set. The variables that are analyzed might include, e.g., all variables related to functional and structural information about neural circuitry. In other some embodiments, it may be useful to exclude the diagnostic and demographic information from the autocorrelation analysis, although in other embodiments such information may be included.

The results of the autocorrelations are then used to select variables to build 236 a classification tree. For example, the variable with the best autocorrelation score can be used to define a rule for the first node of the tree. The variable with the second best score may be used to define a rule for the second node of the tree. Details of tree building are provided below. Once the tree is complete, the classification is used to evaluate the test set.

Objective scoring can also be used to evaluating the tree. For example, the sizes of the clusters in the test set and the training set should be reasonably similar, e.g., within statistically acceptable values. In one embodiment, the tree should have a statistical significance, e.g., the tree structure is not attributed to chance alone.

In some implementations, the classification method may achieve one or more of the following advantages: (i) classifications are obtained by completely objective criteria, (ii) structural and functional information can be easily integrated as can other variables, e.g., information from different imaging techniques, different times and different subjects, (iii) classification is scalable and expandable (e.g., as the number of available subjects grows), (iv) information is condensed relative to raw acquisition data or data transformed onto an anatomical model.

The use of autocorrelations enables one objective approach to selecting variables for tree classification. Variables that provide high autocorrelation scores are indicated as being highly informative. However, in some implementations, this objective approach is combined with a subjective approach, or if desired, in some implementations, a completely subjective approach can be used. In an exemplary subjective approach, regions of the brain that are known to connect and interact with regions that score high by objective criteria are also used for tree classification, e.g., independent of their own autocorrelation score. Regions that are known to be involved or be featured in a particular process may also be selected.

Tree editing can include pruning branches, e.g., particularly branches that do not segregating individuals in an informative manner. For example, segregating a single individual from a group of twenty does not aid the classification process. Similarly segregating in a upper node, five subjects from a group of five hundred may not inform the classification process. Pruning can be performed manually or automatically. In one example, associations rules are used to test the salience of possible correlations and to prune off non-informative nodes. In another example of automated pruning, branches with asymmetric distributions (e.g., <10% into one branch) are removed by computer software.

The classification process can also be evaluated (e.g., by a user or software) to determine if it provides explanatory power. For example, a classification can be evaluated to determine if it bins known exophenotypes (e.g., clinical diagnoses) into subclasses. In another example, a classification is evaluated to determine if there is familiarity, e.g., whether the classification identifies an endophenotype (see, e.g., below). In still another example, the classification continues until one or more particular constraints are satisfied.

It is also possible to do a recursive process wherein tree branches are added and pruned during multiple recursive cycles until the tree structure satisfies particular parameters, e.g., optimization parameters. For example, the tree can be modified until a cost value for growing the tree exceeds the informational value of the added complexity.

In other embodiments, the training and test sets may be different sizes. Or in one embodiment, all available data is used to generate the classification tree.

Endophenotypes

By evaluating information from a plurality of subject it is possible to identify at least two types of phenotypic markers: endophenotypes and markers of disease/disorder progression (MDP).

An endophenotype typically includes the following properties: a) it provides an internal marker of a probability function for disease susceptibility or resistance; (b) it is unchanged by illness progression; and (c) it has measurable heritability/familiality. See, e.g., Almasy and Blanquero (2001) Am. J Med. Genet. 108:42. Thus, endophenotypes may be found (but not necessarily) in unaffected siblings and parents of a subject who is affected by a disorder. Similarly, the endophenotype can be present prior to onset of the disorder. Thus, endophenotypes have high diagnostic value. An endophenotype may be defined by one or more variables, e.g., one or more variables present in a SBM (e.g., a QSBM) described herein.

In contrast, a marker of disease/disorder progression (MDP) is changed during the progression of a disorder. Such markers can be used to characterize the disorder, prescribe or monitor a treatment, and make other decisions (e.g., medical or financial decisions).

A method for evaluating neuropsychiatric phenotypes can include a longitudinal component which is of great value in differentiating between endophenotypes and MDPs. Such longitudinal studies include analyzing a subject at a first time and then analyzing the subject at a later time, e.g., at least one week, one, two, three, four, six, ten, or twelve months later. For example, the subject might be analyzed once a year over three to five years. In some embodiments, the subject is evaluated at approximately regular intervals. During these studies phenotypic variables that remain unchanged, but which differ from normal (e.g., which are identified as useful for classification) are variables that can serve as endophenotypes. If the subject's outward clinical manifestations of a disorder are changing, other variables detected by evaluating neural circuit function may also change. Such variables can server as MDP.

An Integrated System

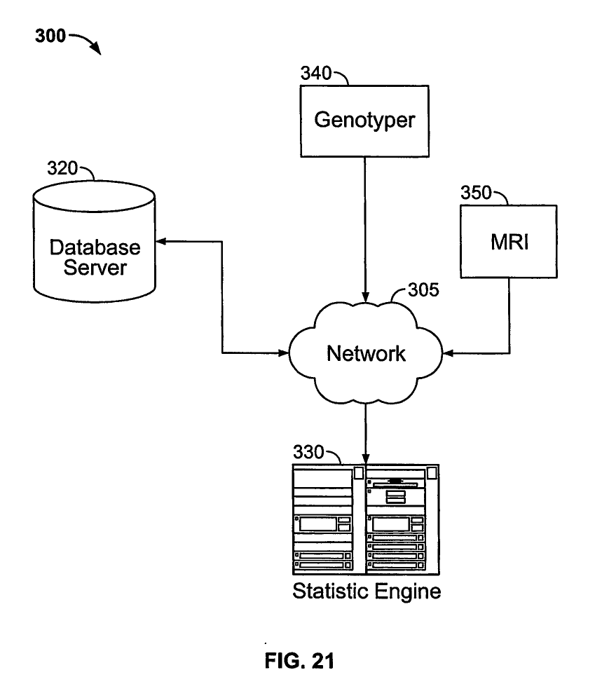

Referring to FIG. 21, an exemplary integrated system 300 can be used to produce information for a database and generate information about neural circuit activity. For example, the system can include a network 305 that connects one or more imagers 350 (e.g., MRI machines) and one or more genotyping stations 340 with a database server 320. The imagers 350 can deliver raw or processed information to the server 320 with information that references an individual (e.g., using an anonymous index). The database server 320 also receives similarly referenced information about the individual's genotype so that there is an association between the genotypic information and the phenotypic information obtained by MRI. For example, a datastructure can be used that includes a first field with a pointer to the genotypic information of the individual and a second field with a pointer to the phenotypic information for the same individual.

In one embodiment, the system 300 also includes a statistics engine which can evaluate the phenotypic information and/or genotypic information, e.g., using a method described herein.

The methods and other features described herein can be implemented in digital electronic circuitry, or in computer hardware, firmware, software, or in combinations thereof. Methods can be implemented using a computer program product tangibly embodied in a machine-readable storage device for execution by a programmable processor; and method actions can be performed by a programmable processor executing a program of instructions to perform functions of the invention by operating on input data and generating output. For example, methods can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. A processor can receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD-ROM disks. Any of the foregoing can be supplemented by, or incorporated in, ASICs (application-specific integrated circuits).

Data structures, trees, databases, and other information formats described herein can be stored in a machine accessible memory (e.g., volatile or non-volatile memory, within a CPU or external to a CPU) or on machine-readable medium (e.g., a hard disk, CD-ROM, and so forth.

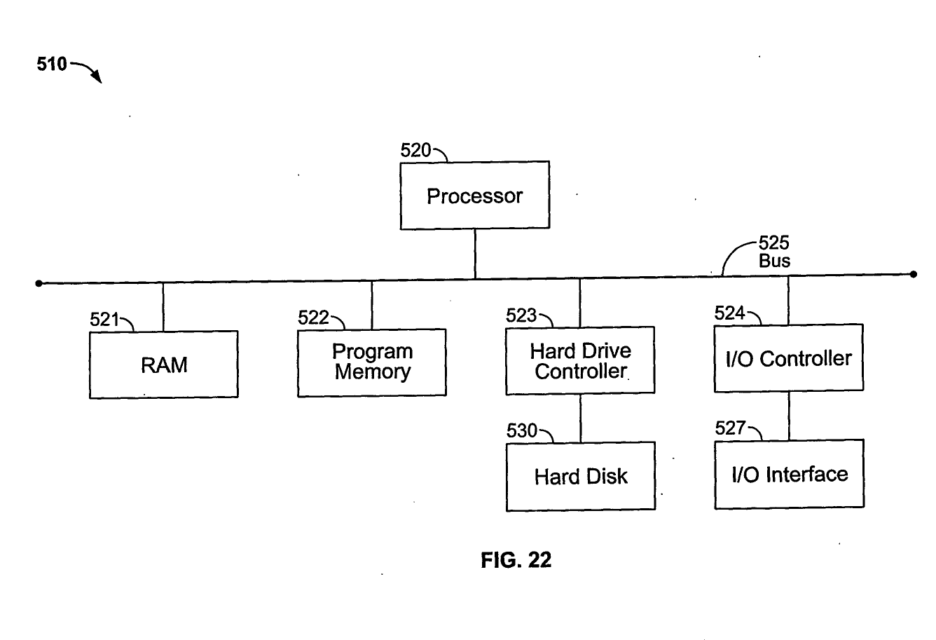

An example of one such type of computer is depicted in FIG. 22, which shows a block diagram of a programmable processing system (system) 510 suitable for implementing or performing the apparatus or methods of the invention. The system 510 includes a processor 520, a random access memory (RAM) 521, a program memory 522 (for example, a writable read-only memory (ROM) such as a flash ROM), a hard drive controller 523, and an input/output (I/O) controller 524 coupled by a processor (CPU) bus 525. The system 510 can be preprogrammed, in ROM, for example, or it can be programmed (and reprogrammed) by loading a program from another source (for example, from a floppy disk, a CD-ROM, or another computer).

The hard drive controller 523 is coupled to a hard disk 530 suitable for storing executable computer programs, including programs embodying the present invention, and data including storage. The I/O controller 524 is coupled by means of an I/O bus 526 to an I/O interface 527. The I/O interface 527 receives and transmits data in analog or digital form over communication links such as a serial link, local area network, wireless link, and parallel link.

One non-limiting example of an execution environment includes computers running Linux Red Hat OS, Windows XP (Microsoft), Windows NT 4.0 (Microsoft) or better or Solaris 2.6 or better (Sun Microsystems) operating systems. Browsers can be Microsoft Internet Explorer version 4.0 or greater or Netscape Navigator or Communicator version 4.0 or greater. Computers for databases and Administration servers can include Windows NT 4.0 with a 400 MHz Pentium II (Intel) processor or equivalent using 256 MB memory and 9 GB SCSI drive. For example, a Solaris 2.6 Ultra 10 (400 Mhz) with 256 MB memory and 9 GB SCSI drive can be used. Other environments can also be used.

Diagnosis

In one embodiment, a tree classification is produced based on information from a plurality of subjects. This tree can be used directly for diagnosing a subject (the “query subject”), particularly a subject that is not a member of the plurality of subjects that was used to produce the tree. Information for the query subject can be run through the tree.

For example, if a native dataset for the query subject is received, the native-dataset can be processed to produce a QSBM that has the same structure as the maps used for producing the tree. The query subject's QSBM is then compared to rules at each node of the tree to determine where the query subject falls on the tree. By proceeding down the tree to a terminal node, this process should indicate which bin or class the query subject belongs in. If the tree includes a probabilistic or other statistical function that corresponds to the decision at each node, this process can also produce a probability or statistical significance for the diagnosis. For example, it is possible to display a value for each of the possible bins or classes that indicates the probability that the query subject belongs in that bin or class. (The probabilities should sum to 1.0). However, it may not be necessary to explore all the branches of the tree. For example, only branches likely to be relevant might be tested.

In another embodiment, a rules-based function is used to define a class. Information about the query subject is then compared to one or more rules to produce an evaluation indicating whether the query subject belongs in the class. The result of the evaluation might again be a probability or other statistic. In this embodiment, it is not necessary to sequentially process a set of rules.

Exemplary Applications

There are numerous applications for the methods, data-structures, and systems described herein. In one example, the methods can be used to characterize (e.g., diagnosis) a neuropsychiatric disorder or a propensity or association with a disorder. In another example, the methods can be used for the discovery of a gene or epigenetic factor which contributes at least in part to a neuropsychiatric disorder. Such disorders include, e.g., schizophrenia, manic depression, bipolar disorder, addictions (e.g., substance abuse, gambling, etc.), obsessive-compulsive disorder, anxiety/paranoia, autism, schizo-affective disorder; delusional disorder, psychotic disorders not elsewhere specified; antisocial personality disorder, anorexia/bulimia nervosa; and so on. Similarly socially valued traits can also be evaluated, e.g., in individuals gifted with musical talent, charm, charisma, mathematical ability, persuasion, determination, creativity, and so forth. Once a gene or epigenetic factor is discovered it can be used a target for identifying, testing, or designing pharmacological interventions.

Another exemplary application provides a database, which can be used, e.g., to diagnosis, evaluate, and process clinical or commercial information. The methods described herein can diagnose functional brain disorder using multiple quantitative variables (e.g., by oversampling information space.

Still other applications include staging clinical diagnosis of neuropsychiatric in terms of functional impairment caused by non-pschiatric illness or to stage a psychiatric illness; detecting non-clinical variants that may appear as clinical disorders; evaluating and planning treatment of psychiatric illness; monitoring and evaluating treatment efficacy; intervening in narcotics abuse; and monitoring narcotic consumption.

Methods of Evaluating Genetic Material

There are numerous methods for evaluating genetic material to provide genetic information. Genetic information can be obtained by evaluating a subject or a sample from a subject. The sample typically includes nucleated cells, e.g., somatic cells, or nucleic acid extracted from such cells (e.g., genomic DNA or cDNA or mRNA). In embodiments in which genomic DNA is used, virtually any biological sample (other than pure red blood cells) is suitable. For example, convenient tissue samples include whole blood, semen, saliva, tears, urine, fecal material, sweat, buccal, skin and hair. In embodiments in which cDNA or mRNA is used, the tissue sample usually includes cells in which the target nucleic acid is expressed.

Nucleic acid samples can analyzed using biophysical techniques (e.g., hybridization, electrophoresis, and so forth), sequencing, enzyme-based techniques, and combinations-thereof

For example, hybridization to microarrays can also be used to detect polymorphisms, including SNPs. In one implementation, a set of different oligonucleotides, with the polymorphic nucleotide at varying positions with the oligonucleotides can be positioned on a nucleic acid array. The extent of hybridization as a function of position and hybridization to oligonucleotides specific for the other allele can be used to determine whether a particular polymorphism is present. See, e.g., U.S. Pat. No. 6,066,454.

In one implementation, hybridization probes can include one or more additional mismatches to destabilize duplex formation and sensitize the assay. The mismatch may be directly adjacent to the query position, or within 10, 71, 5, 4, 3, or 2 nucleotides of the query position. Hybridization probes can also be selected to have a particular Tₘ, e.g., between 45-60° C., 55-65° C., or 60-75° C. In a multiplex assay, Tₘ's can be selected to be within 5, 3, or 2° C. of each other, e.g., probes for a genetic marker can be selected with these criteria.

U.S. Pat. No. 5,837,832 describes a tiling method for array fabrication whereby probes are synthesized on a solid support. These arrays include a set of oligonucleotide probes such that, for each base in a specific reference sequence, the set includes a first probe (for example, a so-called “wild-type” or “WT” probe) that is exactly complementary to a section of the sequence of the chosen fragment including the base of interest in a first allele and at least one additional probes (called “substitution probe”), which are identical to the WT probe except that the base of interest has been replaced by one of a predetermined set of nucleotides (typically, one, two or three nucleotides), i.e., nucleotides other than the nucleotide in the first probe, for example a nucleotide complementary to a second allele. Probes may be synthesized to query each base in the sequence of the chosen fragment or a particular base known to be polymorphic. Target nucleic acid sequences which hybridize to a probe on the array which contain a substitution probe indicate the presence of a single nucleotide polymorphism. See also, e.g., U.S. Pat. Nos. 5,858,659; 5,861,242; 5,593,839 and 5,856,101 (describing, e.g., variously methods of using computers to design arrays and lithographic masks and methods of detecting insertions and deletions).

The design and use of allele-specific probes for analyzing polymorphisms is described by e.g., Saiki et al., Nature 324, 163-166 (1986); Dattagupta, EP 235,726, Saiki, WO 89/11548. Allele-specific probes can be designed that hybridize to a segment of target DNA from one individual but do not hybridize to the corresponding segment from another individual due to the presence of different polymorphic forms in the respective segments from the two individuals. Hybridization conditions should be sufficiently stringent that there is a significant difference in hybridization intensity between alleles, and preferably an essentially binary response, whereby a probe hybridizes to only one of the alleles. In one embodiment, probes are designed to hybridize to a segment of target DNA such that the polymorphic site aligns with a central position (e.g., in a 15-mer at the 7 position; in a 16-mer, at either the 8 or 9 position) of the probe. This design of probe achieves good discrimination in hybridization between different allelic forms. In one embodiment, the probes include a second mismatch which is non-complementary to both alleles of a biallelic pair. The second mismatch serves to destabilize the duplex, reduce Tm, and increase sensitivity.

Allele-specific probes are often used in pairs, one member of a pair showing a perfect match to a reference form of a target sequence and the other member showing a perfect match to a variant form. Several pairs of probes can then be immobilized on the same support for simultaneous analysis of multiple polymorphisms within the same target sequence.

Other hybridization based techniques include sequence specific primer binding (e.g., PCR or LCR); Southern analysis of DNA, e.g., genomic DNA; Northern analysis of RNA, e.g., mRNA; fluorescent probe based techniques (see, e.g., Beaudet et al. (2001) Genome Res. 11(4):600-8); and allele specific amplification. Enzymatic techniques include restriction enzyme digestion; sequencing; and single base extension (SBE). These and other techniques are well known to those skilled in the art.

Electrophoretic techniques include capillary electrophoresis and Single-Strand Conformation Polymorphism (SSCP) detection (see, e.g., Myers et al. (1985) Nature 313:495-8 and Ganguly (2002) Hum Mutat. 19(4):334-42). Other biophysical methods include denaturing high pressure liquid chromatography (DHPLC). For example, different alleles can be identified based on the different sequence-dependent melting properties and electrophoretic migration of DNA in solution. Erlich, ed., PCR Technology, Principles and Applications for DNA Amplification, (W.H. Freeman and Co, New York, 1992), Chapter 7. Alleles of target sequences can also be differentiated using single-strand conformation polymorphism analysis, which identifies base differences by alteration in electrophoretic migration of single stranded PCR products, as described in Orita et al., Proc. Nat. Acad. Sci. 86, 2766-2770 (1989). Amplified PCR products can be generated as described above, and heated or otherwise denatured, to form single stranded amplification products. Single-stranded nucleic acids may refold or form secondary structures which are partially dependent on the base sequence. The different electrophoretic mobilities of single-stranded amplification products can be related to base-sequence differences between alleles of target sequences.

In one embodiment, allele specific amplification technology that depends on selective PCR amplification may be used to obtain genetic information. Oligonucleotides used as primers for specific amplification may carry the mutation of interest in the center of the molecule (so that amplification depends on differential hybridization) (Gibbs et al. (1989) Nucleic Acids Res. 17:2437-2448) or at the extreme 3′ end of one primer where, under appropriate conditions, mismatch can prevent, or reduce polymerase extension (Prossner (1993) Tibtech 11:238). See also, e.g., WO 93/22456. In one embodiment, the allele specific primer is used in conjunction with a second primer which hybridizes at a distal site. Amplification proceeds from the two primers, resulting in a detectable product which indicates the particular allelic form is present. A control is usually performed with a second pair of primers, one of which shows a single base mismatch at the polymorphic site and the other of which exhibits perfect complementarity to a distal site.

In addition, it is possible to introduce a restriction site in the region of the mutation to create cleavage-based detection (Gasparini et al. (1992) Mol. Cell Probes 6:1). In another embodiment, amplification can be performed using Taq ligase for amplification (Barany (1991) Proc. Natl. Acad. Sci USA 88:189). In such cases, ligation will occur only if there is a perfect match at the 3′ end of the 5′ sequence making it possible to detect the presence of a known mutation at a specific site by looking for the presence or absence of amplification.

Enzymatic methods for detecting sequences include amplification based-methods such a the polymerase chain reaction (PCR; Saiki, et al. (1985) Science 230, 1350-1354) and ligase chain reaction (LCR; Wu. et al. (1989) Genomics 4, 560-569; Barringer et al. (1990), Gene 1989, 117-122; F. Barany. 1991, Proc. Natl. Acad. Sci. USA 1988, 189-193); transcription-based methods utilize RNA synthesis by RNA polymerases to amplify nucleic acid (U.S. Pat. No. 6,066,457; U.S. Pat. No. 6,132,997; U.S. Pat. No. 5,716,785; Sarkar et al., Science (1989) 244:331-34; Stofler et al., Science (1988) 239:491); NASBA (U.S. Pat. Nos. 5,130,238; 5,409,818; and 5,554,517); rolling circle amplification (RCA; U.S. Pat. Nos. 5,854,033 and 6,143,495) and strand displacement amplification (SDA; U.S. Pat. Nos. 5,455,166 and 5,624,825). Amplification methods can be used in combination with other techniques.

Other enzymatic techniques include sequencing using polymerases, e.g., DNA polymerases and variations thereof such as single base extension technology. See, e.g., U.S. Pat. No. 6,294,336; U.S. Pat. No. 6,013,431; and U.S. Pat. No. 5,952,174. For example, Chen et al., (PNAS 94:10756-61 (1997)), describes a locus-specific oligonucleotide primer labeled on the 5′ terminus with 5-carboxyfluorescein (FAM). This labeled primer is designed so that the 3′ end is immediately adjacent to the polymorphic site of interest. The labeled primer is hybridized to the locus, and single base extension of the labeled primer is performed with fluorescently-labeled dideoxyribonucleotides (ddNTPs) in dye-terminator sequencing fashion. An increase in fluorescence of the added ddNTP in response to excitation at the wavelength of the labeled primer is used to infer the identity of the added nucleotide.

Another method to identify SNPs is called single nucleotide primer extension (SnuPE) or minisequencing (Nikiforov et al., Nucleic Acids Res., 22: 4167-75 (1994); Pastinen et al., Clin. Chem., 42: 1391-17 (1996); Landegren et al., Genome Res., 8: 769-76 (1998); Kuppuswamy et al., Proc. Natl. Acad. Sci. U.S.A., 88: 1143-7 (1991)). This technique involves the hybridization of a primer immediately adjacent to the polymorphic locus, extension by a single dideoxynucleotide, and identification of the extended primer. All variable nucleotides can be identified with optimal discrimination using the same reaction conditions. (Pastinen et al., Genome Res., 7: 606-14 (1997)). Related detection methods include luminous detection (Nyren et al., Anal. Biochem., 208: 171-5 (1993)), colorimetric ELISA (Nikiforov et al., Nucleic Acids Res., 22: 4167-75 (1994)), gel-based fluorescent assays (Pastinen et al., Clin. Chem., 42: 1391-7 (1996)), homogeneous fluorescent detection (Chen et al., Genet. Anal., 14: 157-63 (1999)), flow cytometry-based assays (Cai et al., Genomics, 66: 135-43 (2000)), and high performance liquid chromatography (HPLC) analysis (Hoogendoom et al., Hum. Genet., 104: 89-93 (1999)).

Mass spectroscopy (e.g., matrix assisted laser desorption ionization-time of flight (MALDI-TOF) mass spectroscopy) can be used to detect nucleic acid polymorphisms. In one embodiment, (e.g., the MassEXTEND™ assay, SEQUENOM, Inc.), selected nucleotide mixtures, missing at least one dNTP and including a single ddNTP is used to extend a primer that hybridizes near a polymorphism. The nucleotide mixture is selected so that the extension products between the different polymorphisms at the site create the greatest difference in molecular size. The extension reaction is placed on a plate for mass spectroscopy analysis. See, e.g., Haff et al., Genome Res., 7: 378-88 (1997); Griffin et al., Trends Biotechnol., 18: 77-84 (2000); Sauer et al., Nucleic Acids Res., 28: E13 (2000)).

Fluorescence based detection can also be used to detect nucleic acid polymorphisms. For example, different terminator ddNTPs can be labeled with different fluorescent dyes. A primer can be annealed near or immediately adjacent to a polymorphism, and the nucleotide at the polymorphic site can be detected by the type (e.g., “color”) of the fluorescent dye that is incorporated.

It is also possible to directly sequence the nucleic acid for a particular genetic locus, e.g., by amplification and sequencing, or amplification, cloning and sequence. The direct analysis of the sequence can be accomplished, e.g., using either the dideoxy chain termination method or the Maxam-Gilbert method (see Sambrook et al., Molecular Cloning, A Laboratory Manual (2nd Ed., CSHP, New York 1989); Zyskind et al., Recombinant DNA Laboratory Manual, (Acad. Press, 1988)). High throughput automated (e.g., capillary or microchip based) sequencing apparati can be used. In still other embodiments, the sequence of a protein of interest is analyzed to infer its genetic sequence. Methods of analyzing a protein sequence include protein sequencing, mass spectroscopy, sequence/epitope specific immunoglobulins, and protease digestion.

Any combination of the above methods can also be used. For example, allele specific technology can be used in combination with microarrays. See, e.g., U.S. Pat. No. 6,287,778.

Exemplary genetic markers (e.g., polymorphisms) can be found from publicly available resources. Such resources include: the Whitehead Institute's integrated maps of the human genome (e.g., the WICGR map, Cambridge Mass.) which provide aligned chromosome maps of genetic markers; other sequence tagged sites (STSs); radiation hybrid map data; CEPH yeast artificial chromosome (YAC) clones; the Genetic Annotation Initiative (web site: cgap.nci.nih.gov/GAI/; an NIH run site which contains information on candidate SNPs); dbSNP Polymorphism Repository (world wide web site: ncbi.nlm.nih.gov/SNP/; a comprehensive NIH-run database containing information on SNPs and also haplotypes); HUGO Mutation Database Initiative (web site: ariel.ucs.unimelb.edu.au:80/.about.cotton/mdi.htm; a database with information about human mutations including SNPs); Human SNP Database (world wide web site: -genome.wi.mit.edu/SNP/human/index.html; managed by the Whitehead Institute for Biomedical Research Genome Institute, this site contains information about SNPs); SNPs in the Human-Genome SNP database (world wide web site: ibc.wustl.edu/SNP; providing access to SNPs that have been organized by chromosomes and cytogenetic location from Washington University); HGBase (web site: hgbase.cgr.ke.se/; a summary of sequence variations in the human genome from the Karolinska Institute of Sweden); the SNP Consortium Database (web site: snp.cshl.org/db/snp/map; a collection of SNPs and related information resulting from a collaborative effort); GeneSNPs (world wide web site: genome.utah.edu/genesnps/; from the University of Utah and U.S. National Institute of Environmental Health). Many exemplary biallelic markers are also described in publications; see, e.g., U.S. Ser. No. 60/206,615, U.S. Ser. No. 60/216,745, WIPO Serial No. PCT/IB00/00184, WIPO Serial No. PCT/IB98/01193, PCT Publication No. WO 99/54500, and WIPO Serial No. PCT/IB00/00403, US 2002-0037508 and US 2002-0032319.

The following are some examples of types of polymorphisms: A restriction fragment length polymorphism (RFLP) is a variation in DNA sequence that alters the length of a restriction fragment (Botstein et al., Am. J Hum. Genet. 32, 314-331 (1980)). The restriction fragment length polymorphism may create or delete a restriction site, thus changing the length of the restriction fragment. RFLPs have been widely used in human and animal genetic analyses (see WO 90/13668; WO90/11369; Donis-Keller, Cell 51, 319-337 (1987); Lander et al., Genetics 121, 85-99 (1989)). Other polymorphisms take the form of short tandem repeats (STRs) that include tandem di-, tri- and tetra-nucleotide repeated motifs. These tandem repeats are also referred to as variable number tandem repeat (VNTR) polymorphisms. VNTRs have been used in identity and paternity analysis (U.S. Pat. No. 5,075,217; Armour et al., FEBS Lett. 307, 113-115 (1992); Horn et al., WO 91/14003; Jeffreys, EP 370,719), and in a large number of genetic mapping studies.

Other polymorphisms take the form of single nucleotide variations between individuals of the same species. Such polymorphisms are far more frequent than RFLPs, STRs and VNTRs. Some single nucleotide polymorphisms (SNP) occur in protein-coding nucleic acid sequences (coding sequence SNP (cSNP)), in which case, one of the polymorphic forms may give rise to the expression of a defective or otherwise variant protein and, potentially, a genetic disease. Examples of genes in which polymorphisms within coding sequences give rise to genetic disease include β-globin (sickle cell anemia), apoE4 (Alzheimer's Disease), Factor V Leiden (thrombosis), and CFTR (cystic fibrosis). cSNPs can alter the codon sequence of the gene and therefore specify an alternative amino acid. Such changes are called “missense” when another amino acid is substituted, and “nonsense” when the alternative codon specifies a stop signal in protein translation. When the cSNP does not alter the amino acid specified the cSNP is called “silent”. Other single nucleotide polymorphisms occur in noncoding regions. Some of these polymorphisms may also result in defective protein expression (e.g., as a result of defective splicing). Other single nucleotide polymorphisms have no effect, e.g., no phenotypic effect.

Pharmacology and Pharmacogenomics

It is also possible to use the methods described herein to evaluate phenotypes (e.g., by imaging) of a subject undergoing a treatment. Differences in phenotype can be detected by classification (e.g., classification trees). Then associations with a particular genotype can be detected. Other strategies (e.g., in FIG. 19) can also be applied, e.g., in combination with the data analysis methods and data structures described herein. Exemplary treatments include administering an agent (e.g., a medicament) and non-invasive treatments (e.g., hyponosis, psychotherapy, etc.). Homeopathic and traditional medicines as well as social behaviors can be similarly analyzed.

In one embodiment, recursive partitioning is used in a study to do pharmacogenetics, e.g., using subjects undergoing a treatment (e.g., medication or a non-invasive therapy). Classification trees can be used to determine if subjects respond differently to a treatment. Or the classification can be done blind—e.g., evaluate treated subjects and controls to detect if significant classifications are objectively made that discriminate between treated and untreated subjects (e.g., humans and non-humans.).

Imaging

An exemplary method for imaging a subject can include positioning subjects to be tested (e.g. persons who are under going a paradigm) and instructing the subjects to remain as still as possible, information about the brain is acquired. A measuring apparatus which non-invasively obtains information about the brain (e.g., structure and/or function) is used. In one embodiment, the subject to be tested is placed in a brain scanner, e.g., an MRI, fMRI, MEG, fCT, OI, SPECT, or PET system.

The imaged information can be acquired while the subject undergoes an experimental paradigm focused on one or more “motivation/emotion” processes. Alternatively, signals can be acquired while the subject is exposed to certain stimuli (e.g. the subject views photographs of people or food or consumer products) or while the subject performs particular tasks (e.g. presses a bar to get a particular result). Alternatively still, the subject can perform two or more of the above tasks while the CNS signals are obtained.

The signals are statistically analyzed and localized to specific anatomical and functional brain regions. The details of the processes for statistically analyzing the CNS signals and localizing the signals to specific brain regions can vary.

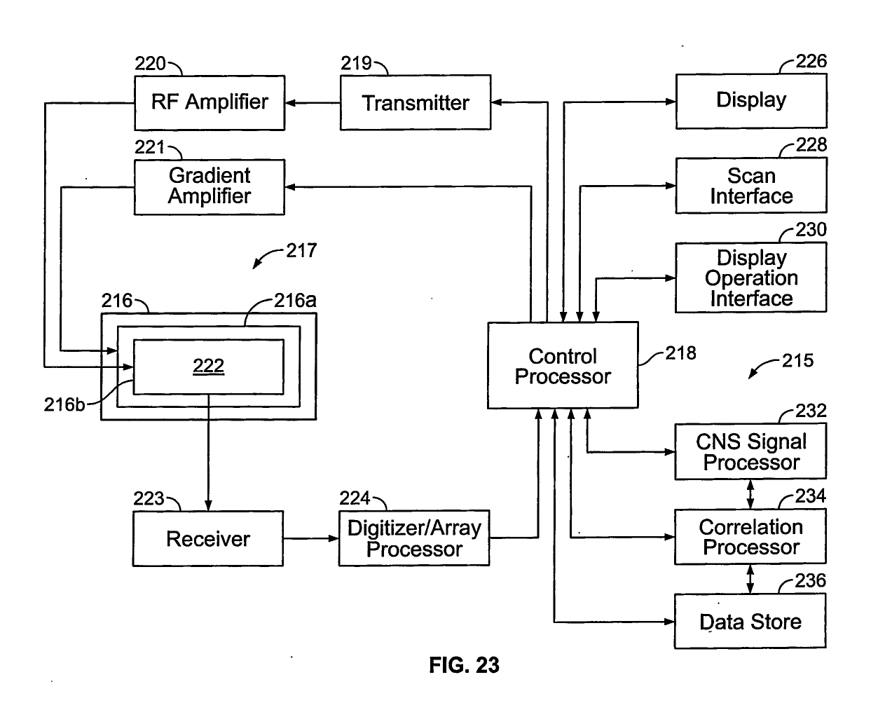

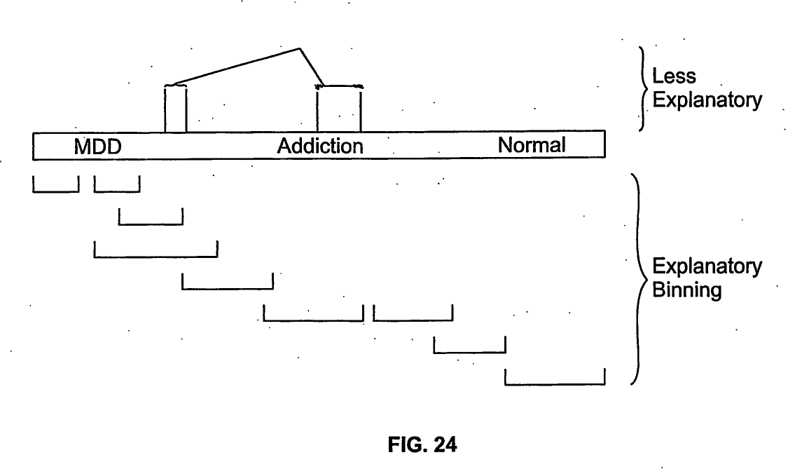

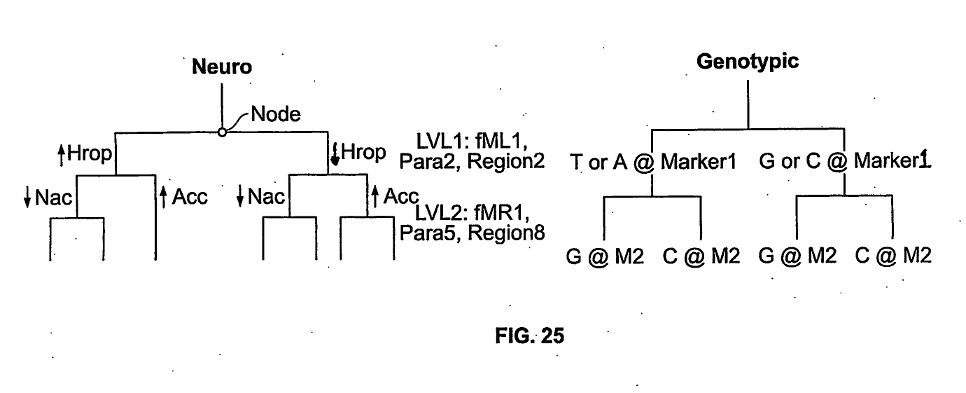

Referring now to the exemplary apparatus in FIG. 23, a noninvasive measurement apparatus and system for measuring indices of brain activity is described, e.g., as follows. In this particular example a magnetic resonance imaging (MRI) system 216 that may be programmed to non-invasively aid in the determination of indices of brain activity during motivational and emotional function in accordance with the present invention is shown. Its should be appreciated however that other techniques including but not limited to fMRI, PET, OI, SPECT, CT, fCT, MRS, MEG and EEG may also be used to non-invasively measure indices of brain activity during motivational and emotional function.

MRI system 215 includes a magnet 216 having gradient coils 216a and RF coils 216b disposed thereabout in a particular manner to provide a magnet system 217. In response to control signals provided from a controller processor 218, a transmitter 219 provides a signal to the RF coil 216b through an RF power amplifier 220. A gradient amplifier 221 provides a current to the gradient coils 216a also in response to signals provided by the control processor 218.

For generating a uniform, steady magnetic field required for MRI, the magnet system 217 may be provided having a resistance or superconducting coils and which are driven by a generator. The magnetic fields are generated in an examination or scanning space or region 222 in which the object to be examined is disposed. For example, if the object is a person or patient to be examined, the person or portion of the person to be examined is disposed in the region 222.

The transmitter/amplifier combination 219, 220 drives the coil 216b. After activation of the transmitter coil 216b, spin resonance signals are generated in the object situated in the examination space 222, which signals are detected and are collected by a receiver 223. Depending upon the measuring technique to be executed, the same coil can be used as the transmitter coil and the receiver coil or use can be made of separate coils for transmission and reception. The detected resonance signals are sampled, digitized in a Digitzer/Aray proceser 224. Digitizer/Array processor 224 converts the analog signals to a stream of digital bits which represent the measured data and provides the bit stream to the control processor 218.

A display 226 coupled to the control processor 218 is provided for the display of the reconstructed image. The display 226 may be provided for example as a monitor, a terminal, such as a CRT or flat panel display.

A user provides scan and display operation commands and parameters to the control processor 218 through a scan interface 228 and a display operation interface 230 each of which provide means for a user to interface with and control the operating parameters of the MRI system 215 in a manner well known to those of ordinary skill in the art.

The control processor 218 can be coupled to a signal processor 232 and a data store 236. The signal processor can be programmed according to a method described herein, e.g., to process raw image information. The processing can include localizing signals to a particular region of the brain.

Some Exemplary Brain Circuits

Brain circuitry includes a prefrontal and sensory cortex. The prefrontal cortex includes medial prefrontal cortex and lateral prefrontal cortex. The region also includes the primary sensory and motor components. These components include the primary somatosensory cortex (S1), the secondary somatosensory cortex (S2), the primary motor cortices (M1), and secondary motor cortices (M2). Motor behavior involves regions such as M1 and M2, along with supplementary motor cortex (SMA). The frontal eye fields (102h) modulate motor aspects of eye control relating to directing the reception of visual signals from the environment to the brain.

Brain circuitry also includes the thalamus region the dorsal striatum region and the lateral and medial temporal cortex regions. The medial temporal cortex region includes, for example, the hippocampus, the basolateral amygdala, and the entorhinal cortex. Also included as part of the brain circuitry are paralimbic regions which include, for example, the insula, the orbital cortex, the parahippocampus and the anterior cingulate. Current perspectives of reward circuitry also include the hypothalamus the ventral pallidum and a plurality of regions collectively designated.

The regions collectively designated comprises the nucleus accumbums (NAc) the central amygdala the sublenticular extended amygdala of the basal forebrain SLEA/basal forebrain or SLEA/BF) the ventral tegmentum (ventral tier) and the ventral tegmentum (dorsal tier).

The regions collectively represent a number of regions having significant involvement in motivational and emotional processing. It should be appreciated that other components such as the basolateral amygdala are also important but not included in the regions designated by reference number. Other regions that are further important to this type of processing include the hypothalamus, the orbitofrontal cortex, the insula and the anterior cingulate cortex. Further regions are also important but listed separately such as the ventral pallidum, the thalamus, the dorsal striatum, the hippocampus, the medial prefrontal cortex, and the lateral prefrontal cortex. Not listed in this figure but also involved in processing sensory information for its emotional implications is the cerebellum.

The functional contribution of each of these major regions are discussed below. It should be noted that what follows is a gross simplification and does not convey the complexity nor the diversity of the functions that these regions have been implicated with and may in the future be connected to. Further note that there is currently a debate regarding the modular vs. non-modular function of these brain regions, i.e., can a specific function be attributed to each region in isolation. Accordingly what is listed below is information which provides one of ordinary skill in the art with the understanding that this function may be mediated by the connection of this region with many other regions (i.e., the function mediated by a distributed set of regions, of which the identified region is a fundamental component).

As a brain region the NAc has previously been implicated in the processing of rewarding/addicting stimuli, and is thought to have a number of functions with regard to probability assessments and reward evaluation. It has also has been implicated in the moment by moment modulation of behavior (e.g., initiation of behavior). Signals measured from the NAc are shown and described below in conjunction with FIGS. 3A-3D.

The SLEA/BF has been implicated in reward evaluation, based on its likely role in brain stimulation reward effects. It is thought to be important for estimating the intensity of a reward value. It and other sections of the basal forebrain appear to be important for the processing of emotional stimuli in general, and it has been implicated in drug addiction.

Like the NAc, the amygdala has been implicated in both processing of emotional information along with processing of pain and analgesia information. The amygdala has been implicated in both the orienting to and the memory of motivationally salient stimuli across the entire spectrum from aversion to reward. It may be important for the processing of signals with social salience in real time. In this context it is often referred to with regard to fear. A number of its anatomical connections to primary sensory cortices, suggest that it is important for the modulation of attention to motivationally salient stimuli.

With respect to the VT/PAG, doparminnergic projections are present from the VT to the SLEA, the orbitofrontal cortex, the amygdala, and the NAc. Indeed dopaminergic projections go to most subcortical and prefrontal sites. In FIG. 3, the fundamental importance of the VT/PAG projection is focussed on the NAc, central Amygdala, and SLEA/B, though it also projects to other regions. The VT has been implicated in reward prediction processes, motor functions and a number of learning processes around motivational events in general. The PAG has also been implicated as a modulator of pain stimuli, for example, and may therefore be a region that signals early information on rewarding or aversive stimuli.

The GOb component of the prefrontal cortex has been implicated in a number of cognitive, memory, and planning functions around emotional stimuli or regarding rewarding or aversive outcomes in animal and human studies. This section of the prefrontal cortex has also been implicated in modulating pain. It has afferent and efferent connections with a number of subcortical structures. The GOb is involved in a number of different reward processes including those of expectancy determination and reward valuation. Patients with lesions in this region tend to have impulse control problems.

The hypothalamus is involved in the monitoring and maintenance of homeostatic systems. It also has been both implicated in the evaluation of the relevance for rewarding and aversive stimuli in order to maintain homeostatic equilibrium. The hypothalamus is highly important for meeting the objectives which optimize fitness over time and meet the requirements necessary for survival.

The cingulate cortex has been interpreted to be involved in attention and planning, the processing of pain unpleasantness, the processing of reward events and emotions in general, and the evaluation of emotional conflict. The cingulate cortex is an extensive region of brain cortex and appears to have emotional and cognitive subdivisions, to name a few.

The insula has been implicated in number of functions including the processing of emotional stimuli, the processing of somatosensory functions, and the processing of visceral function.

The thalamus is composed of a number of sub-nuclei which have been implicated in a diverse range or functions. Fundamental among these functions appears to be that of being an informational relay of sensory and other information between the external and internal environment. It has also been directly implicated in both rewarding and aversive processes, and damage to the structure may result in dysfunction such as chronic pain.

The hippocampus has been extensively implicated in functions for encoding and retrieval of information. Lesions to this structure lead to severe impairment in the ability to form new memories. Motivated behavior is heavily dependent on such memories: for instance, how a particular behavior in the past led to obtaining a goal object which would reduce a particular deficit state such as thirst.

The ventral palladium is one of the primary output sources of the NAc and has a number of projection sites including the dorsomedial nucleus of the thalamus. Via this connection, it is one of the major relays between the NAc and the rest of the brain, in particular prefrontal cortical regions. It has been strongly implicated in reward functions and is a site thought to be important for the development of addiction.

The medial prefrontal cortex of the brain has been strongly implicated in reward functions and has been found to be one of the few brain sites into which cocaine self-administration can be initiated in animals.

In response to reward and aversion situations, certain regions of the brain circuitry play a role in processing reward/aversive information to plan behavioral responses as discussed above. These regions are designated reward/aversion regions of the brain. The activation of such reward/aversion regions can be observed during positive and negative reinforcement using neuroimaging technology. These reward/aversion regions produce specific functional contributions to motivated behavior. For example, contributions made by regions such as the include assessment of probability.

Morphometric Information

Morphometric information about brain structures provides useful indicators of resistance/susceptibility to a disorder or abnormal behavior, therapeutic efficacy, and the presence and staging of active illness (e.g., an active disorder or abnormal behavior). Morphometric information includes information that describes a spatial and/or structural property of a brain structure or relevant part thereof. An example of a brain structure is the amygdala. In the case of cocaine addiction, the right amygdala and certain subnuclei (e.g., as mentioned below) may be particularly relevant. Other examples of brain structures are provided in Table 1.

Morphometric information can be in the form of a morphometric parameter, e.g., a quantitative or qualitative parameter. A quantitative measure of volume is one form of a morphometric parameter. Coordinates or equations describing a surface of a brain structure are another example. Morphometric information can be absolute, e.g., relative to a particular coordinate-frame, or can be relative. For example, a linear distance measure of the extent of over- or under-cutting of a brain structure surface of a subject relative to a reference brain structure is a useful form of relative information. To illustrate, we have observed in one set of cocaine addicted individuals that the volume of the right amygdala is decreased about 23% and that relative to an iso-surface based on probability 0.5, addicted individuals have an undercutting in the anterior extent of about 4.5 mm.

The use of morphometric information, e.g., as described herein, will aid in the diagnosis of behavioral disorders and neuropsychiatric disorders as well as in the discovery of drugs and other therapies for treating such disorders.

In one implementation, a virtual reference structure is created, e.g., representing a statistical function for a brain structure among a cohort of individuals, e.g., individuals with a common characteristic. For example, the cohort can be a cohort of normal controls, a cohort of disorder affected individuals, e.g., substance affected individuals, or bipolar disorder-affected individuals. Using images taken of the brain or regions thereof, brain structures can be segmented as individual structures, following standardized anatomic definitions. Caviness, V. S., Jr., Kennedy, D. N., Richelme, C., Rademacher, J., and Filipek, P. A. (1996). The human brain age 7-11 years: a volumetric analysis based on magnetic resonance images. Cereb Cortex 6, 726-736; Makris, N., Meyer, J. W., Bates, J. F., Yeterian, E. H., Kennedy, D. N., and Caviness, V. S. (1999). MRI-Based topographic parcellation of human cerebral white matter and nuclei II. Rationale and applications with systematics of cerebral connectivity. Neuroimage 9, 18-45; Makris, N., Worth, A. J., Sorensen, A. G., Papadimitriou, G. M., Wu, O., Reese, T. G., Wedeen, V. J., Davis, T. L., Stakes, J. W., Caviness, V. S., et al. (1997). Morphometry of in vivo human white matter association pathways with diffusion-weighted magnetic resonance imaging. Ann Neurol 42, 951-962; Seidman, L. J., Faraone, S. V., Goldstein, J. M., Goodman, J. M., Kremen, W. S., Toomey, R., Tourville, J., Kennedy, D., Makris, N., Caviness, V. S., and Tsuang, M. T. (1999). Thalamic and amygdala-hippocampal volume reductions in first-degree relatives of patients with schizophrenia: an MRI-based morphometric analysis. Biol Psychiatry 46, 941-954; Seidman, L. J., Faraone, S. V., Goldstein, J. M., Kremen, W. S., Horton, N. J., Makris, N., Toomey, R., Kennedy, D., Caviness, V. S., and Tsuang, M. T. (2002). Left hippocampal volume as a vulnerability indicator for schizophrenia: a magnetic resonance imaging morphometric study of nonpsychotic first-degree relatives. Arch Gen Psychiatry 59, 839-849. Segmentation can be performed manually, semi-automatically, or automatically.

Images can be registered (aligned), e.g., to a reference brain that was separate from the cohort. A probability surface (or “isoform surface” or “iso-surface”) for a particular structure for each cohort can be calculated, e.g., on a voxel-by-voxel basis with the aligned data. Iso-surfaces for a pre-selected probability value (e.g., probability 0.5) are created for each cohort separately. Three-dimensional visualization of these surfaces can be used to look for systematic differences in the topology of the brain structure between cohorts, or to evaluate a brain structure of a subject in comparison to the cohort.

The following non-limiting example illustrates some aspects of the methods described herein in one particular implementation

### EXAMPLE (PART 1)

Cocaine and nicotine are two of the most acutely reinforcing drugs in humans and in animals; they are also profoundly addicting, and have a strong comorbidity with depression. Twenty-five percent of the U.S. Population suffers from nicotine dependence, and smoking leads to about 500,000 deaths per year. Major depression is the most common psychiatric disorder in the U.S. today, and the number one cause of mortality in the world. It is frequently co-morbid in individuals that cease nicotine or cocaine self-administration. Baseline anhedonia or dysthymia is also hypothesized to be a causal factor in the development of nicotine dependence and is observed in individuals between episodes of cocaine self-administrations. Long-term use of psychostimulants and the ensuing dependence has pronounced effects on the circuitry of reward-aversion. Recent neuroimaging and post-mortem stereology have also documented functional and morphometric changes in the brain circuitry of reward-aversion with mood disorders (Manji H K, Drevets W C, Charney D S. (2001) The cellular neurobiology of depression. Nat Med. 7:541-7.; Ongur D, Drevets W C, Price J L.( 1998) Glial reduction in the subgenual prefrontal cortex in mood disorders. Proc Natl Acad Sci USA. 95:13290-5.).

The neural circuitry that mediates the rewarding (i.e., hedonic) effects of psychostimulants (Koob et al., 1998), or the rewarding and aversive effects of other stimuli (Wise et al., 1978; Wise, et al., 1992; Koob, 1992; Stein & Fuller, 1992; Kornetsky & Esposito, 1981), can be readily studied by fMRI BOLD to obtain quantitative measures of changes in brain activity. These circuits include the: nucleus accumbens (NAc), sub-lenticular extended amygdala (SLEA) of the basal forebrain, amygdala, ventral tegmentum (VT), and orbital gyrus (GOb), along with other paralimbic regions such as the anterior cingulate, insula, parahippocampus, and temporal pole. Together, these brain regions (referred to as the reward-aversion circuitry) appear to be fundamental to the assessment of motivationally salient informational features for organizing behavior.

In humans, these brain regions have been shown to process expectancy and valuation information and the sequential effects of expectancy on subsequent outcomes. The differential valuation of rewarding vs. aversive outcomes utilizes the same brain circuitry, and unique signal profiles in a subset of these regions have been mapped for rewarding vs. aversive stimuli. We can characterize the relative contributions made by each of these subregions to discrete components of reward-aversion function in different individuals using paradigms (e.g., paradigms described in Breiter et al., 1996; Cohen et al., 1996; Seidman et al., 1998; Breiter & Rosen, 1999; Aharon et al., 2001; Becerra et al., 2001; Breiter et al., 2001). Thus, we can sample, for example:
(1) stimulus input and representation,
(2) feature extraction necessary for assessing motivational intent in others,
(3) probability functions necessary for expectancy determination,
(4) expectancy vs. outcome functions,
(5) valuation functions, and
(6) positive vs. aversive outcomes.
   We can develop a systems biology map, e.g., by using information from at least two of these functions. The map can describe how a stimulus that is rewarding or aversive is processed.

In this exemplary case, the system assessed determines reward-aversion function and acts as an informational backbone for motivation. The ability to produce such system biology maps in individuals further gives us a precise mechanism by which to characterize malfunctions in this circuitry that quantitatively characterize functional brain disorders such as stimulant addiction and depression.

Circuitry-based events responsible for behavior and intracellular signaling events, at very different spatiotemporal scales of brain function, are interlinked and that processes at the distal ends of this spatiotemporal continuum can serve as markers, e.g., for genetic analysis.

Analysis of brain structure and/or function produces a set of quantitative indices (e.g., a systems biology map) which can be associated with genetic information from the subject. Typically such genetic information includes markers on a plurality of different non-homologous chromosomes. When sufficient number of individuals are analyzed, statistics can be used to evaluate the relationship between genotype and phenotype. Linkage from a set of quantitative indices, such as the multitude of quantitative measures in a systems biology map, to the quantitative measures of molecular genetics can pinpoint the genes that contribute to susceptibility and/or resistance to functional brain disorders such as addiction and depression.

### EXAMPLE (PART 2)

### Detailed Methods

(a) Subject Recruitment, Screening, and Scheduling

For Ph1, a total of 500 subjects (plus 8% of this number as potential replacements) will be recruited for scanning over one year (months 6-months 18 of the project, and then rescanned during months 19-30). For Ph2, a total of 800 subjects per year (plus 8% of this number as potential replacements) will be recruited over 4 years (total=3200+replacements). All phases of this project will be conducted according to the U.S. Food and Drug Administration guidelines and the Declaration of Helsinki. To protect all sensitive data, we will obtain a Certificate of Confidentiality from NIH. Written informed consent will be obtained from all patients before protocol-specified procedures are carried out. Subjects will be drawn from an outpatient sample, and will be recruited through general media, as well as physician referrals.

Inclusion Criteria: The following conditions must be met for patient eligibility:
(1) Written informed consent.
(2) Men and women aged between 20-65 years, as sib pairs who are concordant for the criteria below, discordant, or in nuclear families with these diagnoses).
(3) Nicotine dependent subjects:
   a. Smokers who have smoked>10 cigarettes/day for more than 2 years
   b. Meet DSM-IVR criteria for Nicotine Dependence, as determined with the Fagerstrom Nicotine Tolerance Questionnaire (FTQ) (Fagerstrom, 1978)
   c. Saliva cotinine levels>14 ug/L, and end-expiratory carbon monoxide levels>8 ppm (subjects with alcohol dependence will be excluded).
(4) Cocaine dependent subjects:
   a. DSM-IVR diagnosis of cocaine dependence (who are actively using cocaine at the time of entry and are not seeking or participating in treatment for addiction) without other Axis I psychiatric illnesses or past experience of violent behavior while abusing cocaine or opiates. Exceptions will be made for dependence on caffeine or for mild (less than 3 standard drinks/week) consumption of alcohol.
   b. Validation of subjects self-reported drug use will be performed using hair specimens assayed for levels of commonly abused drugs. Our previously published data indicate that self-reported substance use in our non-treatment seeking research subjects is generally valid (Elman et al., 1999).
(5) Subjects with recurrent major depressive disorder:
   a. DSM-IVR criteria for lifetime diagnoses of Unipolar Depressive Disorders (major depression, dysthymia, and minor depression), according to the Structured Clinical Interview for DSM-IV—Axis I Disorders/Patient Edition (SCID-I/P) (First et al., 1995) and Inventory for Depressive Symptomatology (Rush et al., 1986, 1996; Gullion et al., 1998). The DSM-IVR SCID approach will be used by clinicians, and complemented with a SSAGA-II performed by trained research assistants.
(6) Subjects with (3) and/or (4) and/or (5) (see Dierker et al, 2002)
(7) Healthy controls without (3) or (4) or (5)

Exclusion Criteria: In brief, subjects with any of the following will be excluded: pregnancy; suicidality or homocidality; serious medical illness including HIV+ status; severe respiratory compromise; current use of nicotine-containing products in subjects without nicotine dependence; history of seizure disorder; delirium, dementia, or mental disorders due to general medical conditions; substance abuse not specified above; schizophrenia; schizo-affective disorder; delusional disorder; bipolar disorder; psychotic disorders not elsewhere specified; antisocial personality disorder, unless comorbid with cocaine dependence; current anorexia/bulimia nervosa; clinical laboratory evidence of hypothyroidism/hyperthyroidism.

(b) Experiments

The six experimental paradigms listed below will be run with all subjects in Ph1 and Ph2. For each subject, these six paradigms will be run in the order in which they are listed. The time needed for each paradigm will be:

#1 social reward paradigm, 22 minutes,

#2 CPT/probability paradigm, 4½ minutes,

#3 physiological aversion/pain paradigm, 4½ minutes,

#4 mental rotation paradigm, 8 min and 54 seconds,

#5 emotional faces paradigm, 11½ minutes,

#6monetary reward paradigm, 24 minutes.

Between each paradigm, 2 minutes are scheduled for the overall imaging session to allow the reading of the next set of instructions. The total time for functional imaging will thus be 75½ minutes, plus approximately 10 minutes for 5×2 minute pauses between the scanning of each paradigm. This thus leaves 35 minutes for structural scanning described in the imaging section. Of these 6 paradigms, 4 of them have a traditional block design (#2-#5), while 2 of them (#1 & #6) have a single trial-like design. These paradigms have been chosen because they robustly activate reward-aversion circuitry, to produce a systems biology map.

(1) Social Reward Paradigm (Aharon et al., 2001)

Social stimuli will consist of two sets of 40 non-famous human faces [digitized at 600 dpi in 8-bit grayscale, spatially down sampled, and cropped to fit in an oval “window” sized 310-350 pixels wide by 470 pixels high using Photoshop 4.0 software (Adobe Systems)]. Each set will consist of 20 male and 20 female faces. Subjects will be told that they will be exposed to a series of pictures that if not interfered with, will change every eight seconds. However, if they want a picture to disappear faster, they can alternate pressing the “z” and “x” keys, whereas if they want a picture to stay longer on the screen, they can alternate pressing the “n” and “m” keys. The dependent measures of interest will be the amount of work in units of key press that subjects exert in response to the different categories of stimuli, and their resulting viewing durations.

Each pair of key presses will be set to increase or decrease the total viewing time according to the following formula: NewTotalTime=OldTotalTime+(ExtremeTime−OldTotalTime)/K, where ExtremeTime was 0 seconds for keypresses reducing the viewing time, ExtremeTime will be 14 seconds for keypresses increasing the viewing time, and K was a scaling constant set to 40. If the elapsed time for the picture surpassed the total time determined by keypressing, the picture was removed and the next trial began. A “slider” was displayed left of each picture indicating total viewing time at any moment, and changing with every keypress. Subjects will be informed that the task will last 40 minutes, and that this length is independent of their behavior during the task, as is their overall payment for participating in the experiment.

(2) CPT with Differential Probability Conditions (Breiter & Rosen, 1999; Seidman et al., 1998)

The set of experimental conditions in this study are designed to parse out differences in vigilant attention during a serial processing continuous performance task [CPT-AX(del)], involving a simple probabilistic relationship between a cue and delayed target, versus a dual processing continuous performance task [CPT-AX(int)], with a complex probability relationship between a cue and delayed target. The conditional probability of a subsequent target, given the incidence of a cue, will be the same between tasks since the CPT-AX(del) and CPT-AX(int) tasks have the same total number of cue-target pairs, and the same total incidence of true cues plus false cues. The tasks will be different in that the determination of cue-target pairs is more effortful for the CPT-AX(del) task, due to divided processing and interference suppression needs. The effortful determination of cue-target pairs will impair probability computation and lead to diminished task performance.

The two paradigm conditions will involve computer presentation of an auditory letter string, with each letter spoken at a rate of 1 per second. These paradigms will have an A-B-A-C-A-C-A-B-A design where the A condition will be a simple CPT (referred to as the “QA” sequence), and the B condition will be an effortful CPT with three letters between cue and target pairs. The B and C conditions will involve either serial processing (CPT-AX(del)) or divided/dual processing (CPT-AX(int)). The CPT-AX(del) is characterized by a lack of false cues or targets between each cue (“q”) and target (“a”) pair, or by any interdigitated cue-target pairs (i.e., “q”_“q”_“a”_“a”), thus allowing simple probabilistic assessment of cue to target pairing with serial association of stimulus and response. The CPT-AX(int) has false cues and/or targets between pairs of cues and targets, and has cue-target pairs interdigitate together so that commingled pairs were possible, thus preventing simple counting or rehearsal procedures (i.e., forcing subjects to maintain two or more counts), and increasing the effort needed for probabilistic assessment of cue to target pairing. Each B and C epoch will last 90 seconds, while the baseline A epochs will last 60 seconds. There will be a target to distracter ratio of 0.13 for both A and B conditions, and the number of cue-target pairs will be the same. Subjects will respond with a magnet compatible button press, so that reaction time and accuracy could be recorded. The order for performing the CPT-AX(del) and the CPT-AX(int) will be counterbalanced across subjects.

(3) Physiological Aversion (Thermal Pain) (Becerra et at, 2001)

Subjects will be informed in detail about the nature of the experiment, and the temporal sequence of procedures, including rating methods. These rating will involve rating on a scale from 0 (no pain) to 10 (maximum pain) their perception of the pain they experienced, after the functional run. Thermal stimuli will be delivered using a modified [Becerra et al., 1999] Peltier based thermode (Medoc, Haifa, Israel). One scan will be performed during which a base temperature of 35° C. (30 s) (condition A), a warm stimulus of 41° C. (25 s) (condition B), and a target temperature of 46° C. (condition C) will be interleaved. The thermode will be set to change the temperature at a rate of 4° C./s. Thus, it will take 2 s to reach 41° C. from the baseline and 2 s to return to baseline, while for the 35-46° C. contrast, the delay will be 4 seconds. The delays were not part of the baseline (30 s) or stimulus (25 s) times. The three stimuli will be interleaved in a block design: A-B-A-C-A-C-A-B-A.

(4) Mental Rotation (Cohen et al., 1996)

The figures will be the original Shepard and Metzler (1971) objects. They will thus consist of three-dimensional perspective drawings of 10 cubes arranged in chiral patterns and viewed from a variety of rotation angles. Two task variants will be used. In a control condition, subjects will be shown a pair of figures, half of which are identical, and half of which are mirror-reversed shapes. Each of the 10 possible angled-shapes (0-180° in 20° increments) will appear in each type of pair. The stimulus ordering will consist of a set of blocks, so that each of the stimuli appear once before any stimulus appears twice, and each appears twice before any appears three times, and so forth. Within each of these blocks, the stimuli will appear in random order except that the same stimulus will not appear twice within three successive trials. Moreover, half of the pairs within each block will include identical figures and half include mirror-reversed figures. No more than three consecutive trials can have the same response.

The second version of the task (a rotation variant) will be identical to the first except that the members of each pair will be presented at different orientations. The left member will always be presented so that the major axis is vertical. The right member will be presented at nine possible angles (20-180° in 20° increments) from vertical. Three sets of these rotation trials will be used (and 4 sets of control trials), which will include rotations around different major axes. One set will include rotations around the x-axis, another around the y-axis, and another around the z-axis. These stimuli will be presented in separate sets. Within each set, the stimulus trials will be ordered so that each orientation appears once before it appears again, once with identical stimuli and once with mirror-imaged stimuli, within each balanced subgroup of 18 trials. The same orientation will not appear twice within three consecutive trials.

A third “resting” or fixation condition will be interleaved between the “control” and “rotation” tasks. Subjects will be asked to look at each pair, and to decide whether the figures are identical or are mirror-images and to indicate their choice by pressing one of two buttons. In the control condition, subjects will be asked to simply respond as quickly and accurately as possible. In the rotation condition, they will be told to visualize the right-hand stimulus rotating until it is aligned with the left-hand stimulus, and then to decide whether the two shapes are identical or are mirror reversed.

(5) Emotional Faces (Breiter et al., 1996)

Faces used in these experiments will be from Ekman and Friesen (1976). They will have been standardized by (a) digitization, (b) scaling of extents, (c) normalization of contrast across all expressions for each of the individuals utilized (N=8), and across all individuals in the cohort., and (d) fitting with an oval mask to minimize the observation of hair.

The experiment will employ an A-B-A-C-A-D-A-B-A-D-A-C-A-B-A design with equal length epochs of tachistoscopic-like presentations of the faces as. In A, subjects will see 180 presentations of 8 faces in random order; neutral expressions (200 msec) will be followed by a fixation point (300 msec). In B, C, and D, subjects will see faces with one emotion presented 180 times per epoch with the same timing parameters as in A. These facial expressions will be: happy (B), angry (C), and fearful (D). The order in which these blocks of facial expression are presented will be counterbalanced by emotion, and by epoch order within run. This will be a covert paradigm design with passive viewing of tachistoscopic-like face presentations, and use of the same 8 individuals for each expression presented in random order per epoch.

(6) Monetary Expectancy, Gains, and Losses (Breiter et al. 2001)

In this experiment we seek to map the hemodynamic changes that anticipate and accompany monetary losses and gains under varying conditions of controlled expectation and counterfactual comparison. The display will consist of either a fixation point or one of 2 disks (“spinners”). Each spinner will be divided into 2 sectors. Both spinners will offer the same outcomes, a gain of $+10 or a loss of $−8, but the likelihood of the gain will be high (0.66) on the “good” spinner and low (0.33) on the “bad” spinner. The relative areas of the spinner assigned to the two outcomes represent the likelihoods. Thus, on the good spinner, 66% of the area is colored green and labeled $+10, and the remaining 33% of the area is colored red and labeled $−8; on the bad spinner, the colors and labels are reversed. Providing larger gains than losses will be implemented to compensate for the tendency of subjects to assign greater weight to a loss than to a gain of equal magnitude.

Before the game begins, subjects will be shown each spinner 3 times so as to learn its composition. Each trial will consist of (1) an “expectancy phase,” when a spinner is presented and an arrow spins around it, and (2) an “outcome phase” when the arrow lands on one sector and the corresponding amount is added to or subtracted from the subject's winnings. During the expectancy phase, the image of one of the 2 spinners will projected for 10 sec, and the subject will score their emotional response to the displayed spinner (or fixation point) using a potentiometer. During the outcome phase, the arrow will land on one of the sectors and flicker for 9.5 seconds, indicating how much they won or lost. During this time, subjects will score their emotional response to the observed outcome. After 9.5 seconds, a 0.5 second mask will appear. On fixation-point trials, an asterisk will appear in the center of the display for 19.5 sec, followed by the 0.5-sec mask. The pseudo-random trial sequence will be fully counter-balanced to the first order so that trials of a given type (spinner+outcome) are both preceded and followed by the same number of 4 spinner/outcome combinations and 2 times by fixation-point trials. Subjects will observe 24 trials of the +$10 outcome, 24 trials of the −$8 outcome, and 16 trials of spinner baseline. A “dummy” trial will be inserted at the beginning and end of each run for counterbalancing, allowing 18 trials per run for 4 runs. Runs will be separated by 2 min rest periods. The same trial sequence will be used for all subjects, generating winnings of $48, to which will be added the $50 endowment.

(c) Imaging (3T and 7T)

Five hundred subjects in Ph1 and potentially 3200 subjects in Ph2, plus replacement subjects, will be scanned on a 3.0 T Allegra System (Siemens) using a quadrature Siemens head coil. The Siemens system performs a whole head shimming procedure before scanning begins, which incorporates a full array of second order shims to optimize B0 homogeneity, and thus reduce susceptibility/resistance in targeted reward-aversion regions of interest. Imaging for all experiments will begin with a 3-plane scout scan (conventional FLASH sequence with isotropic voxels of 2.8 mm). The axial and coronal scouts will be used for placement and prescription of a 3D MPRAGE anatomic scan, which will be used for anatomic localization of functional activation, and quantitative volumetric measurements. Prescription of experimental slices will follow this sequence with 30 slices parallel to the AC-PC line and covering the NAc, amygdala, SLEA, hypothalamus, VT and GOb, along with most of the lateral prefrontal cortex, and components of the parietal-occipital junction. BOLD imaging will then be performed using a gradient echo T2* weighted sequence (TR/TE=2000/29 ms,; FOV=20 cm; in-plane resolution 3.125×3.125 mm, slice thickness=3 mm; 30 contiguous axial slices).

For Ph1, 100 subjects will be scanned on a 7.0T ultra high field system developed for functional brain studies. If the results of comparison between the 3T and 7T systems are favorable to the 7T system, then the 3200 subjects of Ph2 will be scanned on it. The 7T system consists of a whole body magnet (Magnex Scientific) with a custom made resistive shim set (through 3rd order) and custom head gradient set. The study will obtain a 3D MPRAGE anatomic scan, and then a conventional T2 scan at the same slice locations as the functional prescription. Functional imaging will consist of a high resolution (1.5 mm×1.5 mm×3 mm) single shot gradient echo sequence, covering less brain volume than the 3T scanning protocol, but including the NAc, amygdala, SLEA, hypothalamus, VT and GOb, along components of the lateral prefrontal cortex and the parietal-occipital junction.

(d) Data Analysis of Neuroimaging Data

Anatomic Segmentation/Parcellation for Volumetrics and Activation Localization

The anatomic scans of all subjects will undergo segmentation and parcellation. Segmentation methodology based on intensity contour and differential intensity contour concepts can be used (see, e.g., Kennedy et al., 1989; Caviness et al., 1996; Filipek et al., 1994; Rademacher et al., 1992). The cortical parcellation technique is based upon the concept of limiting sulci and planes and takes advantage of the observed relationships between cortical surface features and the location of functional cortical areas. A critical advantage of this method is that the definitions are unambiguously definable in a standardized fashion from the information visible in high resolution MRI.

To perform this process with 500+ subjects for Ph1 and 3200+ subjects for Ph2, we can use an automated, fully 3D procedure for whole-brain segmentation. The technique uses a set of manually labeled brains as a training set in order to compute prior probabilities and class statistics, and applies a Bayesian classification rule. Specifically, we compute the maximum a posteriori (MAP) estimate of the segmentation W given an input image I and prior information from the training set. Formally this can be expressed as maximizing p(W/I), the probability distribution of the segmentation given the observed image intensities. The prior probability of a given segmentation is initially encoded assuming that the classification at each voxel is independent of all other voxels. This constraint is then relaxed, and the image is iteratively resegmented using an anisotropic Markov-random field to model the image segmentation, resulting in a final segmentation that is more spatially uniform as well as more accurate than the initial one.

Manually parcellated surfaces will also be used as a training set that can be employed to construct classifiers in an analogous manner to the sub-cortical segmentation procedure. This process will depend on two properties of the cortical surface. The first is mean curvature of the surface, a differential measure of the surface folding computed from the trace of the Hessian matrix of the height function of the surface over its tangent plane at each point. The second is the average convexity of the surface (Fischl et al., 1999), a measure that is more sensitive to the presence of primary folds than to secondary or tertiary folds. The initial labeling is performed by assuming the classification is spatially independent, so that the probability of the neuroanatomical label at each point in the cortex is independent from all other cortical locations. This is of course not the case, as the probability of each label is related to the labels of the neighborhood in which it lies. In order to capture the spatial regularity of the labeling, we model the surface labeling using an anisotropic Markov random field. The anisotoropy comes from the observation that labels are much more likely to change as one moves across the cortex in the direction of maximum curvature (i.e. the first principal direction) than in the direction of minimum curvature (i.e. the second principal direction). This information is encoded in the form of Gibbs priors on the probability of a given labeling. The most probable labeling is then iteratively recomputed using the independent spatial labeling as input, using the Iterated Conditional Modes (ICM) algorithm (Besag, 1974).

To further investigate the surface-based structure of each subjects' brain, we will further use a set of automated tools for the construction of geometrically accurate and topologically correct models of the cortical sheet. These include accurate segmentation of gray matter and white matter (Dale et al., 1999), inflation and flattening of the surface models for visualization and analysis purposes (Fischl et al., 1999, 2000, 2002; Sereno et al., 1995), and automatic correction of topological defects (Fischl et al., 2002). The explicit construction of both the gray/white and pial surface boundaries allows the accurate measurement of the thickness of the cortical sheet (Fischl et al., 2000). The thickness of cortex is a potentially important diagnostic measure for a variety of neurodegenerative and psychiatric disorders, many of which are associated with progressive, regionally specific atrophy of the gray matter (for instance, consider alterations in prefrontal and temporal cortex volume observed with cocaine dependence; Franklin et al., 2002).

FMRI Data Preparation

For this project, four of the experimental paradigms have a traditional block design, and 2 have a single trial-like design. For the block design experiments, data preparation will generally follow the procedures specified in Aharon et al. (2001), while for the single trial-like designs, it will generally follow procedures specified in Breiter et al. (2001). In Ph1, data preparation and assessment of main effects between groups (below) will involve analysis using FSL/FS Fast. As an example of the process planned for data preparation, data preparation will involve motion correction, intensity normalization, signal detrending, and spatial filtering. For example, after motion correction, time series data will be inspected to ensure that no data set evidences residual motion in the form of cortical rim or ventricular artifacts >1 voxel. Functional data will then be intensity scaled on a voxel-by-voxel basis to a standard of 1000, so that all mean baseline raw magnetic resonance signals are equal. These data will then be detrended to remove any linear drift over the course of the scan. Spatial filtering will be performed using a Hanning filter with 1.5 voxel radius (this approximates a 0.7 voxel gaussian filter). Lastly, the mean signal intensity for each voxel over all runs will be removed on a time point by time point basis. For the single trial-like experiments, data will further be selectively averaged and normalized relative to the 4 time points of data preceding the trial (see Breiter et al., 2001).

The data analytic procedures used in this project will be based on two assumptions, (a) that the behavior of the hemodynamic control system is approximately linear (i.e., it obeys the superposition axiom) under the experimental conditions tested and in the brain regions targeted by these paradigms, and (b) that deviations from hemodynamic stationarity will be correctable by means of the normalization procedures employed. If the hemodynamic control system obeys superposition and stationarity, then the counterbalancing procedure used in each paradigm ensures that any carryover of hemodynamic responses from antecedent experimental conditions will be constant across conditions.

Two separate approaches will be applied to the evaluation of salient changes related to experimental condition. The first will be based on the evaluation of individual data on its native anatomy. The second will be based on the evaluation of aggregate effects on averaged data that are then evaluated within all individuals in the cohort, using a standardized anatomical space.

Individual data on native anatomy: Individual analyses will be pursued since aggregate analyses may produce Type I errors in the case of (1) opponent responses to different experimental conditions, which would tend to cancel as a result of averaging, or (2) responses confined to a small proportion of trial types or confined to a putative phenotype, which may be diluted by averaging. For single trial-like experiments, data obtained at all time points for each experimental condition will be statistically evaluated by correlation with a model impulse function (Boynton et al., 1996; Dale & Buckner, 1997). To eliminate cross-trial hemodynamic overlap, statistical maps will be derived from correlation between the γ function and a difference signal between each experimental condition and the paradigm baseline. For block design experiments, a γ function will be convoluted with the experimental time course, and used in a correlation analysis. For both single trial-like experiments and block design experiments, the outcome of correlation analysis will be assessed for foci of signal change using a cluster-growing algorithm (for example: Bush et al., 1996). Clusters selected for further analysis will be required to either meet a corrected statistical threshold, or have signal intensity changes from baseline>0.05%. For the corrected statistical threshold (in order to maintain an overall α<0.05), the cluster-growing algorithm will localize activations that meet a corrected p value threshold of p<0.00075 (0.05/67) for the number of segmentation and parcellation regions searched. Regions of interest (ROIs) will be delineated by the voxels with p<0.05 in a 7 mm radius of the voxel with the minimum p value (the “max vox”). These ROIs will then be used to sample the % signal intensity change per condition from the experimental baseline.

Identified ROIs will be localized via superposition of the segmentation and parcellation contours produced as described above. The % signal intensity change from baseline for each of the experimental conditions in the task will then be quantitated and organized in a matrix based on the anatomic segmentation and parcellation units vs. hemispheric laterality. If a focus of signal change is observed in an anatomic segmentation/parcellation unit, it will be noted in the matrix for that anatomic region as an itemset of % signal changes from baseline of each experimental condition. Each experiment will have an independent matrix, as will the volumetric, and clinical information.

Aggregated individuals in Talairach space: Analysis of individuals may miss low-level signal changes observed in common across the cohort, hence an analysis on aggregate data will also be utilized. The outcomes of this analysis that are not found by the analysis of individuals on native anatomy (above), will supplement the results found above. Indeed, these results will constitute a second matrix for each experimental paradigm, thus producing a total of twelve matrices with functional data, along with two more from volumetric and clinical data.

Analysis of aggregated individuals will identify foci of signal change across the aggregate, and apply ROIs of these foci to individuals to sample the % signal intensity change per condition from the experimental baseline. It must be noted that such analyses from the aggregate may produce Type I errors in the case of opponent responses to different experimental conditions, which would tend to cancel as a result of averaging, or responses confined to a small proportion of trial types or confined to a putative phenotype, which may be diluted by averaging.

To allow averaging of data across subjects (for Ph1, 250+ subjects and then 500+ subjects; for Ph2, 1600+ subjects, and then 3200+ subjects), each individual's set of functional data and structural data will be transformed into Talairach space (Breiter et al., 1996a, c; Talairach & Tournoux, 1988), and resliced in the coronal orientation with isotropic voxel dimensions (x,y, z=3.125 mm for 3T, and =1.5 mm for 7T). Optimized fit between functional data and structural scans will then be obtained via translation of exterior contours. These Talairach transformed functional and structural scans will then be averaged. The same procedures for ROI identification used with the individual data on native anatomy will then be used to identify a set of activation clusters on the averaged data to then be used as ROIs to sample from each Talairach transformed individual data set the % signal intensity change per condition from the experimental baseline. In the averaged data, only activations will be selected that meet a corrected p value threshold of p<0.00075 (0.05/67) for the number of segmentation and parcellation regions searched. Activation ROIs from the averaged data will be anatomically localized in each individual on the Talairach transformed individual structural data, using superimposed segmentation and parcellation contours that have also been morphed into the Talairach domain. Again, as with the data produced by analysis of individuals, the data produced from ROIs determined on averaged data, will be listed in matrices.

Classification Tree Analysis (Phenotyping)

To partition the neuroimaging data into the fewest number of sets for the quantitative indices measured, that will be predictive of any future data set obtained, an algorithm based on classification tree analysis will be used. These analyses will be performed on the functional and quantitative volumetric data organized in matrices for each individual. In general, these techniques split data sets presented to them into sub-classes, and keep track of how it was done via a decision-tree structure. This decision tree structure can then be used to classify novel data. There are a number of classification techniques, all of which aim to select the class with the highest estimated conditional probability without computing the whole probability distribution. These techniques basically differ in their employment of different biases in their first steps. Regression trees are basically like classification trees, with the difference that they handle continuous data, and given that the functional and structural data will be continuous, they will be utilized. For these algorithms, most of the effort goes into determining the optimal ordering of the variables in the decision tree, as well as the level at which to cease the decision process (i.e., there comes a point when all members of a branch should be in the same classification). These algorithms are also typically “non-parametric” in that no predictive model has to be hypothesized for the fitting.

The software that will be used for this process will be the CART (classification and regression trees) system initially designed by Steinberg and Colla (1995) and distributed by Salford Systems, CA (note: this system is also incorporated into many statistical packages such as S-plus). CART can lead to “over-fitting” of the data, in that it finds too many classes. Overfitting leads to the identification of too many itemsets (e.g., interesting patterns in the data), which can be a serious issue in domains with many multi-valued parameters, where the search space is large. To protect against this outcome, association rules (Srikant & Agrawal, 1995) can be used to test the salience of all the possible correlations between subclasses in the data, and then prune off non-informative decisions. A standard approach for making optimal class predictions using association rules is the “Large Bayes Classifier” of Meretakis and colleagues. In general, these techniques are computation intensive, necessitating the use of a commercial cluster box system or supercomputer. A recursive-partitioning technique (see, e.g., Zhang and Bonney, 2000) can also be used.

During Ph1, the first 60 subjects per diagnostic category scanned on the 3T magnet (total of 250 subjects) will be used as a training set, and the subsequent subjects scanned will be used as a test set to assess the initial classification schema. This process will then be repeated using the full complement of subjects scanned on the 3T as a training set, and the 100 subjects scanned on the 7T as a test set. A greater specification of the identified classes found from the larger training set would indicate that the initial cohort had not produced saturation of the identified endophenotypes. The training set size can be enlarged as the project progresses.

Assessment of Main Effects Between Groups

To evaluate the efficacy of our phenotyping methods, statistical assessment of effects between groups and correlations between functional and structural measures will be performed. These analyses should produce results embedded in the output of the classification tree analysis. Estimates of the central tendency (location) and dispersion (scale) of the data distribution of the diagnostic groups will use conventional least squares statistics or a robust statistics module, e.g., a Tukey bisquare estimator (Hoaglin et al., 1983; Breiter et al., 2001). Robust statistics are less subject than conventional parametric statistics to the influence of outliers and provide more efficient estimates of location and scale of contaminated normal distributions. Although robust methods are more efficient when dealing with contaminated distributions, they are less efficient than parametric statistics when dealing with near-normal distributions.

Main effects between experimental conditions, and experimental conditions in each diagnostic group can be assessed using multiple regression to carry out a random effects analysis of variance (ANOVA). Experimental condition will be defined as a categorical (noncontinuous) variable, thus avoiding any assumptions concerning the form of the time courses. For the data determined on individual native anatomy, the ANOVA results will need to meet a more stringent a level than the conventional 0.05 value by correction for the number of clusters tested in each individual. For the data determined from averaged data, the ANOVA results will need to meet a more stringent α level than the conventional 0.05 value by correction for the number of clusters found on the averaged data. For both data measured from individual native data, and data from Talairach transformed data, in cases that meet the criterion cc level, pair-wise contrasts between specific experimental conditions will then be performed.

As a last analysis, an autocorrelation analysis will be performed among the functional and structural measures within diagnostic groups, and between diagnostic groups, using a Pearson product-moment correlation coefficient. The correction for performing multiple autocorrelations will be 0.05 adjusted by the number of calculations performed.

FMRI Power Analysis

To estimate our statistical power to detect a difference between experimental conditions that would segregate potential endophenotypes for cocaine dependent, nicotine dependent, or mood disordered subjects vs. controls, we first determined the expected effect-size by reanalyzing prior experimental data. We reanalyzed data from a set of experimental stimuli that produced similar signal magnitude changes in reward regions to those produced by the 6 experimental paradigms described above, and that had a similar number of time points to those 6 paradigms in their shortened format planned for this project. We also selected data for these calculations from experiments that involved subjects with cocaine addiction, and subjects who were healthy controls. In one case we reanlyzed a prior cocaine infusion study (Breiter et al., 1997), while in another we reanalyzed a morphine infusion study in healthy controls Breiter et al., 2000). For each subject in the cocaine infusion study, signal from all voxels in the bilateral NAc (defined anatomically on Talairach-transformed images) was normalized, averaged, and linearly detrended. The resulting time series of 136 time points had an average standard deviation, across 20 infusions in 13 subjects, equal to 0.84% of the grand average signal level. The difference in signal between the 38 pre-infusion time points and the 98 post-infusion time points in a fixed volume around the peak voxel with the NAc was 1.50%, corresponding to an effects size of d=1.79 standard deviations. To achieve 90% power to detect a signal difference of this magnitude at p<0.05 (two-tailed) would require N=15 independent comparisons (Cohen, 1988). Effect sizes of cocaine infusion in other subcortical structures ranged from d=0.60 to 2.14. For the morphine infusion study, effect sizes of morphine infusion in drug-naïve subjects ranged from d=0.71 to 1.67. We also note that our preliminary data indicates effects of similar magnitude can be found when comparing cocaine dependent and healthy control subjects with non-infusion paradigms such as the monetary reward paradigm. These calculations suggest that endophenotypes based on quantitative differences in signal change across individuals should be distinguishable, e.g., with 15 subjects per diagnostic group.

Family Based Association Studies:

The recruitment strategy is based upon the identification of families as the unit of analysis. Thus we also propose family based association studies for the candidate gene association studies that will be performed. We have performed several family based association studies (see for example Wilk et al. 2001; DeStefano et al. 2002).

Family based association tests (FBATs) evaluating association between markers and the various phenotypes will be conducted using the program FBAT (Laird et al. 2000). These tests are described in detail elsewhere (Rabinowitz and Laird 2000; Horvath et al. 2001). A general form of a family based association test statistic for family i (with nᵢ offspring) is

$${S}_{i} = {\sum }_{j = 1}^{{n}_{i}} {X}_{ij} {T}_{ij}$$

where Xᵢⱼ is a function of the genotype data of offspring j in family i and Tᵢⱼ is a function of the phenotype data of that offspring. For a biallelic marker a score statistic based on Sᵢ can be defined as

$$Z = {\sum }_{i = 1}^{N} [ {S}_{i} - E ( {S}_{i} ) ] / √ V ( {S}_{i} )$$

where E(Sᵢ) and V(Sᵢ) are the mean and variance of Sᵢ under the null hypothesis of no linkage and N is the total number of families. If the coding of Xᵢⱼ specifies an additive model (i.e. Xᵢⱼ=the number of alleles of interest (0, 1 or 2) carried by offspring j in family i) and Tᵢⱼ is specified as 0 for unaffected and 1 for affected, then this statistic is equivalent to the TDT for genotyped parent-offspring trios (Lunetta et al, 2000).

When parental genotypes are available, E(Sᵢ) can be computed by conditioning on the observed traits and parental marker genotypes, and is based on Mendelian transmission probabilities (see Horvath et al. 2001 for details). This further justifies the collection of parental genotype information. Rabinowitz and Laird (2000) invoke the statistical method of conditioning on sufficient statistics for the null hypothesis to construct a test of association when parental genotypes are not available. In this case the offspring genotype distribution is defined by conditioning on the observed traits, the partially observed parental genotypes and on the offspring configuration. Tables presenting the conditional probabilities when partial or no parental genotype information is available are given in the FBAT technical report portion of the FBAT documentation. At least two distinct offspring genotypes must be observed for a family to contribute to the FBAT statistic when parental genotypes are not available. The statistical theory of conditioning on the sufficient statistics results in correct p-values (type I error rate) regardless of the population admixture, patterns of missing genotypes or genetic model (Rabinowitz and Laird 2000).

Both multiallelic and biallelic association tests can be used. For the biallelic tests an additive genetic model will be assumed with Xᵢⱼ coded as described above. Coding of Xᵢⱼ for multiallelic tests are described elsewhere (Horvath et al. 2001). The unknown underlying genetic model may determine which test, biallelic or multiallelic, is more powerful, hence both will be considered here. Two definitions of the trait will be employed. In the first definition Tᵢⱼ=the quantitative trait for offspring j in family i. In the second definition Tᵢⱼ=(quantitative trait−μ), where μ=a constant that is chosen to minimize the variance of the test statistic (Horvath et al. 2001). For these trait definitions, a positive Z statistic indicates that the allele is associated with a larger value.

Sib Pair Estimates:

In the linkage power analysis, 900 sibling pairs are mentioned, but the analysis is for a quantitative trait, so it uses the continuous measure for fMRI as the trait to which we are ling. Other than the proband, sibs are not defined as “affected” or unaffected, merely by their fMRI measure(s).

An exemplary 900 sib-pair is estimated based upon the following numbers:

Cocaine families: 213 families, 5 members in each family:
half (n = 107) consisting of 1 parent and 4 offspring (107 probands, 321
siblings),
half (n = 106) consisting of two parents 3 offspring (106 probands, 318
siblings):
(total number of siblings = 639).
Number of sibling pairs:
107 × 6 = 642 sib pairs
106 × 3 = 318 sib pairs
960 sibling pairs total.
Nicotine families: 152 families, 7 members:
half (n = 76) consisting of 1 parent and 4 children, 2 avuncular or cousin.
half (n = 76) consisting of 2 parents, 3 children, 2 avuncular or cousin.
456 sib pairs
228 sib pairs = 684 pairs
For the purposes of power estimates we will add one additional sibling
pair (e.g. one cousin pair) for each of the 152 families:
152 additional pairs
836 sibling pairs total.
Familial Depression families: 107 families, 10 members:
half (n = 54) consisting of 1 parent and 4 children, 5 avuncular & cousin.
half (n = 53) consisting of 2 parents, 3 children, 5 avuncular & cousin.
456 sib pairs
228 sib pairs = 684
For the purposes of power estimates we will add two additional sibling
pairs (e.g. two cousin pairs, perhaps from two different sibships) for
each of the 107 families:
214 additional pairs
898 sibling pairs total.

### EXAMPLE (PART 3)

### Detailed Description of an Exemplary Database

The text that follows summarizes a number of salient features of the Brain Imaging, Genetics, and Behavioral Assessments Database (BIGBAD) including Database Design, Database Architecture, Data Entry Procedures, Data Transfer Procedures, Data Confidentiality, Accessibility and Security, Quality Control, and Database Personnel.

(a) Database Design

The Brain Imaging, Genetics, and Behavioral Assessments Database has been designed to meet the following objectives: (1) Receive and store all data (behavioral, MRI and molecular genetic) acquired during the project; (2) Provide an easy to use, intuitive interface which reflects the work- and dataflow defined by the project protocol; (3) Provide data entry interfaces for behavioral data entry which, to the extent possible, mimic the ‘actual’ test forms; (4) Perform immediate, automatic quality control where possible (validity of data entry, e.g., type, range; redundancy checks); (5) Provide facilities for ‘manual’ quality control at various stages; (6) Automate data transfer (behavioral measures, MRI and molecular genetic) as much as possible; (7) Simplify communication between the four working cores of the phenotype-genotype project; (8) Serve raw and processed data to the outside world, under to-be-defined access control.

Note that for simplicity, in this section all non-MRI and non-genetic data (i.e., clinical, neurological, cognitive, . . . ) is referred to as “behavioral.” The overarching goal of data coordination is to collect all MRI, genetics, and behavioral data acquired for the targeted study. In the case of MRI scanning and molecular genetic studies, collecting data is a relatively straightforward process; in contrast, the behavioral data is significantly more complex, both conceptually and practically. In general, BIGBAD has been designed from the assumption that, whenever possible, ALL behavioral data (raw data and summary scores) will be stored.

BIGBAD has been designed in a modular fashion, making it highly flexible and expandable. As such, each behavioral test is implemented as a separate database module, developed in coordination with the PI in the Clinical Phenotyping Working Core responsible for that instrument. Many tests also required development of complex scoring algorithms, which were either defined or developed by the responsible PI. The result of this common effort will be automatic real-time scoring of the majority of instruments at the time of data entry. Diagram 1 lists the instruments included in the behavioral test battery

Diagram 1: Behavioral instruments included
in the Phenotype-Genotype test battery
Commercial and/or electronic tests

SCID -I/P
IDS
Fagerstrom Nicotine Tolerance Questionaire
SSACA
SSAGA-II
Other tests
Full medical History, ROS and Exam
Full neurological History, ROS, and Exam
Handedness
Pregnancy Test
HIV and HepC
LFTs, CBC, SMA-20,
Hair toxicology
Urine Toxicology
WAIS-R
Saliva Continine
End-expiratory CO

(b) Database Architecture

The primary rationale for using an established database such as BIGBAD is to provide ease of communication between the working cores, ease of data-entry, and continuity in workflow and dataflow by closely mirroring the Project's logic and workflow (see the diagram for information flow in Appendix 5 that organizes the activities performed by each working core).

The components of the system in terms of data acquisition and processing can include: (i) the clinical phenotyping working core and their offline (i.e., paper and pencil), online (i.e., computer-based), and chemistry-based measures; (ii) the MRI scanner used by the neuroimaging working core and its data-analysis platforms; (iii) the quantitative anatomy working core and its data-analysis platforms; (iv) the neurogenetics working core; (v) the PC's or Linux-based workstations at each working core, that upload data to the central database; (vi) the database hardware and software installed and configured at the central database, allowing data entry and access through predefined access mechanisms; (vii) the central supercomputer and disk storage; and (viii) the data backup system (i.e., tape-farm) for the central database.

The database can handle data acquisition from multiple working cores, provide full subject confidentiality, and manage repetitive testing/scanning of subjects throughout the course of the study.

The database architecture can have a three-tier structure:
Database Layer—a relational database (server side)
Application Logic Layer—application logic controlling user access and query execution
Front-end Layer—web-based graphical user interface (GUI) (for investigators in each working core)
   The structural three-tier organization enables applications to be distributed over many physical locations and computing platforms. Investigators access the database via front-end interfaces (e.g., GUIs) developed to best suit their computing environments. These interfaces can be implemented using virtually any programming language and even other databases' GUIs (for example, Microsoft Access can be used as a front-end to a MySQL database). At the same time, investigators can seamlessly connect to multiple databases using one GUI.

(1) Database Software Platform

The database is developed using MySQL, an Open Source Database Management System (see http://www.mysql.com). MySQL is a database management system that incorporates a relational model for its databases, and supports ANSI SQL (standard querying language). It is very flexible and supports compatibility with other database management systems. MySQL also supports ODBC (Open DataBase Connectivity, an industry standard application programming interface (API) for transparent database access) and JDBC (a Java API for executing SQL statements), hence making it possible to use MySQL as a back-end database to many different applications (e.g., MRI data processing pipeline, Microsoft Excel, Matlab, . . . ). MySQL's client/server architecture allows the development of various front-end interfaces with seamless connectivity to the Database servers.

The MySQL architecture corresponds well to the requirements of the Phenotype-Genotype Study. The server (The MySQL daemon process mysqld) connects investigators by creating a new server process for each investigator. Investigators access the MySQL database exclusively through the-mysqld process. Thus the MySQL database server (program) focuses only on data handling, while the mysqld processes take care of the investigator's connectivity and control his/her access privileges.

The Graphical User Interface (GUI) to the database was developed to ensure data and structure flexibility, cross-platform independence, and transparent and full Internet support. It has been implemented as a web-based GUI, written primarily in PHP4 (http://www.php.net). PHP is a powerful and versatile server-side scripting language, featuring an extensive programming interface to MySQL. For certain operations and data manipulation tasks, PHP is complemented by software developed in Perl, JavaScript, or Java.

For secure and automatic data transfer from any PC/workstation in the working cores to the central database, a combination of Unison (http://www.cis.upenn.edu/˜bcpierce/unison/) and Secure Shell (SSH, http://www.ssh.com) is used. Unison is a file synchronizer, which efficiently synchronizes the data present on the laptop with a central data repository. This process is run through SSH to ensure secure, encrypted data transfer.

(2) Database Layer

The core of the management system for the database is a relational database with thousands of fields storing neurological, psychological (behavioral), and medical data (including genetics data), raw and derived scores, MRI scans and analyzed images, and MRI header information.

The core of the database structure is the candidate profile, built around a study subject as a basic “data unit.” A study subject is registered by an investigator at the clinical phenotyping working core. Some study subjects will undergo multiple visits to a particular working core (such as for test and retest scanning). During such a visit, a distinct battery of behavioral instruments and MRI procedures will be administered, both of which are age and study objective dependent.

(3) Application Logic Layer

The middle tier consists of MySQL-based user management functions (using a special “mysql” database to manage user accounts). This enables the mysql daemon processes to verify user accounts at connection time and keep track of their access privileges during their work with the database. This way, the (work) load to verify users is removed from both Database and front-end applications.

At the same time, PHP (server-side), Perl, and Java scripts dynamically develop SQL to query the Database, receive and process resulting data sets and present them to the front-end applications. Since the database front-end delivers completely dynamic web-content that is displayed on the investigators browsers, it's this application layer's job to define and deliver variable and rules for displaying the content.

(4) Front-End Layer

The front-end (GUI) layer was designed to mirror the project workflow, its forms to resemble original layouts of the paper test forms, thereby making data entry highly intuitive. The main Menus of the GUI represent the actual candidate screening and data acquisition stages of the study: 1. Candidate Recruitment Stage/Menu (e.g., initial recruitment of the candidate to the project); 2. Candidate Screening Stage/Menu (e.g., further pre-visit screening of the candidate); 3. Candidate Visit Stage/Menu (e.g., candidate visit for clinical phenotyping); 4. Approval Stage/Menu (e.g., post-visit period for evaluation of collected data and administered neuro-psychological instruments).

Other Menus bring User Management, Data Management, and Candidate Profile Management features: 1. Central Database Area (e.g., data management features, offers real-time monitoring of the data acquisition process at all sites, user-defined querying and displaying of various database statistics); 2. Candidate Information (e.g., candidate profile management features); 3. User Information (e.g., user personal and contact information); 4. Administration (e.g. various administrative tasks, from registering new users to changing access privileges for users or groups).

The MRI and behavioral battery of instruments will be clearly displayed in the candidate profile menu. Data entry and evaluation status of all instruments will offer easy review of the status of work with each candidate enrolled in the project.

(c) Data Entry Protocols and Procedures

The data entry aspect of the database has been designed along two principles: make data entry easy, and make it accurate. To make data entry easy, the online forms have been designed to resemble as much as possible the paper forms that researchers are used to working with. The same headers, titles and layouts as the paper tests will be provided online in many cases, and where they are not, clear instructions will be written to smooth any transitional problems. Data entry in this environment is extremely fast, and typically takes only a few minutes for even the longest measures. Many shorter measures take only moments to enter data, and feedback (including scores) is immediate.

To make data entry accurate, the online forms provide several basic levels of quality control. They limit the entry options of nearly every field, making unreasonable values impossible to enter. They provide immediate feedback to the data entered, and allow investigators to easily check any and all of their entries. Finally, trained personnel will explicitly verify a randomly selected subset of the data entered against paper originals.

Data entry on the commercial software integrated into the project is a more complex issue. Each commercial software package has its own protocols for data entry, but when exported information arrives at the central database, it is run through a standardized battery of checks. Primarily, these checks involve verification of the candidate identity (does this file belong to the correct subject), and of basic information content (does this file contain the information that it should). After these checks have been done, the data is subject to the same quality control as the data arriving via the online interface.

Note that given Ph1 and Ph2 are primarily focussed on research at one center, the data entry system will feature double entry of data, a standard procedure for maintaining data quality. For Ph1 and Ph2, this database will perform double scoring of the behavioral instruments, thus providing quality control by comparing the summary scores only. For Ph3, this feature may be developed to the point that it can be utilized across multiple centers.

(d) Data Transfer Protocols and Procedures

The proposed data transfer mechanism for the phenotype-genotype project calls for a study workstation for each investigator-in the four working cores to function as an extension of the central database, effectively constituting a data gateway between them. In this scenario, all acquired study data, be it clinical/behavioral, MRI, or neurogenetic measures flows from acquisition through the workstation to the central database.

Although data transfer is technically possible using currently available mechanisms, it should be noted that for MRI data this procedure can be cumbersome and require additional human resources. Specifically at the central database, the verification, QC, and format conversion of MRI data requires significant manual intervention.

For data transfer purposes, this study has three primary categories of data: (1) clinical/behavioral data from paper-and-pencil tests and computerized tests (e.g., SCID-I/P); (2) structural and functional MRI data; and (3) molecular genetics data.

These data types can be acquired in different ways, and may require slightly different treatment for storage, archiving, backup, database entry and transfer. In the following, the procedures around the clinical/behavioral and MRI data are described, given these are the most complex, or the largest data sets, respectively, in the project.

The data transfer mechanism has all data acquired or analyzed at the working cores travel via a laptop/workstation (or from the MRI scanner to a workstation in the neuroimaging working core for offline reconstruction of images) to the central database. For two of the data categories, these procedures are summarized as follows:

Clinical/behaviral tests: (a) one set of tests is administered to the subjects using standard, paper-and-pencil test forms. The data contained on these forms are to be entered into the Database using a data entry interface provided by central database, which can be accessed over the Internet. Note that data entry will not be limited to a single laptop/workstation; other computers at the working core, will be usable for data entry. (b) Another set of tests are computerized and administered using a laptop with a battery of computerized tests. The data generated by these instruments are initially stored in the internal representation of each individual software package. Following test administration, the test results are manually ‘exported’ to a format usable for transfer to the Database. Each laptop/workstation will be configured with an upload mechanism that automatically transfers the exported data to the Database.

Structural and functional MRI data: scans are acquired at the MRI console, and from there ‘pushed’ to the Workstation using DICOM transfer. From the Workstation, they are subsequently sent to central database using a similar, encrypted DICOM transfer mechanism.

(e) Data Confidentiality, Security, and Accessibility

The database is designed with a number of features that control access to the database and ensure subject confidentiality.

(f) Quality Control for Data Integrity

Four different levels or stages of quality assurance and quality control have been designed into the dataflow:

(1) At the working core, during and after the data entry. The behavioral data are checked automatically for validity, type, and range as the data are entered in the on-screen test forms. The MRI scans are visually checked at the MR console.

(2) At the working core, before the data is transferred to central database. For behavioral data, this includes an explicit data entry/completeness check. The tests are displayed in the order of administration, making it easier to monitor the data entry process. Once the user enters all the data for a certain instrument, he/she has to mark that the data entry is completed. This informs other users that the test's data entry is completed and disables anyone else but that user from editing the entered data (with the exception of the working core PI, who has the authority to access and modify all data of his/her working core). For MRI data, this QC stage consists of a qualitative evaluation of the data during pre-processing and before statistical evaluation, using visualization software that allows multiple simultaneous cross-sectional views.

Once a test's data entry or MRI acquisition has been completed and checked as such, the authorized user may evaluate the instrument and mark it as “Completed PASS” or “Completed FAILURE”. If the instrument was not administered for some reason, it may be also checked as “Not Administered.” Simultaneously, a record (related to the QC level) is updated, while an entry (comment) is inserted into the comment history table of the Database. Each time this is done, the QC flag table gets updated, keeping the latest entry, while the table comment history keeps the chronological listing of all comments. This provides a complete audit trail, recording exactly what was done with the data throughout the course of the study.

(3) At the central database, upon receipt of the data at it. This stage verifies the integrity and completeness of the received data and MRI scans, i.e. if the received files were correctly transmitted, whether the data is complete, and whether the correct acquisition parameters were used.

(4) At the central database, following data receipt and integrity check. This level of Quality Control is the most comprehensive, in-depth verification of all received information for a study subject. The validation at this QC level initiates the candidate's “promotion” into a status of a full subject, when a study wide, unique Subject ID is assigned to it. For behavioral data, this involves a complete verification of all data against source documents (paper forms) on a random subset of candidates, and rapid data consistency checks of all data. For MRI data, this involves the qualitative and quantitative assessment of image quality

(g) Central Database Organizational Structure

The central database is organized into multiple separate domains of activity for each of the types of data to be incorporated in it (thus approximating the structure for the four working cores).

### REFERENCES

Abecasis G R, Cherny S S, Cookson W O, Cardon L R. (2002) Merlin-rapid analysis of dense genetic maps using sparse gene flow trees. Nat Genet. 30:97-101.
Abecasis G R, Cookson W O, Cardon L R. (2001) The power to detect linkage disequilibrium with quantitative traits in selected samples. Am J Hum Genet. 68:1463-74.
Agrawal, R. Imielinski, T. Swami, A. (1993) Database Mining: A Performance Perspective, IEEE Transactions on Knowledge and Data Engineering, 5: 914-925.
Agrawal, R. Mannila, H. Srikant, R. Toivonen, H. and Verkamo, A. I. (1995) “Fast Discovery of Association Rules”, Advances in Knowledge Discovery and Data Mining, Chapter 12, AAAI/MIT Press, Cambridge, Mass.
Agrawal, R. and Srikant, R. (1998) Fast Algorithms for Mining Association Rules”, Readings in Database Systems, Chapter 7, Morgan Kaufmann Publishers.
Aharon I, Etcoff N, Ariely D, Chabris C F, O'Connor E, Breiter H C. (2001) Beautiful faces have variable reward value: fMRI and behavioral evidence. Neuron. 32:537-51.
Almasy L., and Blangero, J. (2001) Endophenotypes as quantitative risk factors for psychiatric disease: rationale and study design. Am J Med Genet. 105:42-4.
Almasy L, Porjesz B, Blangero J, Chorlian D B, O'Connor S J, Kuperman S, Rohrbaugh J, Bauer L O, Reich T, Polich J, Begleiter H. (1999) Heritability of event-related brain potentials in families with a history of alcoholism. Am J Med Genet. 88:383-90.
Almasy L, Porjesz B, Blangero J, Goate A, Edenberg H J, Chorlian D B, Kuperman S, O'Connor S J, Rohrbaugh J, Bauer L O, Foroud T, Rice J P, Reich T, Begleiter H. (2001) Genetics of event-related brain potentials in response to a semantic priming paradigm in families with a history of alcoholism. Am J Hum Genet. 68:128-135.
Andretic R, Chaney S, Hirsh J. (1999) Requirement of circadian genes for cocaine sensitization in Drosophila Science. 285:1066-8.
Baumgartner, W. A. and Hill, V. A., 1996. Hair analysis for organic analytes: Methodology, reliability issues and field studies. In: Kintz, P., Editor, 1996. Drug Testing in Hair, CRC Press, Boca Raton, Fla., pp. 223-265.
Barrot M, Olivier J D, Perrotti L I, DiLeone R J, Berton O, Eisch A J, Impey S, Storm D R, Neve R L, Yin J C, Zachariou V, Nestler E J. (2002) CREB activity in the nucleus accumbens shell controls gating of behavioral responses to emotional stimuli. Proc Natl Acad Sci USA. 99:11435-40.
Becerra L, Breiter H C, Wise R, Gonzalez R G, Borsook D. (2001) Reward circuitry activation by noxious thermal stimuli. Neuron. 32:927-46.
Bechara A, Tranel D, Damasio H, Damasio A R. (1996) Failure to respond autonomically to anticipated future outcomes following damage to prefrontal cortex. Cereb Cortex. 6:215-25.
Berrettini W H. (2000) Are schizophrenic and bipolar disorders related? A review of family and molecular studies. Biol Psychiatry. 48(6):531-8.
Bierut L J, Rice J P, Edenberg H J, Goate A, Foroud T, Cloninger C R, Begleiter H, Conneally P M, Crowe R R, Hesselbrock V, Li T K, Nurnberger J I Jr, Porjesz B, Schuckit M A, Reich T. (2000) Family-based study of the association of the dopamine D2 receptor gene (DRD2) with habitual smoking. Am J Med Genet. 90:299-302.
Bradley, P. S. Gehrke, J. Ramakrishnan, R. and Srikant R. (2002) Scaling Mining Algorithms to Large Databases, Communications of the ACM, 45(8), August
Breiter H C, Aharon I, Kahneman D, Dale A, Shizgal P. (2001) Functional imaging of neural responses to expectancy and experience of monetary gains and losses. Neuron. 30:619-39.
Breiter H C, Rosen B R. (1999) Functional magnetic resonance imaging of brain reward circuitry in the human. Ann N Y Acad Sci. 877:523-47.
Breiter H C, Gollub R L, Weisskoff R M, Kennedy D N, Makris N, Berke J D, Goodman J M, Kantor H L, Gastfriend D R, Riorden J P, Mathew R T, Rosen B R, Hyman S E. (1997) Acute effects of cocaine on human brain activity and emotion. Neuron. 19:591-611.
Breiter H C, Etcoff N L, Whalen P J, Kennedy W A, Rauch S L, Buckner R L, Strauss M M, Hyman S E, Rosen B R. (1996) Response and habituation of the human amygdala during visual processing of facial expression. Neuron. 17:875-87.
Carpenter P A, Just M A, Reichle E D. (2000) Working memory and executive function: evidence from neuroimaging. Curr Opin Neurobiol. 10:195-9.
Castellanos F X, Tannock R.(2002) Neuroscience of attention-deficit/hyperactivity disorder: the search for endophenotypes. Nat Rev Neurosci. 3:617-28.
Cohen M S, Kosslyn S M, Breiter H C, DiGirolamo G J, Thompson W L, Anderson A K, Brookheimer S Y, Rosen B R, Belliveau J W. Changes in cortical activity during mental rotation. A mapping study using functional MRI.
Coon H, Myers R H, Borecki I B, Arnett D K, Hunt S C, Province M A, Djousse L, Leppert M F. (2000) Replication of linkage of familial combined hyperlipidemia to chromosome 1q with additional heterogeneous effect of apolipoprotein A-I/C-III/A-IV locus. The NHLBI Family Heart Study. Arterioscler Thromb Vasc Biol. 20:2275-80.
Crabbe J C. (2002) Genetic contributions to addiction. Annu Rev Psychol. 53:435-62.
Crabbe J C, Wahlsten D, Dudek B C. (1999) Genetics of mouse behavior: interactions with laboratory environment. Science 284:1670-2.
Crow T J. (1999) Twin studies of psychosis and the genetics of cerebral asymmetry. Br J Psychiatry. 5:399-401.
Dierker L C, Avenevoli S, Stolar M, Merikangas K R. (2002) Smoking and depression: an examination of mechanisms of comorbidity. Am J Psychiatry. 159:947-53.
DeStefano A L, Cupples L A, Maciel P, Gaspar C, Radvany J, Dawson D M, Sudarsky L, Corwin L, Coutinho P, MacLeod P, et al. (1996) A familial factor independent of CAG repeat length influences age at onset of Machado-Joseph disease. Am J Hum Genet. 59:119-27.
DeStefano A L, Lew M F, Golbe L I, Mark M H, Lazzarini A M, Guttman M, Montgomery E, Waters C H, Singer C, Watts R L, Currie L J, Wooten G F, Maher N E, Wilk J B, Sullivan K M, Slater K M, Saint-Hilaire M H, Feldman R G, Suchowersky O, Lafontaine A L, Labelle N, Growdon J H, Vieregge P, Pramstaller P P, Klein C, Hubble J P, Reider C R, Stacy M, MacDonald M E, Gusella J F, Myers R H. (2002) PARK3 influences age at onset in Parkinson disease: a genome scan in the GenePD study. Am J Hum Genet. 70:1089-95.
Egan M F, Goldberg T E, Kolachana B S, Callicott J H, Mazzanti C M, Straub R E, Goldman D, Weinberger D R. (2001) Effect of COMT Val108/158 Met genotype on frontal lobe function and risk for schizophrenia Proc Natl Acad Sci USA. 98:6917-22.
Eisen S A, Slutske W S, Lyons M J, Las sman J, xian H, Toomey R, Chantarujikapong S, Tsuang M T (2001) The Genetics of Pathological Gambling. Sem Clin Neuropsychiatry 6:195-204
Elliott R, Friston K J, Dolan R J. (2000). Dissociable neural responses in human reward systems. J. Neurosci. 20:6159-65.
Enard W, Khaitovich P, Klose J, Zollner S, Heissig F, Giavalisco P, Nieselt-Struwe K, Muchmore E, Varki A, Ravid R, Doxiadis G M, Bontrop R E, Paabo S. (2002) Intra- and interspecific variation in primate gene expression patterns. Science 296:340-3.
Fischl B, Dale A M. (2000) Measuring the thickness of the human cerebral cortex from magnetic resonance images. Proc Natl Acad Sci USA. 97:11050-5.
Fischl B, Sereno M I, Dale A M. (1999) Cortical surface-based analysis. II: Inflation, flattening, and a surface-based coordinate system. Neuroimage. 9:195-207.
Fischl B, Salat D H, Busa E, Albert M, Dieterich M, Haselgrove C, van der Kouwe A, Killiany R, Kennedy D, Klaveness S, Montillo A, Makris N, Rosen B, Dale A M. (2002) Whole brain segmentation: automated labeling of neuroanatomical structures in the human brain. Neuron. 33:341-55.
Ferraro T N, Berrettini W H. (1996) Quantitative trait loci mapping in mouse models of complex behavior. Cold Spring Harb Symp Quant Biol.; 61:771-81.
Flint J, Mott R. (2001) Finding the molecular basis of quantitative traits: successes and pitfalls. Nat Rev Genet. 2:437-45.
Franlin T R, Acton P D, Maldjian J A, Gray J D, Croft J R, Dackis C A, O'Brien C P, Childress A R. (2002) Decreased gray matter concentration in the insular, orbitofrontal, cingulate, and temporal cortices of cocaine patients. Biol. Psychiatry 15:134-42.
Fukuda, T., Morimoto, Y., Morishita, S., and Tokuyama, T. (2001) Data Mining with optimized two-dimensional association rules. ACM Transactions on Database Systems 26: 179-213.
Gainetdinov R R, Caron M G. (2002) Monoamine Transporters: From Genes to Behavior. Annu Rev Pharmacol Toxicol.
Gawin F H, Ellinwood E H Jr. (1988) Cocaine and other stimulants. Actions, abuse, and treatment. N Engl J Med. 318:1173-82.
Gear R W, Aley K O, Levine J D. (1999) Pain-induced analgesia mediated by mesolimbic reward circuits. J Neurosci. 19:7175-81.
Gershon E S (1990) Genetics. In: Goodwin F K, Jarison K R (eds) Manic-depressive illness, Oxford University Press, Oxford, pp 373-401.
Gottlieb D J, Wilk J B, Harmon M, Evans J C, Joost O, Levy D, O'Connor G T, Myers RH. (2001) Heritability of longitudinal change in lung function. The Framingham study. Am J Respir Crit Care Med. 164:1655-9.
Gottesman I I, Shields J (1982) Schizophrenia: the epigenetic puzzle. Cambridge University Press, New York.
Gullion C M, Rush A J. (1998) Toward a generalizable model of symptoms in major depressive disorder. Biol Psychiatry. 44:959-72.
Hariri A R, Mattay V S, Tessitore A, Kolachana B, Fera F, Goldman D, Egan M F, Weinberger D R. (2002) Serotonin transporter genetic variation and the response of the human amygdala. Science. 297:400-3.
Horvath S, Xu X, Laird N M. (2001) The family based association test method: strategies for studying general genotype-phenotype associations. Eur J Hum Genet. 9:301-6.
Huber K M, Gallagher S M, Warren S T, Bear M F. (2002) Altered synaptic plasticity in a mouse model of fragile X mental retardation. Proc Natl Acad Sci USA. 99:7746-50.
Johanson C E, Fischman M W. (1989) The pharmacology of cocaine related to its abuse. Pharmacol Rev. 41:3-52.
Jorgenson E, Hinds D, Risch N. (1999) Sib-pair analysis of the collaborative study on the genetics of alcoholism data set. Genet Epidemiol. 17 Suppl 1:S187-91.
Josselyn S A, Shi C, Carlezon W A Jr, Neve R L, Nestler E J, Davis M. (2001) Long-term memory is facilitated by cAMP response element-binding proteinoverexpression in the amygdala. J Neurosci. April 1;21(7):2404-12.
Kelsoe J R, Spence M A, Loetscher E, Foguet M, Sadovnick A D, Remick R A, Flodman P, Khristich J, Mroczkowski-Parker Z, Brown J L, Masser D, Ungerleider S, Rapaport M H, Wishart W L, Luebbert H (2001) A genome survey indicates a possible susceptibility locus for bipolar disorder on chromosome 22. Proc Natl Acad Sci USA 98:585-590
Kendler K S, Diehl S R (1993) The genetics of schizophrenia: a current genetic-epidemiologic perspective. Schizophr Bull 19:261-285.
Kendler K S, Prescott C A. (1998) Cocaine use, abuse and dependence in a population-based sample of female twins. Br J Psychiatry. 173:345-50.
Kendler K S, Karkowski L M, Neale M C, Prescott C A. (2000) Illicit psychoactive substance use, heavy use, abuse, and dependence in a US population-based sample of male twins. Arch Gen Psychiatry. 57:261-9.
Kendler K S, Neale M C, Sullivan P, Corey L A, Gardner C O, Prescott C A. (1999) A population-based twin study in women of smoking initiation and nicotine dependence. Psychol Med. 29:299-308.
Kendler K S, Karkowski L M, Neale M C, Prescott C A. (2000) Illicit psychoactive substance use, heavy use, abuse, and dependence in a US population-based sample of male twins. Arch Gen Psychiatry. 57:261-9.
Kendler K S, Neale M C, Thornton L M, Aggen S H, Gilman S E, Kessler R C. (2002) Cannabis use in the last year in a US national sample of twin and sibling pairs. Psychol Med. 32:551-4.
Knutson B, Adams C M, Fong G W, Hommer D. (2001) Anticipation of increasing monetary reward selectively recruits nucleus accumbens. J Neurosci. 21:RC159
Koob G F. (1992) Neural mechanisms of drug reinforcement. Ann N Y Acad Sci. 654:171-91.
Koob G F, Sanna P P, Bloom F E. (1998) Neuroscience of addiction. Neuron. 21:467-76.
Kornetsky C, Esposito R U. (1981) Reward and detection thresholds for brain stimulation: dissociative effects of cocaine. Brain Res. 209:496-500.
Kruglyak L, Daly M J, Reeve-Daly M P, Lander E S. (1996) Parametric and nonparametric linkage analysis: a unified multipoint approach. Am J Hum Genet. 58:1347-63.
Kwok, P. Y. (2001) Methods for Genotyping Single Nucleotide Polymorphisms. Annu. Rev. Genom. Human. Genet. 2001, Vol. 2: 235-258.
Lange C, Laird N M. (2002) On a general class of conditional tests for family-based association studies in genetics: the asymptotic distribution, the conditional power, and optinality considerations. Genet Epidemiol. 23:165-80.
Lange C, Laird N M. (2002) Power calculations for a general class of family-based association tests: dichotomous traits. Am J Hum Genet. 71:575-84.
Lawler, A. (2002) White House Stirs Interest in Brain Imaging Initiative. Science, 297:748-9.
Lawrence N S, Ross T J, Stein E A. (2002) Cognitive mechanisms of nicotine on visual attention. Neuron. 36:539-48.
Li H, Chaney S, Roberts U, Forte M, Hirsh J. (2000) Ectopic G-protein expression in dopamine and serotonin neurons blocks cocaine sensitization in Drosophila melanogaster. Curr Biol. Feb 24;10(4):211-4.
Logothetis N K. (2002) The neural basis of the blood-oxygen-level-dependent functional magnetic resonance imaging signal. Philos Trans R Soc Lond B Biol Sci. 357:1003-37.
Lunetta K L, Faraone S V, Biederman J, Laird N M. (2000) Family-based tests of association and linkage that use unaffected sibs, covariates, and interactions. Am J Hum Genet. 66:605-14.
McGinnis R E, Fox H, Yates P, Cameron L A, Barnes M R, Gray I C, Spurr N K, Hurko O, St Clair D. (2000) Failure to confirm NOTCH4 association with schizophrenia in a large population-based sample in Scotland. Nature Genet. 28:128-129.
McGue M, Elkins I, Iacono W G. (2000) Genetic and environmental influences on adolescent substance use and abuse. Am J Med Genet. 96(5):671-7.
MacKinnon D F, Jamison K R, DePaulo J R. (1997) Genetics of manic depressive illness. Annu Rev Neurosci. 20:355-73.
Mackay T F. (2001) The genetic architecture of quantitative traits. Annu Rev Genet. 35:303-39.
Makris N, Meyer J W, Bates J F, Yeterian, E H, Kennedy D N, Caviness V S. MRI-based topographic parcellation of human cerebral white matter and nuclei. H. Rationale and applications with systematics of cerebral connectivity. Neurolmage 1999;9:18-45.
Manji H K, Drevets W C, Charney D S. (2001) The cellular neurobiology of depression. Nat Med. 7:541-7.
Merikangas K, Chakravarti A, Moldin S, Araj H, Blangero J, Burmeister M, Crabbe J, Depaulo J, Foulks E, Freimer N, Koretz D, Lichtenstein W, Mignot E, Reiss A, Risch N, S Takahashi J. (2002) Future of genetics of mood disorders research. Biol Psychiatry. 52:457.
Meyer J W, Makris N, Bates J F, Caviness V S, Kennedy D N. MRI-based topographic parcellation of human cerebral white matter. I. Technical foundations. Neurolmage 1999;9:1-17.
Murray C J L, Lopez A D. (1996). The global burden of disease. Cambridge Mass., Harvard Univ. Press.
Myers R H, Schaefer E J, Wilson P W, D'Agostino R, Ordovas J M, Espino A, Au R, White R F, Knoefel J E, Cobb J L, McNulty K A, Beiser A, Wolf P A. (1996) Apolipoprotein E epsilon4 association with dementia in a population-based study: The Framingham study. Neurology. 46:673-7.
Narr K L, Cannon T D, Woods R P, Thompson P M, Kim S, Asunction D, van Erp T G, Poutanen V P, Huttunen M, Lonnqvist J, Standerksjold-Nordenstam C G, Kaprio J, Mazziotta J C, Toga A W. (2002) Genetic contributions to altered callosal morphology in schizophrenia. J Neurosci 22:3720-9
Nestler E J. (2001) Molecular basis of long-term plasticity underlying addiction. Nat Rev Neurosci. 2:119-28.
Nestler E J, Barrot M, DiLeone R J, Eisch A J, Gold S J, Monteggia L M. (2002) Neurobiology of depression.Neuron. 34:13-25.
Nestler E J, Barrot M, Self D W. (2001) DeltaFosB: a sustained molecular switch for addiction. Proc Natl Acad Sci USA. 98:11042-6.
O'Donnell W T, Warren S T. A decade of molecular studies of fragile x syndrome. Annu Rev Neurosci. 2002;25:315-38.
Ogura Y, Bonen D K, Inohara N, Nicolae D L, Chen F F, Ramos R, Britton H, Moran T, Karaliuskas R, Duerr R H, Achkar J P, Brant S R, Bayless T M, Kirschner B S, Hanauer S B, Nunez G, Cho J H. (2001) A frameshift mutation in NOD2 associated with susceptibility to Crohn's disease. Nature. 411:603-6.
Ongur D, Drevets W C, Price J L. (1998) Glial reduction in the subgenual prefrontal cortex in mood disorders. Proc Natl Acad Sci USA. 95:13290-5.
Peltonen L, Palotie A, Lange K. (2000) Use of population isolates for mapping complex traits. Nat Rev Genet.: 182-90.
Pliakas A M, Carlson R R, Neve R L, Konradi C, Nestler E J, Carlezon W A Jr. (2001) Altered responsiveness to cocaine and increased immobility in the forced swim test associated with elevated cAMP response element-binding protein expression in nucleus accumbens. J Neurosci. 21:7397-403.
Porjesz B, Almasy L, Edenberg H J, Wang K, Chorlian D B, Foroud T, Goate A, Rice J P, O'Connor S J, Rohrbaugh J, Kuperman S, Bauer L O, Crowe R R, Schuckit M A, Hesselbrock V, Conneally P M, Tischfield J A, Li T K, Reich T, Begleiter H. (2002) Linkage disequilibrium between the beta frequency of the human EEG and a GABAA receptor gene locus. Proc Natl Acad Sci USA. 99:3729-33.
Post W S, Larson M G, Myers R H, Galderisi M, Levy D. (1997) Heritability of left ventricular mass: the Framingham Heart Study. Hypertension 30:1025-8.
Pratt S C, Daly M J, Kruglyak L. (2000) Exact multipoint quantitative-trait linkage analysis in pedigrees by variance components. Am J Hum Genet. 66:1153-7.
Rabinowitz D, Laird N. (2000) A unified approach to adjusting association tests for population admixture with arbitrary pedigree structure and arbitrary missing marker information. Hum Hered. 50:211-23.
Rao D C, Gu C (2001) False positives and false negatives in genome scans. In Rao DC, Province M A (eds) Genetic Dissection of Complex Traits, Academic Press, San Diego, pp 487-498
Reich T, Hinrichs A, Culverhouse R, Bierut L. (1999) Genetic studies of alcoholism and substance dependence. Am J Hum Genet. 65:599-605.
Risch N, Spiker D, Lotspeich L, Nouri N, Hinds D, Hallmayer J, Kalaydjieva L, McCague P, Dimiceli S, Pitts T, Nguyen L, Yang J, Harper C, Thorpe D, Vermeer S, Young H, Hebert J, Lin A, Ferguson J, Chiotti C, Wiese-Slater S, Rogers T, Salmon B, Nicholas P, Myers R M, et al. (1999) A genomic screen of autism: evidence for a multilocus etiology. Am J Hum Genet.: 493-507.
Rush A J, Giles D E, Schlesser M A, Fulton C L, Weissenburger J, Burns C. (1986) The Inventory for Depressive Symptomatology (IDS): preliminary findings. Psychiatry Res. 18:65-87.
Rush A J, Gullion C M, Basco M R, Jarrett R B, Trivedi M H. (1996) The Inventory of Depressive Symptomatology (IDS): psychometric properties. Psychol Med. 26:477-86.
Seidman L J, Breiter H C, Goodman J M, Goldstein J M, Woodruff P W, O'Craven K, Savoy R, Tsuang M T, Rosen B R. (1998) A functional magnetic resonance imaging study of auditory vigilance with low and high information processing demands. Neuropsychology. 12:505-18.
Shahbazian M D, Antalffy B, Armstrong D L, Zoghbi H Y. (2002) Insight into Rett syndrome: MeCP2 levels display tissue- and cell-specific differences and correlate with neuronal maturation. Hum Mol Genet. 11:115-24.
Sham P C, Lin M W, Zhao J H, Curtis D. (2000) Power comparison of parametric and nonparametric linkage tests in small pedigrees. Am J Hum Genet. 66:1661-8.
Sham P C, Chemy S S, Purcell S, Hewitt J K. (2000) Power of linkage versus association analysis of quantitative traits, by use of variance-components models, for sibship data. Am J Hum Genet. 66:1616-30
Smoller J W, Lunetta K L, Robins J. (2000) Implications of comorbidity and ascertainment bias for identifying disease genes. Am J Med Genet. 96:817-22.
Srikant, R. and Agrawal, R. (1997) Mining Generalized Association Rules, Future Generation Computer Systems 13: 1-13.
Stein E A, Fuller S A. (1992) Selective effects of cocaine on regional cerebral blood flow in the rat. J Pharmacol Exp Ther. July; 262(1):327-34.
Straub R E, Sullivan P F, Ma Y, Myakishev M V, Harris-Kerr C, Wormley B, Kadambi B, Sadek H, Silverman M A, Webb B T, Neale M C, Bulik C M, Joyce P R, Kendler K S (1999) Susceptibility genes for nicotine dependence: a genome scan and followup in an independent sample suggest that regions on chromosomes 2, 4, 10, 16, 17 and 18 merit further study. Mol Psychiatry 4:129-144
Suarez, B. K., Hampe, C. L., and Van Eederwegh, P (1994) Problems of replicating linkage claims in psychiatry. In: Gershon E S, Cloninger C R (eds) Genetic approaches to mental disorders. American Psychiatric Association, Washington, D.C.
Sullivan P F, Neale M C, Kendler K S. (2000) Genetic epidemiology of major depression: review and meta-analysis. Am J Psychiatry. 157:1552-62.
Thompson P M, Cannon T D, Narr K L, van Erp T, Poutanen V P, Huttunen M, Lonnqvist J, Standertskjold-Nordenstam C G, Kaprio J, Khaledy M, Dail R, Zoumalan C I, Toga A W. (2001) Genetic influences on brain structure. Nat Neurosci 4:1253-8
Tsai H J, Sun G, Weeks D E, Kaushal R, Wolujewicz M, Mcgarvey S T, Tufa J, Viali S, Deka R (2001) Type 2 Diabetes and three Calpain-10 gene polymorphisms in Samoans: no evidence of association. Am J Hum Genet 69: 1236-1244
Tsuang M T, Bar J L, Hartley R M, Lyons M J. (2001) The Harvard twin study of substance abuse: what we have learned. Harv Rev Psychiatry 9: 267-279
Uhl G R, Liu Q R, Walther D, Hess J, Naiman D (2001) Polysubstance abuse-vulnerability genes: genome scans for association, using 1004 subjects and 1494 single-nucleotide polymorphisms. Am J Hum Genet 69: 1290-1300
Wilcox M A, Smoller J W, Lunetta K L, Neuberg D. (1999) Using recursive partitioning for exploration and follow-up of linkage andassociation analyses. Genet Epidemiol. 17 Suppl 1:S391-6.
Wilk J B, Volcjak J S, Myers R H, Maher N E, Knowlton B A, Heard-Costa N L, Demissie S, Cupples L A, DeStefano A L. (2001) Family-based association tests for qualitative and quantitative traits using single-nucleotide polymorphism and microsatellite data. Genet Epiderniol.; 21 Suppl 1:S364-9
Williams J T, Begleiter H. Porjesz B, Edenberg H J, Foroud T, Reich T, Goate A, Van Eerdewegh P, Almasy L, Blangero J. (1999) Joint multipoint linkage analysis of multivariate qualitative and quantitative traits: Alcoholism and event-related potentials. Am J Hum Genet 65: 1148-1160.
Winokur G, Coryell W. (1992) Familial subtypes of unipolar depression: a prospective study of familial pure depressive disease compared to depression spectrum disease. Biol Psychiatry. 32:1012-8.
Wise R A. (1978) Catecholamine theories of reward: a critical review. Brain Res. August 25;152(2):215-47.
Wise R A, Spindler J, deWit H, Gerberg G J. (1978) Neuroleptic-induced “anhedonia” in rats: pimozide blocks reward quality of food. Science. July 21;201(4352):262-4.
Wise R A, Bauco P, Carlezon W A Jr, Trojniar W. (1992) Self-stimulation and drug reward mechanisms. Ann N Y Acad Sci. June 28;654:192-8.
Wise R A (1996) Addictive drugs and brain stimulation reward. Annu Rev Neurosci 19:319-340.
Zee R Y, Myers R H, Hannan M T, Wilson P W, Ordovas J M, Schaefer E J, Lindpaintner K, Kiel D P. (2000) Absence of linkage for bone mineral density to chromosome 12q12-14 in the region of the vitamin D receptor gene. Calcif Tissue Int. 67:434-9.
Zhang H, Bonney G. (2000) Use of classification trees for association studies. Genet Epidemiol 19:323-32
Zhang H, Lecklman J F, Pauls D L, Tsai C P, Kidd K K, Campos M R; Tourette Syndrome Association International Consortium for Genetics. (2002) Genomewide scan of hoarding in sib pairs in which both sibs have Gilles de la Tourette syndrome. Am J Hum Genet 70:896-904
Zubieta J K, Smith Y R, Bueller J A, Xu Y, Kilbourn M R, Jewett D M, Meyer C R, Koeppe R A, Stohler C S. (2001) Regional mu opioid receptor regulation of sensory and affective dimensions of pain. Science. 293:311-5.

Other embodiments of the invention are within the following claims.

1-138. (canceled)

139. A datastructure comprising:
a) genetic information that describes a plurality of genetic markers on at least two different, non-homologous chromosomes of a subject; and
b) a systems biology map of the subject, wherein the map comprises a matrix of information about neural circuit function in the brain, the matrix including functional information obtained during a mental process of a subject, the matrix including a first dimension that identifies regions of the brain, and one or more values for each region, wherein the datastructure associates genetic information with the system biology map for the subject.

140. The datastructure of claim 139, wherein the systems biology map comprises information about activity in a plurality of brain regions during at least one paradigm.

141. The datastructure of claim 140, wherein the systems biology map comprises information about activity in a plurality of brain regions during at least two paradigms.

142. The datastructure of claim 140, wherein the paradigm interacts with a reward/aversion mechanism in a normal subject.

143. The datastructure of claim 139, wherein the systems biology map comprises a plurality of matrices, each matrix comprising information about neural activity in a plurality of defined brain regions during different paradigms.

144. A database comprising a plurality of records, wherein each record of the plurality comprises a datastructure according to claim 1.

145. A method of evaluating subjects using functional information about brain activity, the method comprising:
providing a database that comprises functional information about brain activity for each of a plurality of subjects; and
classifying the subjects based on the functional information, to thereby evaluate one or more of the subjects.

146. The method of claim 145, wherein the classifying comprises selecting a subset of variables selected based on information content of each of the variables, and sorting the subjects as a function of the variables of the subset.

147. The method of claim 145, wherein the classifying comprises selecting a subset of variables selected based on correlations among the variables, and sorting the subjects as a function of the variables of the subset.

148. The method of claim 145, wherein each variable is associated with an activity of a particular region of the brain during a paradigm.

149. The method of claim 145, wherein the classifying comprises generating a binary tree, wherein each node of the tree corresponds to a variable associated with a particular region of the brain and a paradigm.

150. The method of claim 145, wherein the classifying is recursive.

151. The method of claim 145, wherein the classifying comprises generating a non-parametric association rule algorithm.

152. A method comprising:
providing a database that comprises quantitative information about brain function for each of a plurality of subjects; and
objectively identifying a subset of subjects from the plurality of subjects according to similarity of brain function.

153. The method of claim 152, wherein the identifying comprises generating one or more association rules that model the subset.

154. The method of claim 152, wherein the identifying comprises generating a decision tree that models the subset.

155. The method of claim 152, wherein the identifying comprises generating a probability function that models the subset.

156. The method of claim 152, wherein the database comprises at least one systems biology map that comprises values determined by evaluating subjects during at least two different mental processes.

157. A datastructure comprising:
a systems biology map of a subject wherein the map comprises quantitative information about neural circuit function in the brain, the information indicating function of a plurality of regions of the brain during a plurality of mental processes.

158. A method of providing a systems biology map, the method comprising:
providing native datasets of brain function for a plurality of subjects during a mental process, the information comprising quantitative data for signals in at least a plurality of brain regions;
combining information from the native datasets to provide an aggregate dataset; and
localizing regions of activity in the aggregate dataset.
